(19) United States
(12) Patent Application Publication
(10) Pub. No.: US 2015/0154375 A1
(43) Pub. Date: Jun. 4, 2015

(54) SYSTEMS AND METHODS FOR OPTIMIZING DRUG THERAPIES

(71) Applicants: COMPANION DX REFERENCE LAB, LLC., Houston, TX (US); The Board of Regents of the University of Texas System, Austin, TX (US)

(72) Inventors: Kevin P. Rosenblatt, Houston, TX (US); David W. Lasecki, Houston, TX (US); Prem P. Gurnani, Houston, TX (US); Pratheesh Sathyan, Houston, TX (US)

(21) Appl. No.: 14/553,750

(22) Filed: Nov. 25, 2014

Related U.S. Application Data
(60) Provisional application No. 61/909,943, filed on Nov. 27, 2013.
(60) Provisional application No. 62/030,539, filed on Jul. 29, 2014.

(51) Int. Cl. G06F 19/00

(52) U.S. Cl. CPC G06F 19/3456

(57) ABSTRACT

Several embodiments disclosed herein relate to methods of providing an optimized drug therapy that is specialized or customized for an individual subject or a group of subjects based, at least in part, on one or more of the genetic profile of the subject, the pharmacogenomic profile of the subject, and/or evaluation of possible drug-drug interactions. In several embodiments, systems specialized for performing one or more aspects of the methods are provided.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field

Several embodiments of the invention disclosed herein generally relate to systems and methods for optimizing drug therapies.

2. Description of the Related Art

The genetic makeup of an individual can pre-dispose that individual to be particularly susceptible (or less susceptible) to development of a particular disease, or type of disease, such as cancer. Similarly the unique genetic makeup of that individual can lead to alterations in the metabolism of certain therapeutic agents that may be used to treat a disease. Thus, the variations in metabolism can lead to a therapeutic agent being effective in one individual, less effective in another individual, and perhaps ineffective and/or generating side effects in other individuals. Moreover, many patients that are affected with certain diseases, such as cancer, are prescribed a panel of medications (e.g., anti-cancer agents, anti-nausea medications, anti-inflammatories, etc.). The plurality of drugs, coupled with the manner in which a particular individual metabolizes each of the drugs, can cause drug-drug interactions. In some instances, the drug-drug interactions can lead to adverse side effects, such as reduced efficacy of one or more of the drugs, drug-induced toxicity, etc.

### SUMMARY

One aspect of the inventions disclosed herein relates to a method of optimizing a drug therapy for a subject in need of the therapy. The method may comprise receiving a genetic profile of the subject, obtaining a pharmacogenomics analysis of the subject, and/or processing a level of one or more drugs in the subject. In several embodiments, the methods comprise obtaining or receiving a genetic profile of a subject in need of a drug therapy. In several embodiments, the genetic profile relates to identification of one or more mutations present in a biological sample obtained from the subject, e.g., a mutation in cancerous cells. In several embodiments, the one or more mutations are unique to the subject (or to the disease that the subject is affected by), and thus provide a possible specific target for a drug therapy. In several embodiments, the methods comprise identifying one or more drugs (from a pool of candidate drugs) that may have an increased therapeutic efficacy against cells having the one or more mutations identified from the sample from the subject. In other words, the subject is screened to identify disease targets that are unique and then a drug (or drugs) are identified that will be effective in treating (e.g., eliminating or reducing the activity of) cells or tissues bearing the one or more identified mutations. Some embodiments, also comprise evaluating the pharmacogenomics profile of the subject in order to identify and/or classify the subject with respect to his or her ability to absorb, distribute, excrete or otherwise metabolize each of the drugs identified. In this manner, the potential for the subject to react adversely to a drug (e.g., if they metabolize a drug very slowly, a standard dose may lead to adverse side effects in that subject) can be identified. Likewise, the possibility of the subject needed a particularized dose, such as a dosing regimen employing greater or more frequent dosing, can be identified if, for example, the subject metabolizes a drug particularly rapidly. Moreover, in several embodiments, the methods also evaluate the possibility of drug-drug interactions between each of the identified candidate drugs as well as optionally the possible interaction between any of the identified candidate drugs and other drugs that the subject may already be receiving (e.g., other drugs for the disease or ailment in question or another disease or ailment). In this manner, the potential for adverse effects from drug administration can be reduced, and in some embodiments, eliminated, thereby improving the efficacy of the treatment and/or the patient quality of life during treatment. Thus, in several embodiments, the methods disclosed employ a plurality of multi-layered analyses (e.g., identification of one or more mutations, identification of one or more drugs, and identification of one more drug-gene and/or drug-drug interaction). Thus, the methods disclosed herein provide a more robust analysis than those that may focus on a single mutation, a single drug, or the like. The methods are also performed, as discussed herein, using systems designed to exploit this robust analysis. In this manner, the methods and systems disclosed herein provide a powerful tool for identification of therapies that are more likely to provide a positive therapeutic benefit for a specific subject (e.g., based on their genetic and pharmacogenomic profiles). In still additional embodiments, the methods further comprise evaluation of the levels (e.g., concentrations/amounts) of drugs that are selected and administered to the subject to ensure that those levels are within an optimal window for that subject. In some embodiments, these optimal windows are unique to the subject, at least in part due to their genetic or pharmacogenomics profile. In some embodiments, these windows are outside a typical range of dose for a drug. In some embodiments, this leads to use of a drug in a manner that is specific to the subject in order to provide the greatest potential for a positive therapeutic outcome. This “therapeutic drug monitoring” dovetails with the identification of mutations and therapeutic agents and serves as an optional control measure to ensure that the identified therapeutic regime is in fact providing a positive outcome for the subject, ideally with reduced or eliminated adverse effects.

In certain embodiments, the genetic profile of the subject may be prepared by a method comprising (i) processing a first set of data using a computer system configured to receive and assess the first set of data and provide an output comprising a second set of data, said first set of data comprising information related to genetic sequences of biological materials obtained from diseased cells or tissue of the subject, and said second set of data comprising information related to one or more genetic alternations or variants of the diseased cells or tissue of the subject as compared to normal, non-diseased cells, wherein said computer system comprises an algorithm that compares a data point from the first set of data with a corresponding data point from normal, non-diseased cells, and (ii) processing the second set of data using a computer system configured to receive and assess the second set of data and provide an output comprising a third set of data, said processing the second set of data comprises identifying differentially expressed genetic alterations or variants in the diseased cells and querying an electronic drug database to identify a first set of candidate drugs that may be associated with an elevated degree of therapeutic efficacy against cells exhibiting the one or more genetic alternations or variants identified in the diseased cells or tissue of the subject, said third set of data comprising information related to the first set of candidate drugs.

In some embodiments, the pharmacogenomics analysis of the subject is generated by a method comprising (iii) processing a fourth set of data using a computer system configured to receive and assess the fourth set of data, said fourth set of data comprising information related to the pharmacokinetic profile of the subject, wherein the pharmacokinetic profile of the subject was determined by screening the subject for characteristic identifiers of absorption, distribution, metabolism, and/or excretion of drugs, (iv) processing the third and fourth sets of data and a fifth set of data using a computer system configured to receive and assess the third, fourth, and fifth sets of data, said fifth set of data comprising information related to a panel of drugs currently being administered or contemplated to be administered to the subject, said processing the third, fourth, and fifth sets of data comprising: evaluating one or more of the following: an impact of the pharmacokinetic profile of the subject on a recommended dosage amount of each of the first set of candidate drugs, and an impact of putative or actual drug-drug interactions for each of the first set of candidate drugs and one or more drugs currently being administered or contemplated to be administered to the subject, (v) providing an output comprising a sixth set of data, said sixth set of data comprising information related to a second set of candidate drugs, and (vi) generating at least one report, wherein said report comprises a recommended panel of therapeutic drugs comprising the second set of candidate drugs and dosing regimens for the panel.

In some additional embodiments, the processing the level of one or more drugs in the subject may comprises (vii) processing a seventh set of data using a computer system configured to receive and assess the seventh set of data and provide an output comprising an eighth set of data, said seventh set of data comprising information related to the presence and/or a level of one or more drugs in the subject, and said one or more drugs being selected from the second set of candidate drugs and having been previously administered to the subject, said eighth data comprising information related to the concentration of said one or more drugs, (viii) determining, based on the concentration of said one or more drugs in the subject, if the concentration is within a desired therapeutic window and whether administration of the at least one drug that has been previously administered to the subject needs to be altered or maintained in order to be within the desired therapeutic window, and (ix) generating a report comprising information on suggested alterations or maintenance of the drug administration in order to reach concentrations of the at least one drug that are within the desired therapeutic window.

In certain embodiments, the identifiers may comprise one or more genes that are associated with absorption, distribution, metabolism and/or excretion of drugs in the subject and said fourth set of data is generated by a method comprising (x) processing a ninth set of data using a computer system configured to receive and assess the ninth set of data and provide an output comprising a tenth set of data, said ninth set of data comprising information related to sequences of genetic materials obtained from the subject and said tenth set of data comprising information related to one or more alterations or variants of the one or more genes, wherein said computer system comprises an algorithm that compares a data point from the eighth set of data with a corresponding data point from a control, (xi) determining a genotype of the one or more genes, (xii) determining a phenotype of the one or more genes, and (xiii) outputting the eleventh set of data, said eleventh set of data comprising information related to the genotype and/or the phenotype of the one or more genes, said fourth set of data comprising at least part of the eleventh set of data, wherein the computer system comprises an algorithm that matches the genotype to its corresponding phenotype.

In some alternative embodiments, the genes associated with absorption, distribution, metabolism and/or excretion of drugs in the subject include, but are not limited to, genes encoding, for example, Factor II (Prothrombin), gene encoding Factor V (Leiden), gene encoding Methylenetetrahydrofolate reductase (MTHFR), gene encoding VKORC1, gene encoding Cytochrome P4502C9, gene encoding Cytochrome P4502C19, gene encoding Cytochrome P4502D6, gene encoding Cytochrome P4503A4, and gene encoding Cytochrome P4503A5.

In still some alternative embodiments, the tenth set of data may comprise at least two alterations or variants of a same gene or different genes that are associated with absorption, distribution, metabolism and/or excretion of drugs in the subject.

In still some alternative embodiments, the normal, non-diseased cells are from the subject.

In still some alternative embodiments, the normal, non-diseased cells may be from an individual other than the subject.

In still some alternative embodiments, the control may be a separate individual having no genetic alteration or variant of at least one of the genetic identifiers.

In still some alternative embodiments, a concentration of the at least one drug within the desired therapeutic window may be associated with reduced adverse side effects, as compared to the degree of side effects when the concentration is not within the desired therapeutic window.

In still some alternative embodiments, the processing the level of one or more drugs in the subject may be repeated.

In still some alternative embodiments, the method may further comprise operating an imaging process.

Depending on the embodiment, one or more elements of (i) to (xiii) described herein can be included or omitted from a given combination of elements (i) to (xiii) that are included in that embodiment. There is no limitation on choosing one or more elements selected from the group consisting of the above-listed elements of (i) to (xiii) and operating the chosen elements to practice several embodiments of the methods disclosed herein. In addition, in many alternative embodiments, one or more steps selected from the group consisting of a step of receiving a genetic profile of the subject, a step of obtaining a pharmacogenomics analysis of the subject, a step of processing a level of one or more drugs in the subject, and a step of operating an imaging process can be added or omitted from the combination comprising all four steps. Also any additional step or steps can be added to any combination of the chosen steps. There is no limitation on choosing any number of steps from those disclosed herein and performing the chosen steps to practice several embodiments of the methods disclosed herein.

Another aspect of the inventions disclosed herein relates to a method of optimizing a drug therapy for a subject in need of the therapy. The method may comprise receiving a first set of candidate drugs that may be associated with treating the condition of the subject, obtaining a pharmacogenomics analysis of the subject, and processing a level of one or more drugs in the subject.

In some embodiments, the first set of candidate drugs that may be associated with a condition of the subject may be generated by a method comprising (i) providing information on the condition of the subject, and (ii) processing the information on the condition of the subject using a computer system configured to receive and assess said information, query an electronic drug database, and provide an output comprising a first set of data, said first set of data comprising information on a first set of candidate drugs that may be associated with an elevated degree of therapeutic efficacy against cells exhibiting the condition of the subject.

In certain embodiments, the pharmacogenomics analysis of the subject may be generated by a method comprising (iii) processing a second set of data using a computer system configured to receive and assess the second set of data, said second set of data comprising information related to the pharmacokinetic profile of the subject, wherein the pharmacokinetic profile of the subject was determined by screening the subject for characteristic identifiers of absorption, distribution, metabolism, and/or excretion of drugs, (vi) processing the first and second sets of data and a third set of data using a computer system configured to receive and assess the first, second and third sets of data, said third set of data comprising information related to a panel of drugs currently being administered or contemplated to be administered to the subject, said processing the first, second and third sets of data comprising evaluating one or more of the following: an impact of the pharmacokinetic profile of the subject on a recommended dosage amount of each of the first set of candidate drugs, and an impact of putative or actual drug-drug interactions for each of the first set of candidate drugs and one or more drugs currently being administered or contemplated to be administered to the subject, (v) providing an output comprising a fourth set of data, said fourth set of data comprising information related to a second set of candidate drugs, and (vi) generating at least one report, wherein said report comprises a recommended panel of therapeutic drugs comprising the second set of candidate drugs and dosing regimens for the panel.

In some embodiments, the processing the level of one or more drugs in the subject may comprises (vii) processing an fifth set of data using a computer system configured to receive and assess the fifth set of data and provide an output comprising an sixth set of data, said fifth set of data comprising information related to the presence and/or a level of one or more drugs in the subject, and said one or more drugs being selected from the second set of candidate drugs and having been previously administered to the subject, said sixth data comprising information related to the concentration of said one or more drugs, (viii) determining, based on the concentration of said one or more drugs in the subject, if the concentration is within a desired therapeutic window and whether administration of the at least one drug that has been previously administered to the subject needs to be altered or maintained in order to be within the desired therapeutic window, and (ix) generating a report comprising information on suggested alterations or maintenance of the drug administration in order to reach concentrations of the at least one drug that are within the desired therapeutic window.

In some alternative embodiments, the identifiers may comprise one or more genes that are associated with absorption, distribution, metabolism and/or excretion of drugs in the subject and said second set of data is generated by a method comprising (x) processing an seventh set of data using a computer system configured to receive and assess the seventh set of data and provide an output comprising a eighth set of data, said seventh set of data comprising information related to sequences of genetic materials obtained from the subject; said eighth set of data comprising information related to one or more alterations or variants of the one or more genes, wherein said computer system comprises an algorithm that compares a data point from the seventh set of data with a corresponding data point from a control, (xi) determining a genotype of the one or more genes, (xii) determining a phenotype of the one or more genes, and (xiii) outputting the ninth set of data, said ninth set of data comprising information related to the genotype and/or the phenotype of the one or more genes, said second set of data comprising at least part of the ninth set of data, wherein the computer system comprises an algorithm that matches the genotype to its corresponding phenotype.

In still some alternative embodiments, the one or more genes associated with absorption, distribution, metabolism and/or excretion of drugs in the subject may be selected from the group consisting of gene encoding Factor II (Prothrombin), gene encoding Factor V (Leiden), gene encoding Methylenetetrahydrofolate reductase (MTHFR), gene encoding VKORC1, gene encoding Cytochrome P4502C9, gene encoding Cytochrome P450 2C19, gene encoding Cytochrome P4502D6, gene encoding Cytochrome P4503A4, and gene encoding Cytochrome P4503A5. Other genes, or variants, mutants, and the like may be evaluated in additional embodiments.

In still some alternative embodiments, the processing the third, fourth, and fifth sets of data may further comprise (xiv) computing the dosing regimens for the recommended panel of therapeutic drugs comprising the second set of candidate drugs, wherein said computing comprises processing the information related to at least two alterations or variants of a same gene or different genes that are associated with absorption, distribution, metabolism and/or excretion of drugs in the subject.

In still some alternative embodiments, the normal, non-diseased cells may be from the subject.

In still some alternative embodiments, the normal, non-diseased cells may be from an individual other than the subject.

In still some alternative embodiments, the control may be a separate individual (or population) having no genetic alteration or variant of at least one of the genetic identifiers.

In still some alternative embodiments, a concentration of the at least one drug within the desired therapeutic window may be associated with reduced adverse side effects, as compared to the degree of side effects when the concentration is not within the desired therapeutic window.

In still some alternative embodiments, the processing the level of one or more drugs in the subject can be repeated.

In still some alternative embodiments, the method may further comprise operating an imaging process.

In various embodiments, one or more element of (i) to (xiv) can be added or omitted from the combination comprising the elements (i) to (xiv). There is no limitation on choosing one or more elements selected from the group consisting of the above-listed elements of (i) to (xiv) and operating the chosen elements to practice several embodiments of the methods disclosed herein. In addition, in many alternative embodiments, one or more steps selected from the group consisting of a step of receiving a first set of candidate drugs that may be associated with a condition of the subject, a step of obtaining a pharmacogenomics analysis of the subject, a step of processing a level of one or more drugs in the subject, and a step of operating an imaging process can be added or omitted from the combination comprising all four steps. Also any additional one or more steps can be added to any combinations of the chosen steps. There is no limitation on choosing one or more steps selected from the group consisting of the above-listed four steps and operating the chosen steps to practice several embodiments of the methods disclosed herein.

Still another aspect of the inventions disclosed herein relates to a system for implementing a customized drug therapy for a subject having a disease. The system may comprise (i) a genetic data interface that is configured to receive a first set of data and store said first set of data in an electronic sequence database, said first set of data generated by a genetic material sequencing apparatus and comprising information related to the genetic profile of the subject, (ii) a genetic data analyzer that is configured to access the first set of data in the electronic database and to process the first set of data to generate a second set of data, based on said first set of data, said second set of data comprising information related to one or more genetic alterations or variants of diseased cells or tissue of the subject as compared to normal, non-diseased cells, wherein the genetic data analyzer comprises an algorithm that compares a data point from the first set of data with a corresponding data point from normal, non-diseased cells, thereby generating the second set of data, wherein the genetic data analyzer comprises an output generator that prepares the second set of data for output, (iii) a genetic data processor that is configured to receive the second set of data from the output generator and query an electronic drug database to generate a third set of data, said third set of data comprising information related to a first set of candidate drugs that may be associated with an elevated degree of therapeutic efficacy against cells exhibiting the genetic alterations or variants identified in the diseased cells of the subject, (iv) a pharmacogenomics data interface that is configured to receive a fourth set of data and a fifth set of data, wherein said fourth set of data is related to the pharmacokinetic profile of the subject, wherein the pharmacokinetic profile of the subject was determined by screening the subject for characteristic identifiers of absorption, distribution, metabolism, and/or excretion of drugs, wherein the fifth set of data is related to a panel of drugs currently being administered or contemplated to be administered to the subject, the pharmacogenomics data interface configured to store the fourth and fifth set of data in an electronic patient drug profile, (v) a pharmacogenomics data analyzer that is configured to receive and process the third, fourth, and fifth sets of data and configured to evaluate one or more of the following: an impact of the pharmacokinetic profile of the subject on a recommended dosage amount of each of the first set of candidate drugs, and an impact of putative or actual drug-drug interactions for each of the first set of candidate drugs and one or more drugs currently being administered or contemplated to be administered to the subject, (vi) a pharmacogenomics data processor that is configured to generate a sixth set of data, said sixth set of data comprising information related to a second set of candidate drugs, (vii) a first data output controller that is configured to generate at least one report, wherein said report comprises a recommended panel of therapeutic drugs comprising the second set of candidate drugs and dosing regimens for said panel, (viii) a drug monitoring data receiver that is configured to receive a seventh set of data, said seventh set of data comprising information related to the presence and/or a level of one or more drugs in the subject, and said one or more drugs being selected from the second set of candidate drugs and having been previously administered to the subject, (xi) a drug monitoring data analyzer that is configured to process the seventh set of data so as to determine a concentration of said one or more drugs in the subject, and (x) a drug monitoring data processor configured to determine, based on the concentration of said one or more drugs in the subject, if the concentration is within a desired therapeutic window and whether administration of the at least one drug that has been previously administered to the subject needs to be altered (e.g., increased or decreased) or maintained in order to be within the desired therapeutic window, and (xi) a second data output controller that is configured to generate a report comprising information on suggested alterations or maintenance of the drug administration in order to reach concentrations of the at least one drug that are within the desired therapeutic window, and wherein the system comprises at least a computer processor and/or an electronic memory.

In some embodiments, the identifiers may comprise one or more genes that are associated with absorption, distribution, metabolism and/or excretion of drugs in the subject. In several embodiments, the system further comprises (xv) a pharmacokinetic data interface that is configured to receive an eighth set of data and store said eighth set of data in an electronic sequence database, said eighth set of data generated by genetic material sequencing apparatus, (xvi) a pharmacokinetic data analyzer that is configured to access the eighth set of data in the electronic database and to process the eighth set of data to generate a ninth set of data, based on said eighth set of data, said ninth set of data comprising information related to one or more alterations or variants of the one or more genes, wherein the pharmacokinetic data analyzer comprises an algorithm that compares a data point (or points) from the eighth set of data with a corresponding data point (or points) from a control, wherein the pharmacokinetic data analyzer comprises an output generator that prepares the ninth set of data for output, and (xvii) a pharmacokinetic data processor that is configured to receive and process the ninth set of data from the output generator to determine a genotype of the one or more genes and a corresponding phenotype thereof, wherein the pharmacokinetic data processor comprises an algorithm that matches the genotype to its corresponding phenotype, and wherein the pharmacokinetic data processor comprises an output generator that prepares a tenth set of data for output, said tenth set of data comprising information related to the genotype and/or the phenotype of the one or more genes, said fourth set of data comprising at least part of the tenth set of data.

In certain embodiments, the one or more genes associated with absorption, distribution, metabolism and/or excretion of drugs in the subject include, but are not limited to, genes encoding Factor II (Prothrombin), gene encoding Factor V (Leiden), gene encoding Methylenetetrahydrofolate reductase (MTHFR), gene encoding VKORC1, gene encoding Cytochrome P4502C9, gene encoding Cytochrome P4502C19, gene encoding Cytochrome P4502D6, gene encoding Cytochrome P4503A4; and gene encoding Cytochrome P4503A5 (or variants of any of these).

In some alternative embodiments, the ninth set of data may comprise information related to at least two alterations or variants of a same gene or different genes that are associated with absorption, distribution, metabolism and/or excretion of drugs in the subject.

In still some alternative embodiments, the normal, non-diseased cells may be from the subject.

In still some alternative embodiments, the normal, non-diseased cells may be from an individual other than the subject.

In still some alternative embodiments, the control may be a separate individual (or individuals or a population) having no genetic alteration or variant of at least one of the genetic identifiers.

In still some alternative embodiments, a concentration of the at least one drug within the desired therapeutic window is associated with reduced adverse side effects, as compared to the degree of side effects when the concentration is not within the desired therapeutic window.

In still some alternative embodiments, the processing the level of one or more drugs in the subject can be repeated, for example as an ongoing monitor during the course of a treatment of the subject.

In still some alternative embodiments, the system may further comprise (xviii) an imaging data receiver that is configured to receive an eleventh set of data and a twelfth set of data, said eleventh set of data comprising information related to a first imaging data of a tissue or organ of the subject, wherein said first set of imaging data were obtained prior to the administration of said one or more drugs, and said twelfth set of data comprising information related to a second imaging data of the tissue or organ of the subject, wherein said second set of imaging data were obtained after the administration of said one or more drugs, (xix) an imaging data analyzer that is configured to process the eleventh and twelfth sets of data so as to compare the condition of the tissue or organ of the subject before and after the administration, and (xx) an imaging data processor configured to process determine any change in the condition of the tissue or organ of the subject.

In various embodiments, one or more element of (i) to (xx) can be added or omitted from the combination comprising the elements (i) to (xx). There is no limitation on choosing one or more elements selected from the group consisting of the above-listed elements of (i) to (xx) and operating the chosen elements to run several embodiments of the systems disclosed herein.

Still another aspect of the inventions disclosed herein relates to a system for implementing a customized drug therapy for a subject having a condition. The system may comprise (i) a drug data interface that is configured to receive a first set of data and store said first set of data in an electronic sequence database, said first set of data comprising information related to the condition of the subject, (ii) a drug data processor that is configured to receive the first set of data from the output generator and query an electronic drug database to generate a second set of data, said second set of data comprising information related to a first set of candidate drugs that may be associated with an elevated degree of therapeutic efficacy against cells exhibiting the condition of the subject, (iii) a pharmacogenomics data interface that is configured to receive a second set of data and a third set of data, wherein said second set of data is related to the pharmacokinetic profile of the subject, wherein the pharmacokinetic profile of the subject was determined by screening the subject for characteristic identifiers of absorption, distribution, metabolism, and/or excretion of drugs, wherein the third set of data is related to a panel of drugs currently being administered or contemplated to be administered to the subject, the pharmacogenomics data interface configured to store the fourth and fifth set of data in an electronic patient drug profile, (iv) a pharmacogenomics data analyzer that is configured to receive and process the first, second, and third sets of data and configured to evaluate one or more of the following: an impact of the pharmacokinetic profile of the subject on a recommended dosage amount of each of the first set of candidate drugs, and an impact of putative or actual drug-drug interactions for each of the first set of candidate drugs and one or more drugs currently being administered or contemplated to be administered to the subject, (v) a pharmacogenomics data processor that is configured to generate a fourth set of data, said fourth set of data comprising information related to a second set of candidate drugs, (vi) a first data output controller that is configured to generate at least one report, wherein said report comprises a recommended panel of therapeutic drugs comprising the second set of candidate drugs and dosing regimens for said panel, (vii) a drug monitoring data receiver that is configured to receive a fifth set of data, said fifth set of data comprising information related to the presence and/or a level of one or more drugs in the subject, and said one or more drugs being selected from the second set of candidate drugs and having been previously administered to the subject, (viii) a drug monitoring data analyzer that is configured to process the fifth set of data so as to determine a concentration of said one or more drugs in the subject, (ix) a drug monitoring data processor configured to determine, based on the concentration of said one or more drugs in the subject, if the concentration is within a desired therapeutic window and whether administration of the at least one drug that has been previously administered to the subject needs to be altered or maintained in order to be within the desired therapeutic window, and (x) a second data output controller that is configured to generate a report comprising information on suggested alterations or maintenance of the drug administration in order to reach concentrations of the at least one drug that are within the desired therapeutic window, and wherein the system comprises at least a computer processor and an electronic memory.

In some embodiments, the identifiers may comprise one or more genes that are associated with absorption, distribution, metabolism and/or excretion of drugs in the subject and the system further may comprise (xi) a pharmacokinetic data interface that is configured to receive a sixth set of data and store said sixth set of data in an electronic sequence database, said eighth set of data generated by genetic material sequencing apparatus, (xii) a pharmacokinetic data analyzer that is configured to access the sixth set of data in the electronic database and to process the sixth set of data to generate a seventh set of data, based on said sixth set of data, said seventh set of data comprising information related to one or more alterations or variants of the one or more genes, wherein the pharmacokinetic data analyzer comprises an algorithm that compares a data point from the sixth set of data with a corresponding data point from a control, wherein the pharmacokinetic data analyzer comprises an output generator that prepares the seventh set of data for output, and (xiii) a pharmacokinetic data processor that is configured to receive and process the seventh set of data from the output generator to determine a genotype of the one or more genes and a corresponding phenotype thereof, wherein the pharmacokinetic data processor comprises an algorithm that matches the genotype to its corresponding phenotype, and wherein the pharmacokinetic data processor comprises an output generator that prepares an eighth set of data for output, said eighth set of data comprising information related to the genotype and/or the phenotype of the one or more genes, said second set of data comprising at least part of the eighth set of data.

In certain embodiments, the one or more genes associated with absorption, distribution, metabolism and/or excretion of drugs in the subject include, but are not limited to, genes encoding Factor II (Prothrombin), gene encoding Factor V (Leiden), gene encoding Methylenetetrahydrofolate reductase (MTHFR), gene encoding VKORC1, gene encoding Cytochrome P4502C9, gene encoding Cytochrome P4502C19, gene encoding Cytochrome P4502D6, gene encoding Cytochrome P4503A4; and gene encoding Cytochrome P4503A5.

In some embodiments, the ninth set of data may comprise information related to at least two alterations or variants of a same gene or different genes that are associated with absorption, distribution, metabolism and/or excretion of drugs in the subject.

In some alternative embodiments, the normal, non-diseased cells may be from the subject.

In still some alternative embodiments, the normal, non-diseased cells may be from an individual other than the subject.

In still some alternative embodiments, the control may be a separate individual having no genetic alteration or variant of at least one of the genetic identifiers.

In still some alternative embodiments, a concentration of the at least one drug within the desired therapeutic window may be associated with reduced adverse side effects, as compared to the degree of side effects when the concentration is not within the desired therapeutic window.

In still some alternative embodiments, the processing the level of one or more drugs in the subject can be repeated.

In still some alternative embodiments, the system may further comprises (xiv) an imaging data receiver that is configured to receive a ninth set of data and a tenth set of data, said ninth set of data comprising information related to a first imaging data of a tissue or organ of the subject, wherein said first set of imaging data were obtained prior to the administration of said one or more drugs, and said tenth set of data comprising information related to a second imaging data of the tissue or organ of the subject, wherein said second set of imaging data were obtained after the administration of said one or more drugs, (xv) an imaging data analyzer that is configured to process the ninth and tenth sets of data so as to compare the condition of the tissue or organ of the subject before and after the administration, and (xvi) an imaging data processor configured to process determine any change in the condition of the tissue or organ of the subject.

In various embodiments, one or more element of (i) to (xvi) can be added or omitted from the combination comprising the elements (i) to (xvi). There is no limitation on choosing one or more elements selected from the group consisting of the above-listed elements of (i) to (xvi) and operating the chosen elements to run several embodiments of the systems disclosed herein.

The methods and systems summarized above and set forth in further detail below describe certain actions taken by a practitioner; however, it should be understood that they can also include the instruction of those actions by another party. Thus, actions such as “collecting a biological sample from a subject” include “instructing the collection of a biological sample from a subject.”

### BRIEF DESCRIPTION OF THE DRAWINGS

FIGS. 1A-1B a non-limiting embodiment of a flowchart related to the derivation of a therapeutic regime for a specific patient based on their genetic profile.

FIG. 2 shows a non-limiting process flow diagram of certain embodiments of the methods disclosed herein.

FIG. 3 shows a non-limiting embodiment of patient-specific process flow according to several embodiments disclosed herein.

FIGS. 4A-4C show a non-limiting embodiment of a genetic profiling report of the methods disclosed herein. In certain embodiments, the report may be prepared based on an analysis of a non-small cell lung cancer (NSCLC) biopsy.

FIGS. 5A-5C show a non-limiting embodiment of a genetic profiling report of the methods disclosed herein. In certain embodiments, the report may be prepared based on an analysis of a pancreatic tumor.

FIGS. 6A-6E show a non-limiting embodiment of a genetic profiling report of the methods disclosed herein. In certain embodiments, the report may be prepared based on an analysis of a lung cancer patient.

FIGS. 7A-7D show a non-limiting embodiment of a genetic profiling report of the methods disclosed herein. In certain embodiments, the report may be prepared based on an analysis of a patient diagnosed with ascending colon tubular adenoma.

FIGS. 8A and 8B show the statistical data of the progression free survival rates (%) in two groups of NSCLC patients. The data shows the criticality of a genetic profiling analysis in developing a customized drug treatment regimen.

FIG. 9 shows a simplified diagram illustrating the EGFR signaling pathway from the signal reception on a cell surface to the downstream signaling cascade.

FIGS. 10A-10L show a non-limiting embodiment of a report of the methods disclosed herein. In certain embodiments, the report may contain the results obtained from a pharmacogenomics analysis of a subject. In some embodiments, the report may comprise the general information on medicine and the application protocol thereof.

FIG. 11 shows a set of the statistical data of the survival probability on NSCLC patients.

FIG. 12 shows another set of the statistical data of the survival probability on NSCLC patients. The data from FIGS. 11 and 12 show the efficacy of a combinatorial operation of a genetic profiling analysis and a pharmacogenomics analysis in developing a customized drug treatment regimen

FIG. 13 shows a non-limiting embodiment of a drug monitoring analysis of the methods disclosed herein. In certain embodiments, the drug monitoring analysis may utilize mass spectrometry.

FIG. 14 shows a non-limiting embodiment of a drug monitoring analysis of the methods disclosed herein. In certain embodiments, the drug monitoring analysis may utilize a stable isotope (SI) to determine the metabolic level of a drug in a subject.

FIG. 15 shows a non-limiting embodiment of the methods disclosed herein where a drug treatment protocol can be designed based on the subject's genetic and metabolic profiles.

FIG. 16 shows a non-limiting embodiment of the methods disclosed herein where an imaging process is used.

FIG. 17 shows a non-limiting embodiment of the methods disclosed herein. In certain embodiments, the methods disclosed herein can be applicable to a clinical trial design and management.

FIG. 18 shows a non-limiting personalized medicine solution of certain embodiments of the methods disclosed herein.

FIG. 19 shows a chart showing the data related to incidence of histologic subtypes in the U.S. population.

FIG. 20 shows a chart showing the data related to the stage of diagnosis and treatment, and five year survival rate in a NSCLC patient population.

FIG. 21 shows a non-limiting process flow diagram of certain embodiments of the methods disclosed herein, wherein the method is applied to a patient diagnosed with non-small cell lung cancer (NSCLC).

FIG. 22 shows a process flow diagram related to certain embodiments of developing a subject-specific drug treatment protocol.

FIG. 23 shows an alternative process flow diagram related to certain embodiments of developing a subject-specific drug treatment protocol.

FIG. 24 shows a process flow diagram of certain embodiments of the methods disclosed herein, especially related to a genetic profiling analysis.

FIG. 25 shows a process flow diagram of certain embodiments of the methods disclosed herein, especially related to a pharmacogenomics analysis.

FIG. 26 shows a process flow diagram of certain embodiments of the methods disclosed herein, especially related to a drug monitoring analysis.

FIG. 27 shows a process flow diagram of certain embodiments of the methods disclosed herein where a genetic profiling analysis may not be adopted.

FIG. 28 shows a process flow diagram of certain embodiments of the methods disclosed herein, especially related to a process to generate a pharmacokinetic profile of a subject.

FIG. 29 shows a non-limiting embodiment of the systems disclosed herein, especially related to a system to implement a method of developing a subject-specific therapeutic drug regimen.

FIG. 30 shows another non-limiting embodiment of the systems disclosed herein, especially related to a system to implement a method of developing a subject-specific therapeutic drug regimen.

FIG. 31 shows a still another non-limiting embodiment of the systems disclosed herein, especially related to a system to implement a method of developing a subject-specific therapeutic drug regimen.

FIG. 32 shows a still another non-limiting embodiment of the systems disclosed herein, especially related to a system to implement a method of developing a subject-specific therapeutic drug regimen.

FIG. 33 shows a still another non-limiting embodiment of the systems disclosed herein, especially where an imaging data process and the relevant elements to operate the imaging data process are incorporated.

FIG. 34 shows a non-limiting embodiment of the systems disclosed herein, especially related to a computer system to implement a method of developing a subject-specific therapeutic drug regimen.

### DETAILED DESCRIPTION

Generally speaking, the treatment of diseases, in particular cancers, has focused on the elimination of “bad” cells with the understanding that there may be some loss of “good” cells along the way. For example, chemotherapy is premised on the preferential destruction of tumor cells as compared to non-tumor cells based largely on the higher metabolic activity of cancer cells. While drugs have been developed with more specific targeting in recent years, there has yet to be developed and/or widely implemented therapies that leverage unique patient characteristics (or characteristics of the disease with which a patient is affected) to focus the therapies on treating a disease while reducing side effects.

However, as disclosed herein, several embodiments of the present invention relate to a complete therapeutic regime that determines, based in part on a set of unique characteristics of a disease afflicting a particular patient, a pool of candidate therapeutic drugs. In the context of cancer, for example, this may be a particular marker or mutation that the cancerous cells exhibit. Thus, the pool of drugs identified comprises drugs that are thought to be particularly beneficial to treating and/or eliminating a cancer having this particular marker or mutation. This is in contrast to prior methods, in which a physician may determine the type of cancer, then administer a particular drug based on its success in prior patients. However, because there is patient to patient variability in drug responsiveness, and in cancer severity, that approach is akin to an educated guess.

Once identified, the pool of candidate drugs is then optionally further refined based on specific metabolic characteristics of the patient. These characteristics may include the rate at which a particular patient metabolizes a class of drug, which will impact the amount required to generate a therapeutic effect in the patient. Drug absorption rates, excretion rates, and/or other pharmacokinetic parameters are also assessed, in several embodiments. Many prior approaches employed administration based on the drug labeling recommendations and/or based on prior experience. Again, this approach is a best-guess, and essentially a one-size fits most solution. Several embodiments disclosed herein provide a one size fits one patient (or some patients) approach, focusing the administration and dosing regimen on specific characteristics of the patient and the disease state of the patient.

In addition to the assessment of patient metabolic characteristics, several embodiments also refine this assessment based on other drugs that a patient may be taking. Other drugs may alter the metabolism of a particular therapeutic drug (e.g., increase or decrease it's metabolism), which can dramatically shift the therapeutic window of drug concentration and that of adverse side effects. In some cases, other drugs may have no bearing on the impact of the therapeutic drug. However, the methods disclosed herein provide the physician more focused list of drugs, possible drug-drug interactions, and drug doses, thereby improving patient care.

Consequently, several embodiments of the methods (and systems to employ the methods) disclosed herein represent a shift away from an approach in which a physician would administer a drug to treat a disease and hope that the diseased cells are eliminated prior to the therapy damaging the normal cells to an extent that the patient is adversely affected. The methods disclosed herein arm the physician with specific information about a specific patient, the specific characteristics of the diseased cells of the patient, and the drug/drugs that are ideal for treating that disease, all while contemplating certain characteristics of the patient (e.g., the patient's metabolism or drug-drug interactions) that assist in reducing side effects. The method disclosed herein are no longer relying on a best guess, but are a “soup to nuts” program for truly personalized medicine.

With an analysis of a particular patient's DNA (e.g., profiling genetic mutations that may be associated with the patient's disease) an ideal drug therapy can be developed based on the patient's drug metabolism profile and potential for drug-drug interactions.

In contrast to a “trial-and-error” method of prescribing medications, wherein physicians would often have to wait and see whether a patient would respond to a certain medication before judging its efficacy, the methods disclosed herein allow more precisely guided patient treatment plans based on patient unique genetic and genomic information.

In one aspect, several embodiments of the invention disclosed herein are related to a method for designing or providing a drug treatment regimen that is specialized (or customized) for a subject.

In some embodiments, the methods disclosed herein are applicable to a drug treatment of a single individual while some embodiments relate to treatment of a plurality of subjects. The individual subject or a plurality of the subjects targeted by the methods disclosed herein may generally be healthy or have one or more conditions in health. In certain embodiments, the methods may be applicable to a plurality of the subjects who may be associated with one or more common conditions (e.g. diseases or disorders). In some other embodiments, a plurality of the subjects targeted by the methods of the invention may share one or more common aspects (e.g. genetic and/or metabolic traits, and/or nutritional habits) including, but not limited to, race, gender, age, geographical location, common or related ancestry, family history of a certain disease(s) or condition(s), and others.

In certain embodiments, the methods disclosed herein can be customized or designed for an individual subject. The individual subject may have one or more conditions and the methods may be used to provide a drug treatment regimen that is particularly specialized to treat the one or more conditions the subject is affected with.

In alternative embodiments, the methods disclosed herein may be customized or designed for a plurality of individuals sharing one or more commons traits or characteristics. Therefore, in some examples, the methods can be designed for a certain population sharing one or more of genetic traits, metabolic traits, gender, nationality, race, age, ancestry, current or past disease condition, family history of a certain disease or condition, nutritional habit and geographic location. Thus, in one example, the methods can be designed to serve a group of people generally residing in a common area (e.g. a certain city, state or country) and having a trend of, for example, consuming relatively high fat diet. The methods can thus be designed to provide a drug treatment plan for preventing and/or treating conditions related to the consumption of such a high fat diet. The methods can be customized for a certain race or nationality, or people sharing a common ancestry. As another example, the methods disclosed herein can optionally be designed for a group of people in a particular age range, e.g. about 10 years of age, about 20 years of age, about 30 years of age, about 40 years of age, or about 50 years of age (or more) and having, e.g. a past history of diabetes. In another example, the methods disclosed herein can optionally be designed for a group of a common age, e.g. about 10 years of age or less, about 20 years of age or less, about 30 years of age or less, about 40 years of age or less, about 50 years of age or less, about 60 years of age or less, about 70 years of age or less, about 80 years of age or less, or about 90 years of age or less and having a past history of, e.g. diabetes. The concerned condition/disorder/disease shared by a given group can vary depending on the embodiment and therefore the methods and systems disclosed herein are not limited to a certain disease but includes a variety of inherent or acquired conditions, infectious or non-infectious diseases, and chronical or acute disorders.

The methods disclosed herein can be designed or customized in many different ways, e.g., for a single individual or a plurality of individuals. Further, the methods can be designed with respect to various condition(s) or aspect(s) that is/are associated with the target individual(s). Therefore, any methods that are configured to provide a customized/specialized drug treatment regimen to one or more target subjects, especially concerning one or more condition(s) (including pathological and non-pathological conditions) are with the scope of the various embodiments of the invention disclosed herein.

In some embodiments, the subject on which the methods are used is an individual that is considered generally healthy. In some other embodiments, the subject may have one or more abnormal conditions. Such an abnormal condition may include, but are not limited to, an inherent condition such as developmental delay or defect. In still some other embodiments, the subject may be afflicted with an acquired condition, e.g. an infection. Further, in still some other embodiments, the subject may be afflicted with or diagnosed with one or more pathological conditions (e.g., a cancer, benign growth or other type of neoplasia).

In several embodiments, the methods are used to generate patient-specific therapies to treat target tissues that are infected, for example with one or more bacteria, viruses, fungi, and/or parasites. In several embodiments, the infections of bacterial origin may include, but are not limited to, infections with bacteria is selected the group of genera consisting of Bordetella, Borrelia, Brucella, Campylobacter, Chlamydia and Chlamydophila, Clostridium, Corynebacterium, Enterococcus, Escherichia, Francisella, Haemophilus, Helicobacter, Legionella, Leptospira, Listeria, Mycobacterium, Mycoplasma, Neisseria, Pseudomonas, Rickettsia, Salmonella, Shigella, Staphylococcus, Streptococcus, Treponema, Vibrio, and Yersinia, and mutants or combinations thereof.

In several embodiments, the methods are used to generate patient-specific (based on both mutation and pharmacogenomic analysis of the patient) therapies treat a variety to treat viral infections, such as those caused by one or more viruses selected from the group consisting of adenovirus, Coxsackievirus, Epstein-Barr virus, hepatitis a virus, hepatitis b virus, hepatitis c virus, herpes simplex virus, type 1, herpes simplex virus, type 2, cytomegalovirus, ebola virus, human herpesvirus, type 8, HIV, influenza virus, measles virus, mumps virus, human papillomavirus, parainfluenza virus, poliovirus, rabies virus, respiratory syncytial virus, rubella virus, and varicella-zoster virus.

In several embodiments, the methods disclosed herein can be used to develop patient-specific therapies to treat chronic diseases, including but not limited to neurological impairments or neurodegenerative disorders (e.g., Alzheimer's disease, Parkinson's disease, Huntington's disease, epilepsy, dopaminergic impairment, dementia resulting from other causes such as AIDS, multiple sclerosis, amyotrophic lateral sclerosis, cerebral ischemia, physical trauma any other acute injury or insult producing neurodegeneration), immune deficiencies, repopulation of bone marrow (e.g., after bone marrow ablation or transplantation), arthritis, auto-immune disorders, inflammatory bowel disease, cancer, diabetes, muscle weakness (e.g., muscular dystrophy, amyotrophic lateral sclerosis, and the like), progressive blindness (e.g. macular degeneration), and progressive hearing loss.

In several embodiments, the methods are used to generate patient-specific (based on both mutation and pharmacogenomic analysis of the patient) therapies treat a variety of cancers, including but not limited to acute lymphoblastic leukemia (ALL), acute myeloid leukemia (AML), adrenocortical carcinoma, kaposi sarcoma, lymphoma, gastrointestinal cancer, appendix cancer, central nervous system cancer, basal cell carcinoma, bile duct cancer, bladder cancer, bone cancer, brain tumors (including but not limited to astrocytomas, spinal cord tumors, brain stem glioma, craniopharyngioma, ependymoblastoma, ependymoma, medulloblastoma, medulloepithelioma, breast cancer, bronchial tumors, burkitt lymphoma, cervical cancer, colon cancer, chronic lymphocytic leukemia (CLL), chronic myelogenous leukemia (CIVIL), chronic myeloproliferative disorders, ductal carcinoma, endometrial cancer, esophageal cancer, gastric cancer, Hodgkin lymphoma, non-Hodgkin lymphoma hairy cell leukemia, renal cell cancer, leukemia, oral cancer, liver cancer, lung cancer (including but not limited to, non-small cell lung cancer, (NSCLC) and small cell lung cancer), pancreatic cancer, bowel cancer, lymphoma, melanoma, ocular cancer, ovarian cancer, pancreatic cancer, prostate cancer, pituitary cancer, uterine cancer, and vaginal cancer.

Drugs that are applicable to the methods disclosed herein comprises any synthetic or natural compound that can be used to prevent and/or treat any condition. Drugs are not limited to a compound that is generally considered of medicinal purpose (e.g., a prescribed or over the counter drug) but may also include any dietary or nutrition supplement(s). Therefore, for example, a vitamin, a mineral, an herb or other botanical, an amino acid, a dietary substance for use by man to supplement the diet by increasing the total dietary intake (e.g., enzymes or tissues from organs or glands), or a concentrate, metabolite, constituent or extract can also be applicable to the methods disclosed herein.

In some embodiments, the methods disclosed herein comprise one or more of a genetic profiling of a subject, a pharmacogenomic analysis of the subject, and a drug monitoring analysis of one or more drugs that the subject is, or will be, taking.

In one aspect, the methods comprise a pharmacogenomics analysis of the subject. Genetic profiling and/or a drug monitoring analysis are optional. In some embodiments, the methods comprise all three of a genetic profiling, a pharmacogenomics analysis, and a drug monitoring analysis. In some embodiments, the methods may comprise a pharmacogenomics analysis and a drug monitoring analysis but not a genetic profiling. In some other embodiments, the methods may comprise a genetic profiling and a pharmacogenomics analysis but not a drug monitoring analysis. In certain embodiment, a genetic profiling of a subject may generally be employed when a target subject or a group of target subjects has one or more medical conditions, e.g. cancer. In such an example, the genetic profiling can be conducted to identify one or more genetic variations or alterations that may be associated with the condition(s).

In several embodiments, the methods comprise a genetic profiling of a subject. The genetic profiling may comprise an analysis of the DNA of a patient at least in some embodiments. Genetic profiling generally refers to any process to test and identify one or more genetic alterations or variants present in the genome of a subject, or in specific cells of a subject (e.g., tumor cells). One or more genetic alterations or variants may include one or more selected from the group consisting of mutations, polymorphisms, deletion, duplication and any mixtures thereof. In some embodiments, the genetic profiling may comprise analysis of the subject's nucleic acid sequences. In some other embodiments, the genetic profiling may comprise analysis of DNA, RNA or both isolated from the subject.

In several embodiments, the DNA analyzed is isolated from a subject, and more particularly from a diseased tissue (e.g. tumor), to determine specific mutations in those cells that may be exploited in a therapeutic sense. In several embodiments, samples are collected from a patient, such as saliva, serum, blood, plasma, biopsy, etc.

DNA isolation and sequence analysis is then performed on the sample to identify particular genetic mutations, gene fusions or other mutations that may be helpful in diagnosing a patient. In several embodiments, the sequence data from the patient is compared to sequences of normal cells of the patient and/or to DNA sequences from normal cell populations. DNA sequence analysis can be through Sanger-based methods. In several embodiments, however, higher throughput methods are used, such as, for example, microelectrophoretic methods, sequencing by hybridization, real-time observation of single molecules, and cyclic-array sequencing. Alternatively or in combination with the sequence analysis, any other suitable techniques such as a single nucleotide polymorphism (SNP) profiling assay can be applied to determine the genetic profile of a subject or patient.

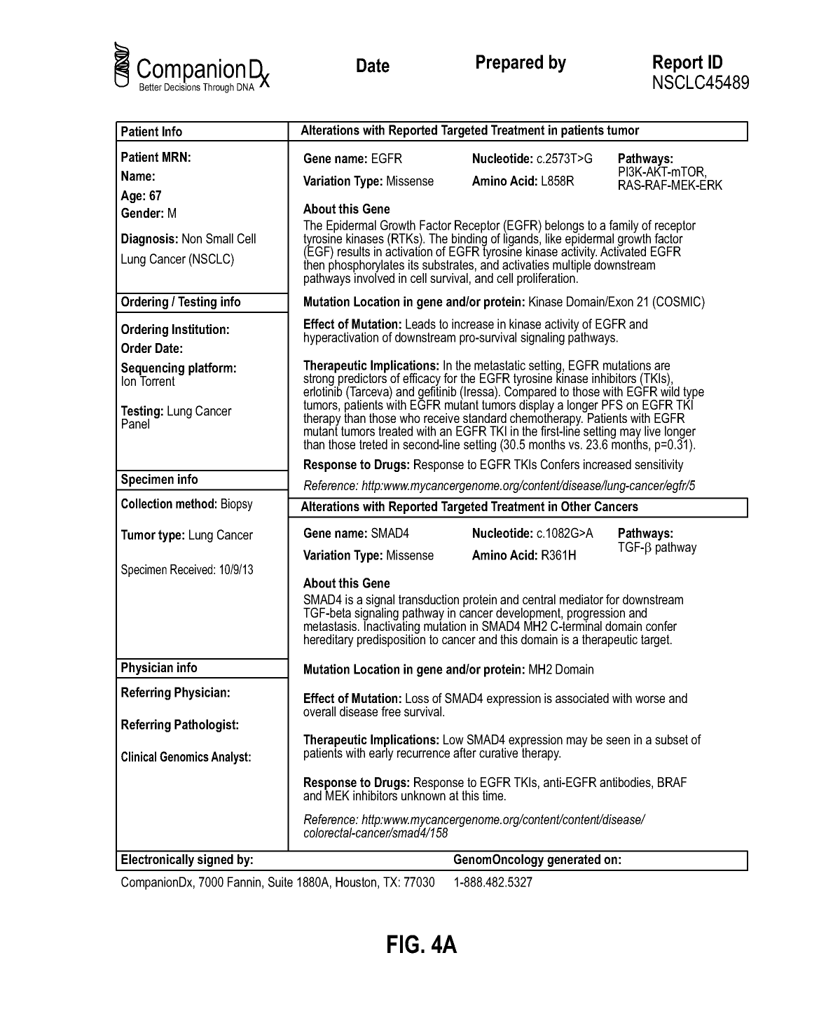

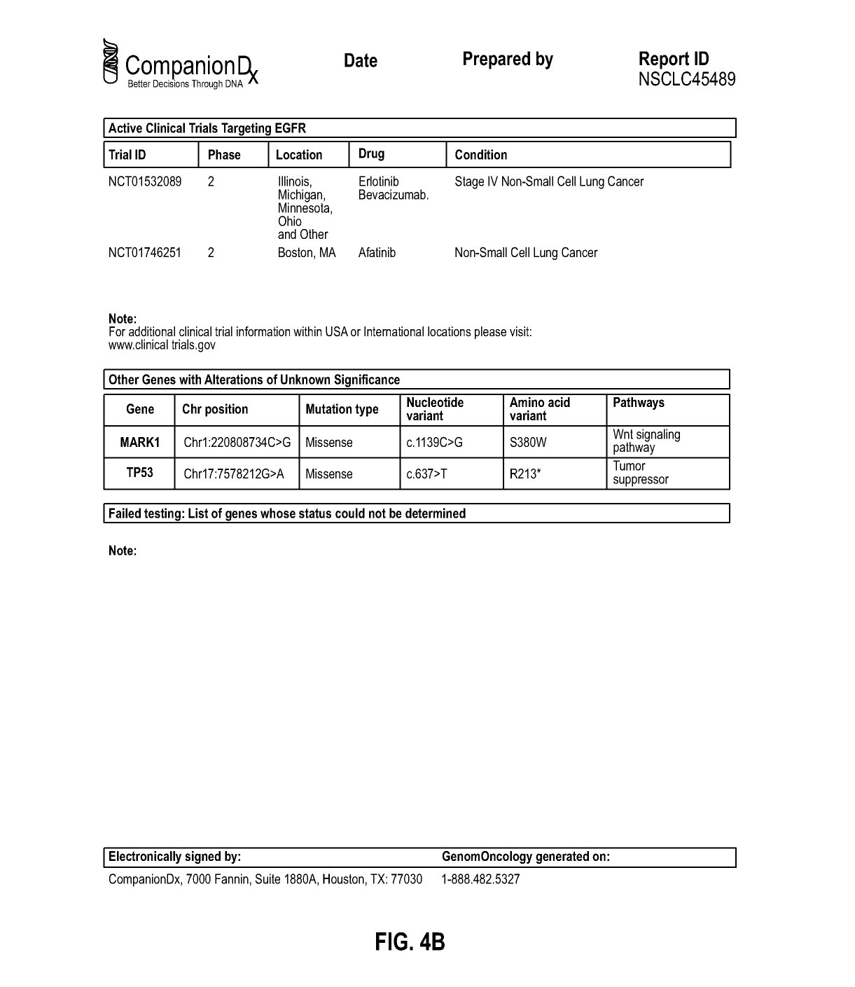

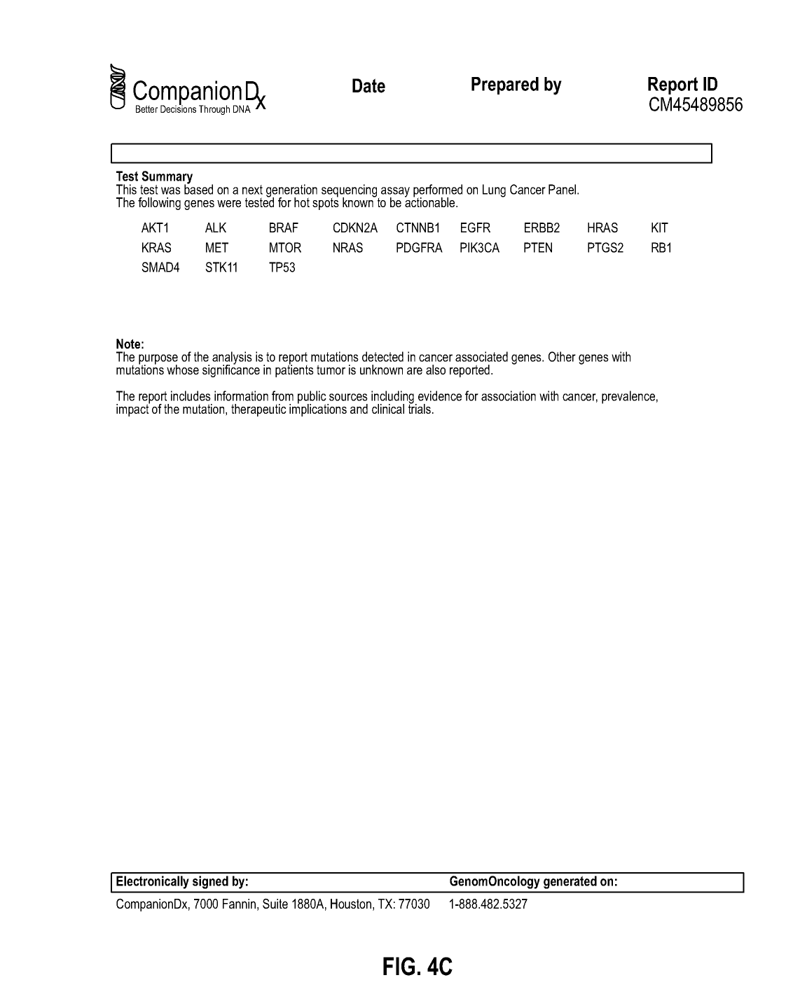

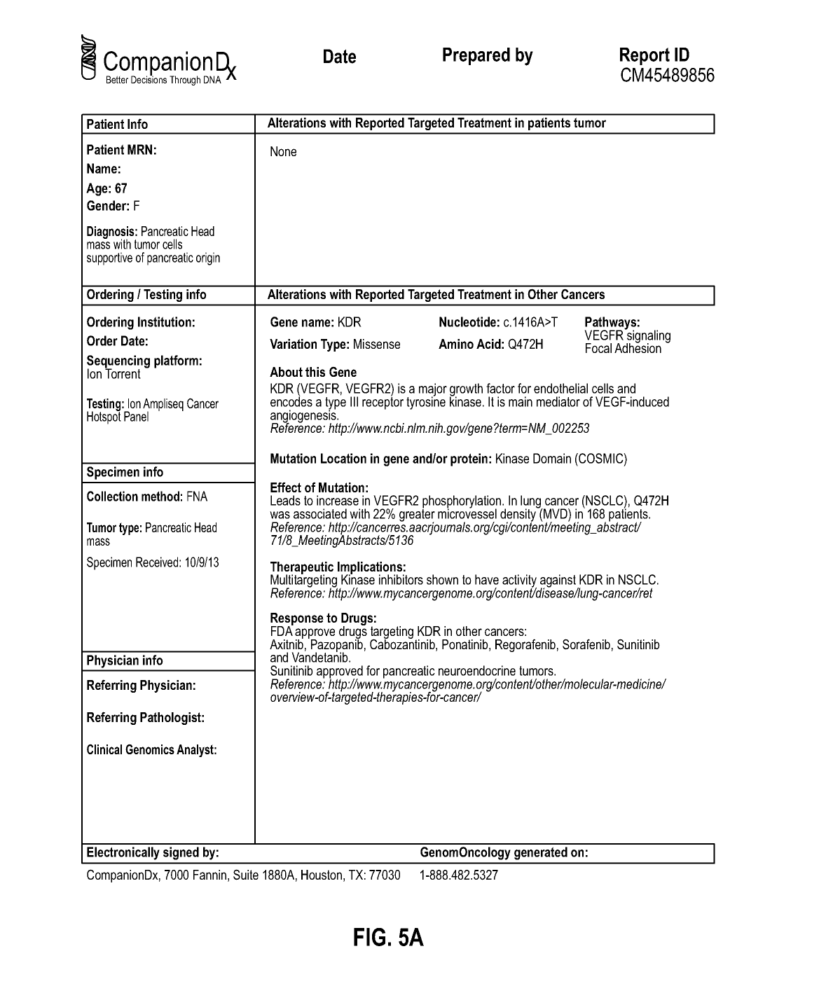

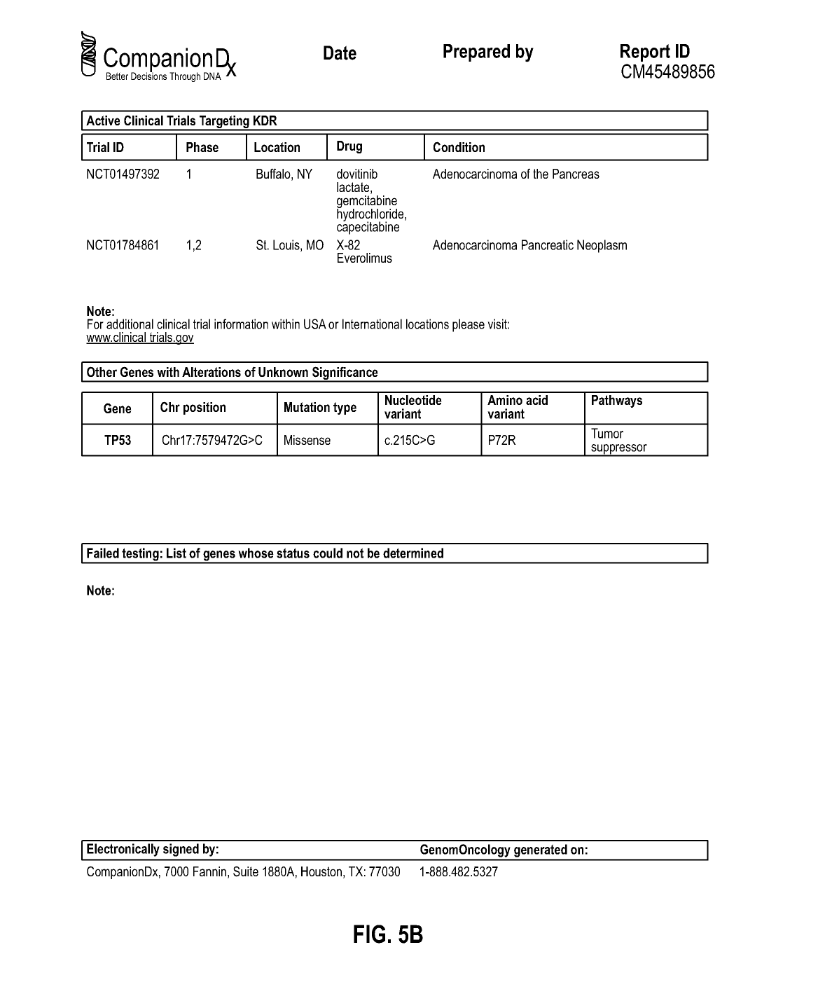

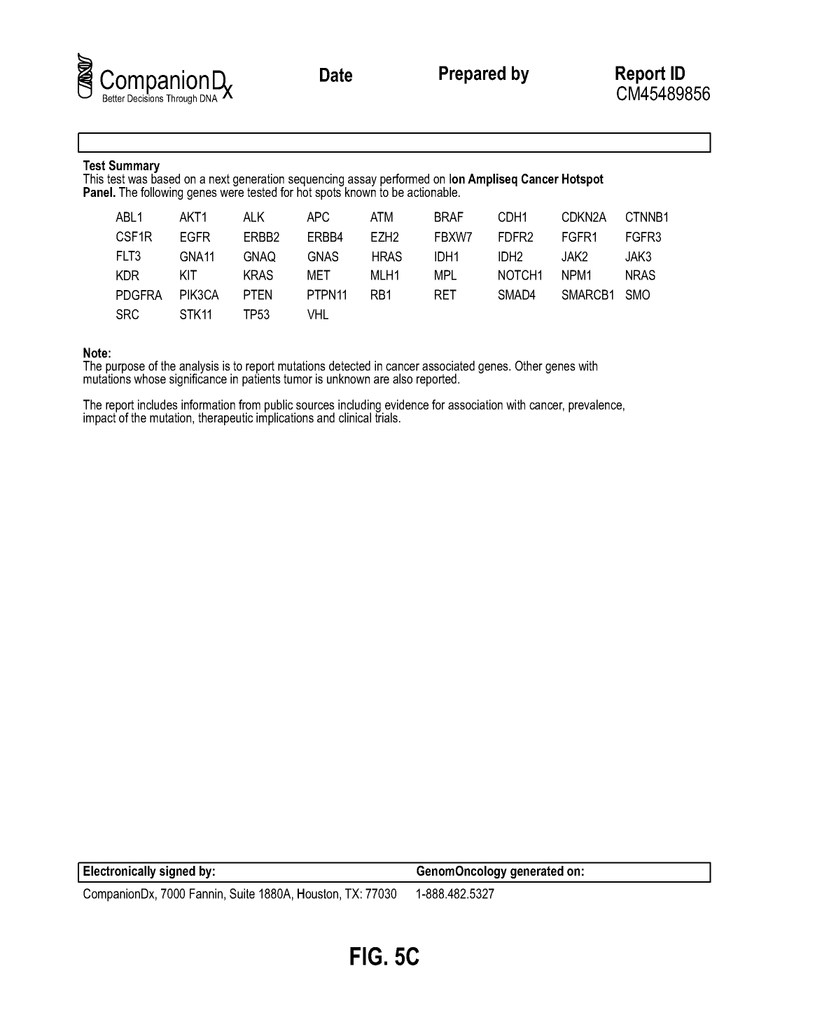

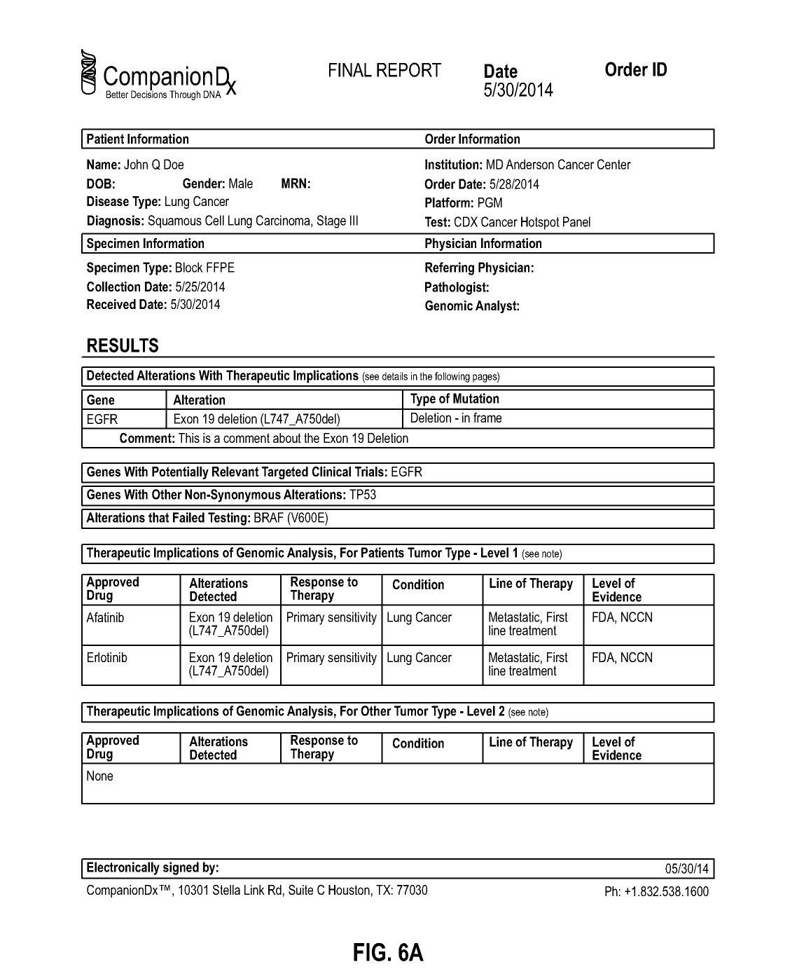

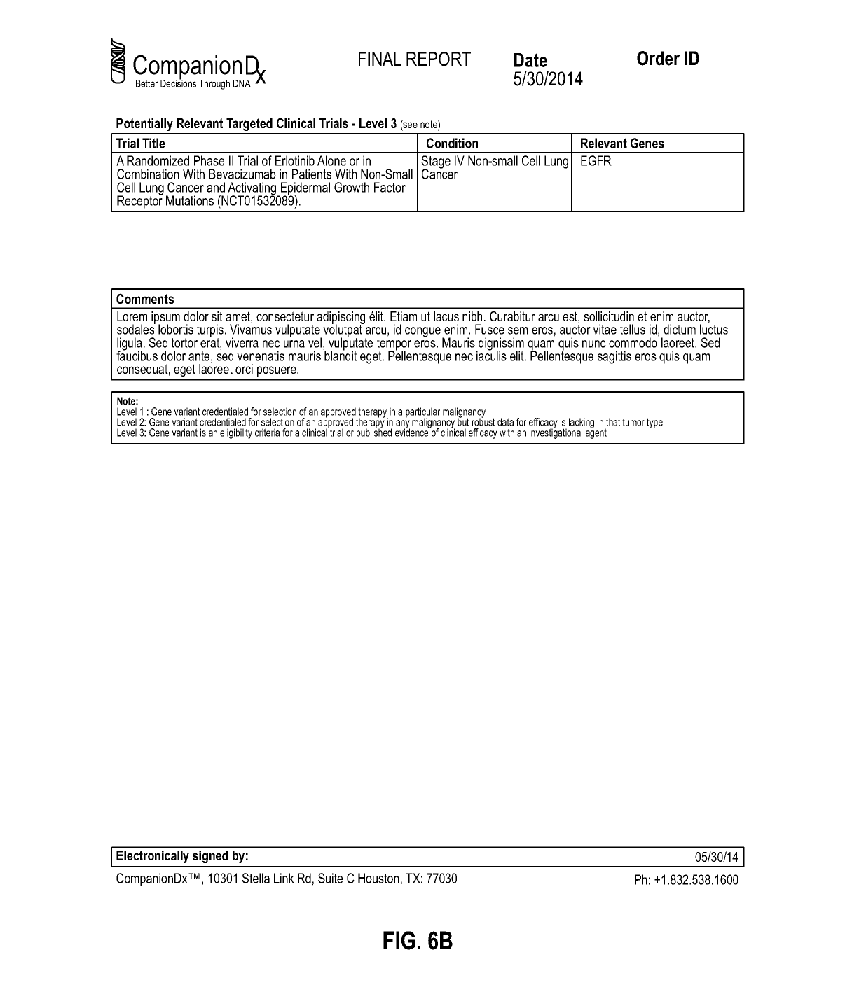

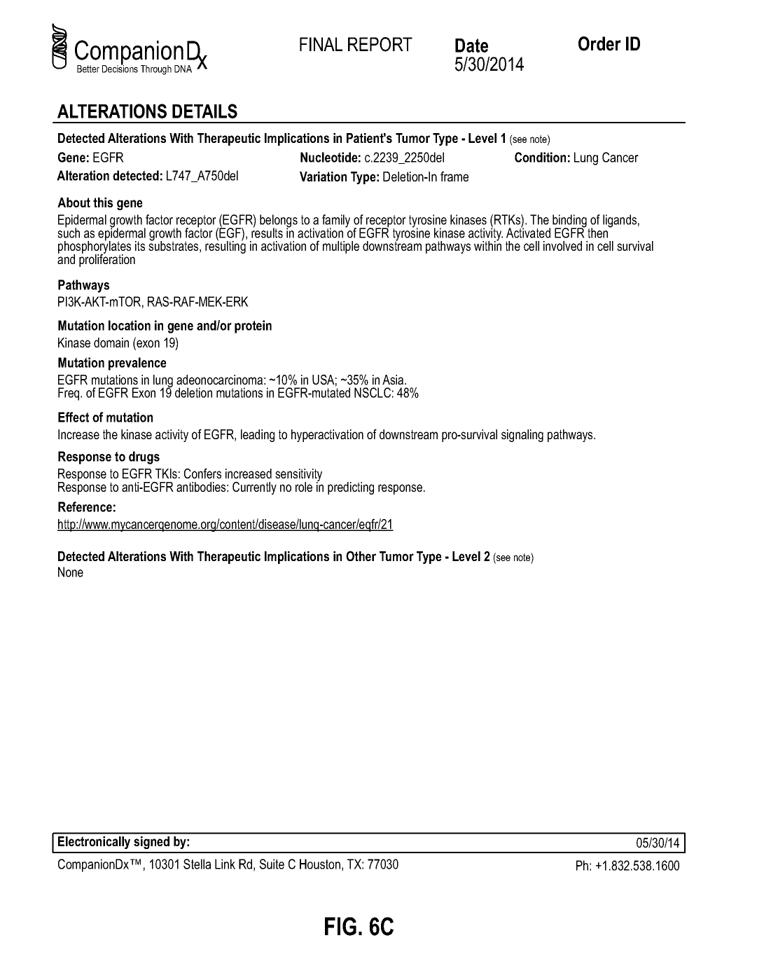

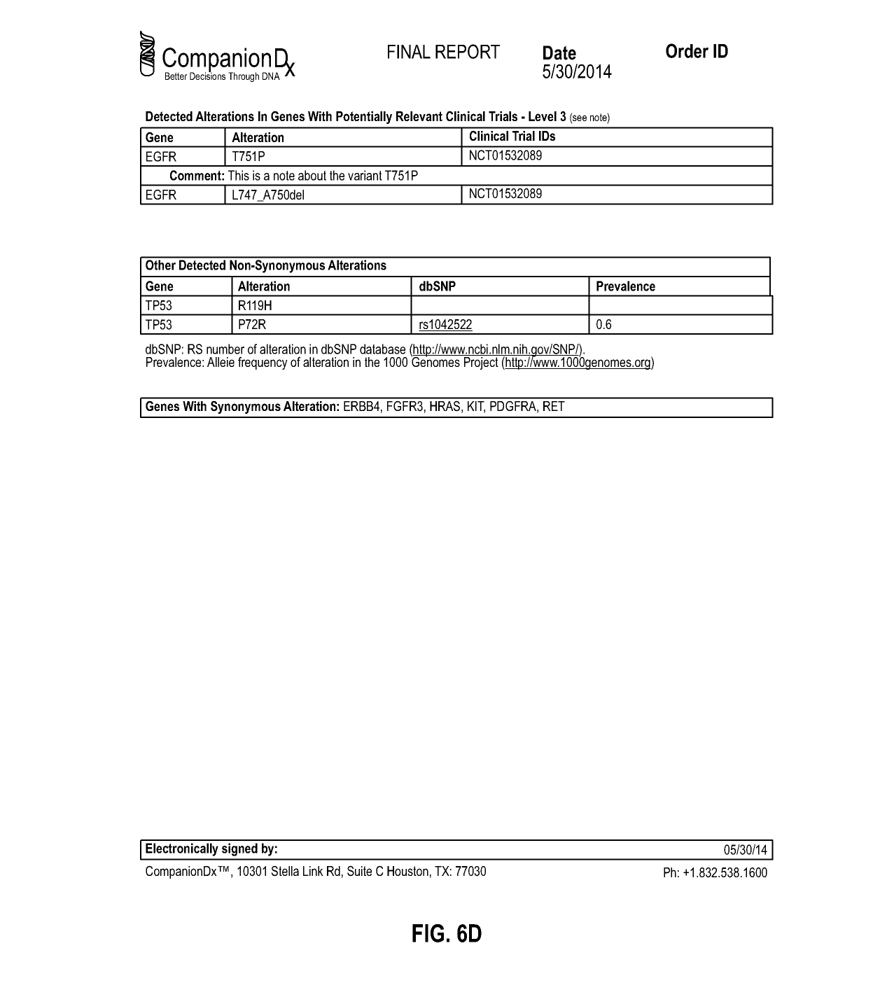

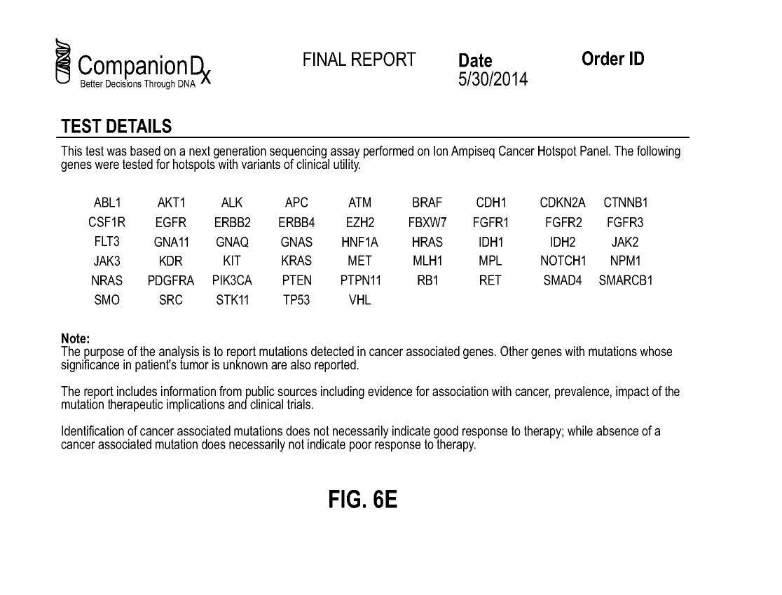

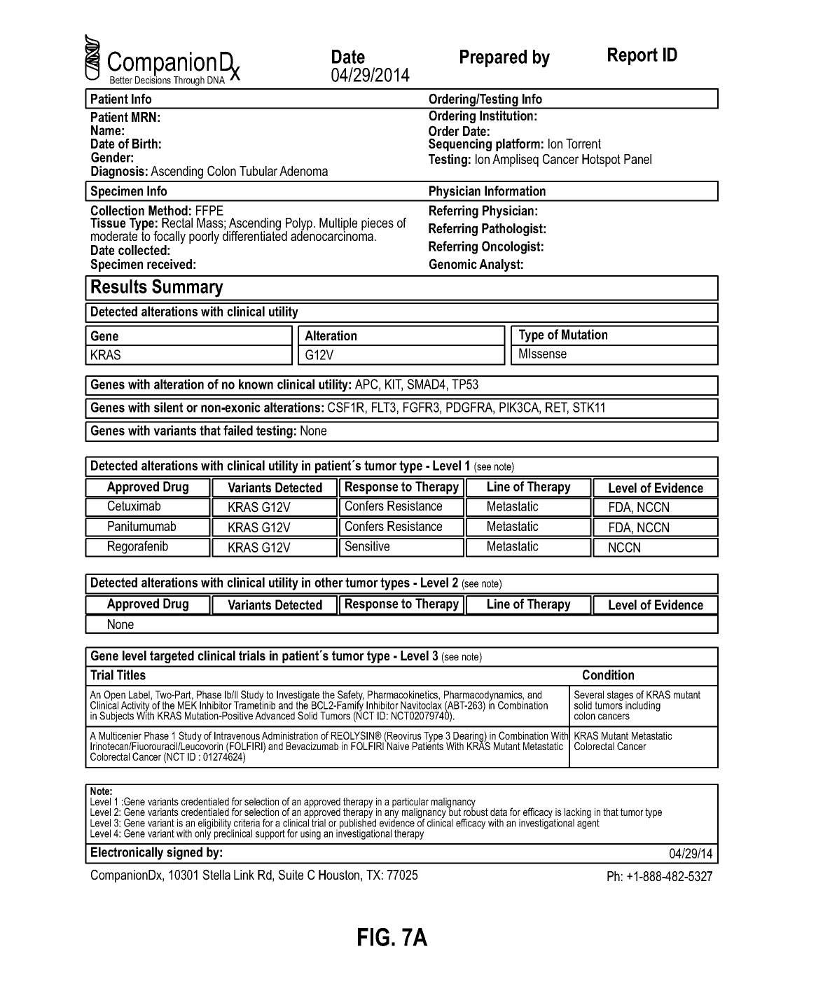

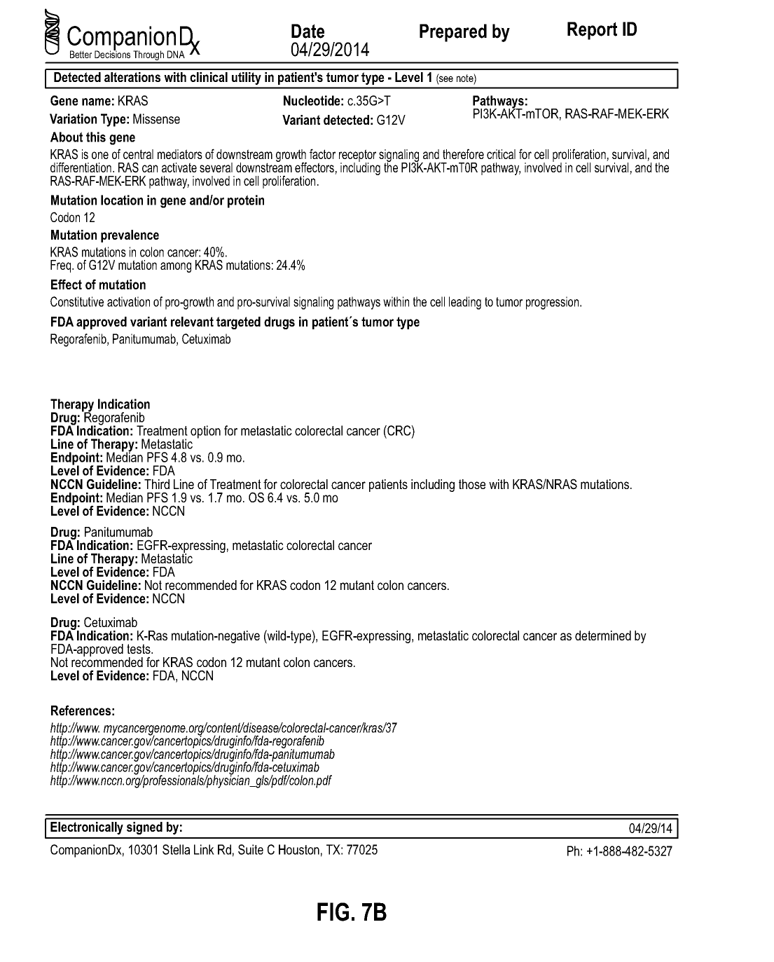

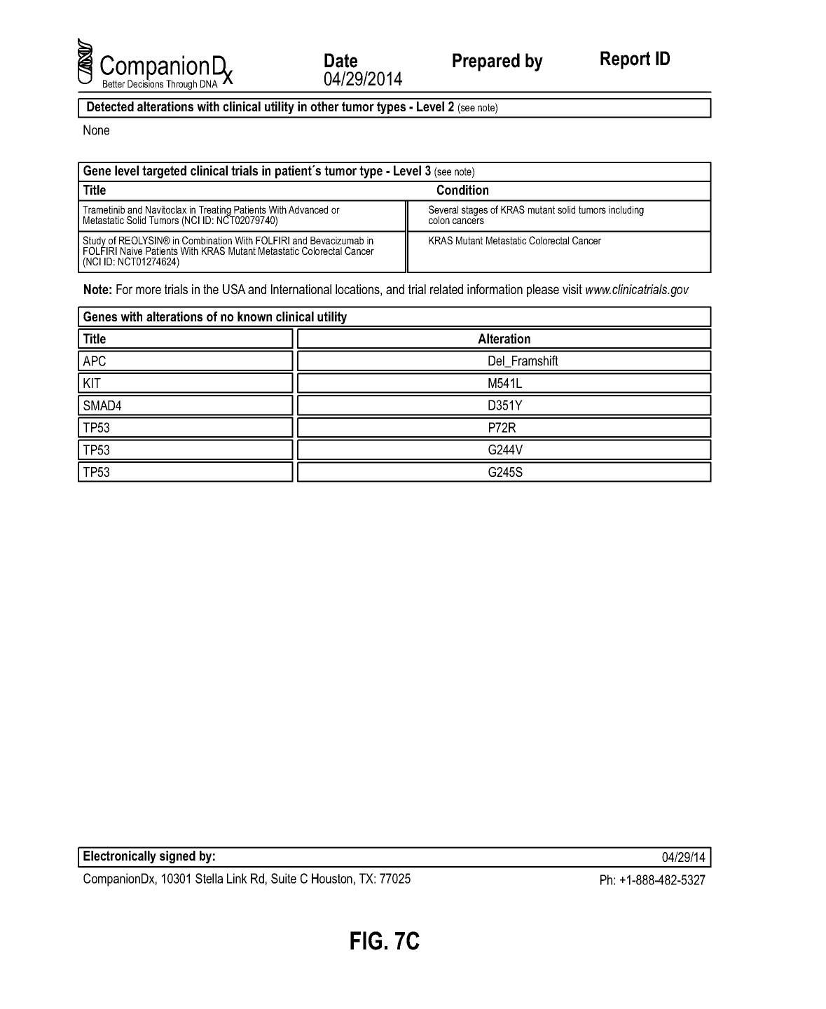

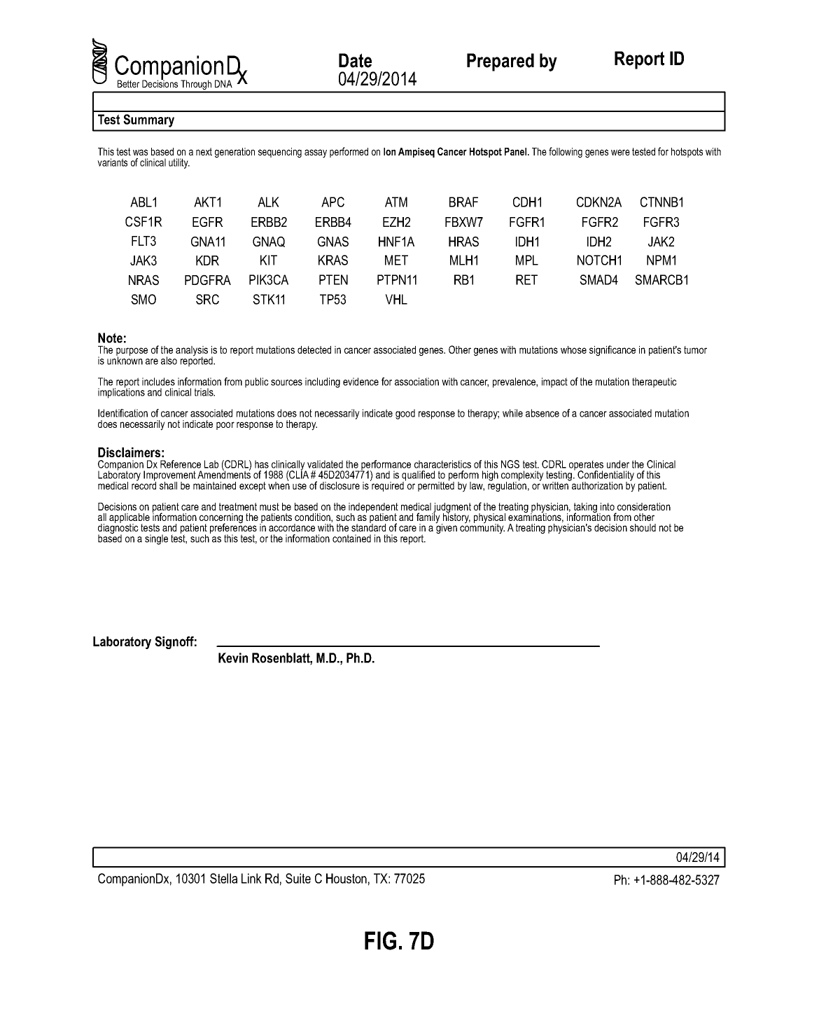

Genes or parts thereof that may be targeted in the genetic profiling protocol may comprise genes that may be associated with the subject's condition. Therefore, in one example where a subject has been diagnosed with breast cancer, variations on one or more genets that are known be associated with the disease, e.g. BRCA1, BRCA2, CDH1, STK11, TP53, AR, ATM, BARD1, BRIP1, CHEK2, DIRAS3, ERBB2, NBN, PALB2, RAD50, and RAD51 can be tested. In some embodiments, in addition to the genes that are known to be associated with a certain type of cancer that a target patient was diagnosed with, some other genes that are known to be associated with other types of cancer or cancer in general can be tested. Thus, in one non-limiting example illustrated in FIGS. 4A-4C where a patient was diagnosed with lung cancer, the “hot spots” on the genes known to be actionable in lung cancer and other types of cancer, e.g. AKT1, ALK, BRAF, CDKN2A, CTNNB1, EGFR, ERBB2, HRAS, KIT, KRAS, MET, MTOR, NRAS, PDGFRA, PIK3CA, PTEN, PTGS2, RBI, SMAD4, STK11, and TP53 were tested. In another non-limiting example illustrated in FIGS. 5A-5C where a patient diagnosed with pancreatic head mass with tumor cells supportive of pancreatic origin was tested, the genetic variations or mutations on certain genes selected from the hot spot regions that are frequently mutated in human cancer genes were tested. The specific, selected genes for the test are shown in the “Test Summary” section. FIGS. 6A-6E and 7 provide additional non-limiting examples of reports generated from the genetic profiling analysis of certain embodiments of the methods disclosed herein. The report shown in FIG. 6 was generated from the genetic profiling analysis of a patient diagnosed with squamous cell lung carcinoma stage III. The test was conducted to monitor genetic variations or mutations on the genes listed in page 5 of the report and determined the presence of deletion mutation in the EGFR gene. The report further provided a list of approved drugs that are known to be effective to the diseases or conditions that are associated with the mutations on EGFR. The report shown in FIGS. 7A-7D was generated from the genetic profiling analysis of a patient diagnosed with ascending colon tubular adenoma. The test was conducted to monitor genetic variations or mutations on the genes listed in page 4 of the report and determined the presence of missense mutation in the KRAS gene. The report further provided a list of approved drugs that are known to be effective to the diseases or conditions that are associated with the mutations on KRAS. The drugs identified as being relevant or effective to the specific mutations detected from the subject (or patient) may be further studied in the following pharmacogenomics analysis.

The information on the genes that may be associated with a specific disease can be obtained and/or readily accessible in many sources such as publically available databases (e.g. “The Cancer Genome Atlas” managed by National Cancer Institute, “Catalogue of Somatic Mutations in Cancer (COSMIC)” managed by Wellcome Trust Sanger Institute, and “My Cancer Genome”™ that is managed by Vanderbilt-Ingram Cancer Center). Alternatively or in combination, a commercial database or software that may contain relevant information about genes associated with a variety of diseases can be employed in the genetic profiling protocols disclosed herein. Therefore, one skilled in the art who wishes to conduct the methods can readily select one or more genes that are known to be associated with the condition or disease of the subject. Any manners or approaches to select such genes for the genetic profiling of the method disclosed herein are therefore within the scope of the embodiments of the inventions disclosed herein.

Once the genetic profiling is conducted so that the information on genetic variations (including, but not limited to, mutations, alterations, deletions, duplications, polymorphisms and variants) of certain genes that may be associated with the subject's disease or condition is identified, such information may be further processed to identity any drugs that may be associated with such genetic variations. The information related to the drugs that may be associated with the genetic variations is also readily obtainable and accessible via various public databases, e.g. “My Cancer Genome”™ that is managed by Vanderbilt-Ingram Cancer Center, “CANSAR” managed by the Institute of Cancer Research, UK, and “Genomics of Drug Sensitivity in Cancer” managed by the Wellcome Trust Sanger Institute, or commercial databases, e.g. Oncomine Cancer Research Knowledgebase (Thermo Fisher Scientific Inc., Waltham, Mass.). In several embodiments, a proprietary database is used. Thus, any manner or approach to identify (or select) a drug (or drugs) that may be associated with treating the subject's genetic variations according to the method are therefore within the scope of the inventions disclosed herein. The selected drugs from this method can be considered as candidate drugs for the subject-specialized (customized) drug therapy.

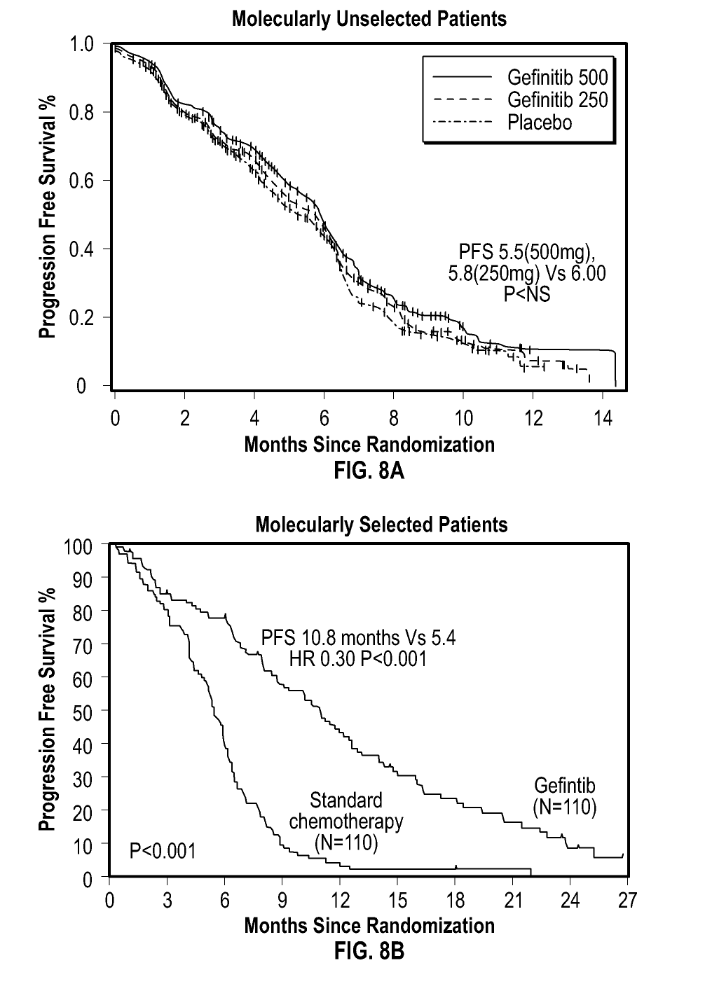

The efficacy of the genetic profiling analysis of a subject and identification of certain candidate drugs that may be associated with the subject's genetic mutations is shown in the data provided in FIG. 8. The data of FIG. 8 were obtained by taking a group of non-small cell lung cancer patients from the cancer genome atlas (TCGA) as a test group. Non-small cell lung cancer (NSCLC) is known to be linked to one or more genetic variations and some of such NSCLC-associated genetic variations are provided in Table 6. Table 6 also shows some candidate drugs that are known to be specific to one or more of the NSCLC-associated genetic variations. One of frequent genetic markers detected from NSCLC patients is a mutation in EGFR. The database search for the therapeutic drugs associated with EGFR mutation(s) may identify, among others, Gefitinib as a candidate drug.

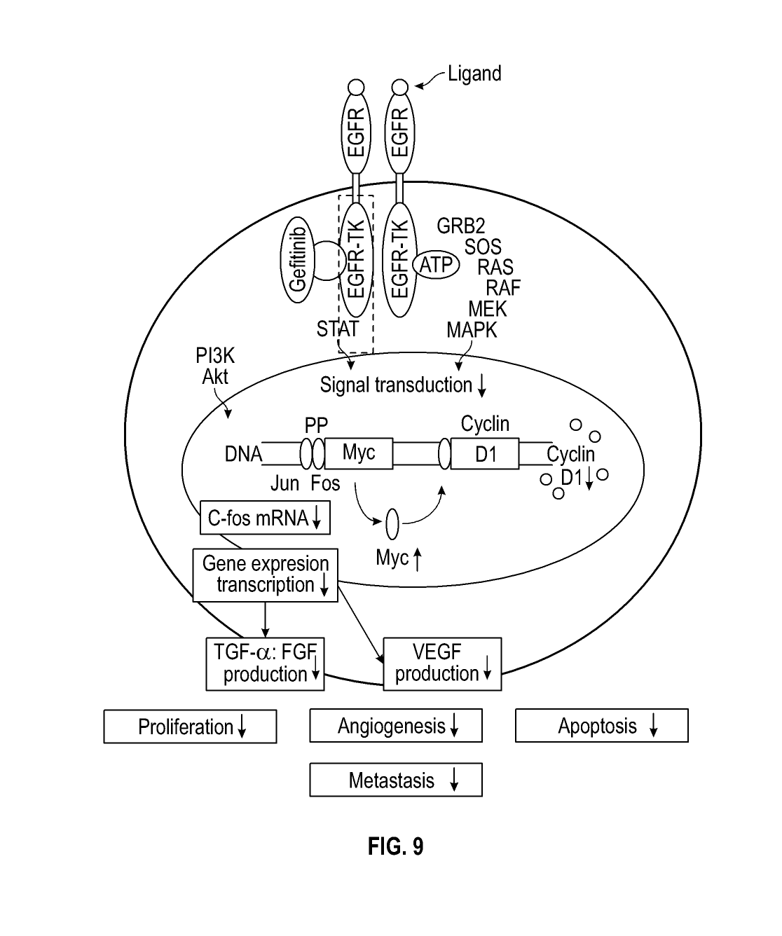

Gefitinib is a drug used for certain types of cancer including lung cancer. Gefitinib is generally orally administered and a reversible tyrosine kinase inhibitor (TKIs) of an Epidermal Growth Factor Receptor (EGFR) inhibitor. The EGFR family includes four different tyrosine kinase receptors, EGFR (ErbB-1), ErbB-2, ErbB-3 and ErbB-4. The schematic diagram showing the EGFR signaling pathway is provided in FIG. 9. Gefitinib has an inhibitory effect both on the autophosphorylation and downstream signaling.

Given gefitinib has a specific activity to the EGFR pathway, the treatment of this drug to NSCLC patients who do not have EGFR mutations is not expected to exhibit a significant effect in treating/controlling the disease. This is in fact the case as illustrated in FIG. 8. The figure shows the data obtained from the experiments in which the progression free survival rates (in %) were measured in two groups of NSCLC patients. The first group (A), which were retrieved from Giaccone et al. 2004, J. Clin. Oncol. 22(5): 777-84 (incorporated by reference herein) comprised molecularly unselected patients, i.e. randomly selected patients whose mutations in the EGFR pathway were not determined and considered. On the other hand, the second group (B), which were retrieved from Maemondo et al., 2010, New Eng. J. Med., 362: 2380-2388, (incorporated by reference herein) comprised molecularly selected patients, i.e. patients who were selected for having mutations in the EGFR pathway. As clearly seen from the comparative view of the data of (A) and (B), the progression free survival rate was significantly improved when the treatment of gefitinib was targeted to the patients having the EGFR mutation, i.e. the target of gefitinib. In (A), all the patients were treated with gefitinib, and there is no detectable change in graphs. In contrast, in (B) where the NSCLC patients having EGFR mutation were concerned, the treatment of gefitinib shows notably improved efficacy over the standard chemotherapy. The gefitinib treatment significantly enhanced the progression free survival rate and extended the life expediency by 5.4 months on average over that of the standard chemotherapy. This analysis demonstrates that determination of the patient's genetic profile and identification of specific drugs that may target the subject's mutations plays a key role in developing an effective personalized and optimized drug treatment regimen.

Once the information related to the candidate drugs is obtained, a report having such information can be generated or provided. Certain non-liming and illustrative of examples of such reports are provided in FIGS. 4 to 7. The report can contain any information related to the candidate drugs that may be associated with the subject's genetic variations. The information present in the report may comprise the genetic variations of the subject, one or more candidate drugs that are associated with the subject's genetic variations, the candidate drugs' pharmacological and pharmacokinetic data, and the like.

In some embodiments, the candidate drugs that are identified from the genetic profiling (e.g., a first group of candidate drugs) are further narrowed down via the pharmacogenomics analysis, thereby providing a second group of candidate drugs.

In some embodiments, the genetic profiling step is not necessary and thus the methods disclosed herein need not necessarily comprise a genetic profiling component. For example, if a target subject or a group of target subjects does not have a condition that is associated with genetic variations, the genetic profiling may not need to be conducted. Therefore, for instance, if the primary target conditions of the subject are believed to be, e.g. the infections by microorganisms (e.g. E. coli and/or Salmonella strains), one skilled in the art (e.g. a medical doctor or medicinal expert) can readily select or identify a group of candidate drugs (e.g., a first group of candidate drugs) that may be associated with or known to treat the infections. In such a case, the first group of candidate drugs can be identified without the genetic profiling data, and the following pharmacogenomics analysis can further narrow down to the second group of candidate drugs. In addition, as an additional example, where a general health condition of a group of subjects consuming high-fat diet is concerned and therefore a method for preventing or treating a condition(s) related to the high-fat diet is designed for such a group, no genetic profiling of the target subjects may be necessary. Instead, one or more drugs (or other agents) that are known to be effective in reducing or preventing the concerned condition related to the high-fat diet can be considered as the first group of candidate drugs.

In conjunction with the genetic profiling analysis that is performed on patient samples, a pharmacogenomics analysis can also be performed at least in some embodiments, with two main goals. First, the pharmacogenomics analysis returns information on the impact of genetic variation on the response to medications in patient and the possible drug-gene and drug-drug interactions that the patient may experience. Second, the pharmacogenomics analysis is interwoven with the mutation analysis to provide a smaller, more-directed set of possible treatment options for a patient, based on their unique genetic profile.

Various enzymatic systems exist in the human body that metabolize various compounds. While the cytochrome P450 system is described herein as one system that can be assessed, it shall be appreciated that other enzyme systems can also be evaluated by the methods disclosed herein (e.g., those systems that oxidize, reduce, hydrolyze, perform cyclization or decyclization, and/or those that are involved in excretion) for their potential roles in developing an efficacious tailored therapy regimen. The methods disclosed herein evaluate not only the functionality of a drug metabolism system of a specific patient, but also the possibility of drug-drug interactions for a patient (e.g., for those drugs that may be metabolized by the same pathway).

Cytochrome P450, is one of the most common enzymatic systems involved in the metabolism of drugs and understanding and/or avoid certain impacts (e.g., be they reduced metabolism of a drug by a specific patient or drug-drug interactions) on this may system be key to developing effective therapies.

Genetic mutations or polymorphisms (genetic variants) of CYP450 (or CYP) are known to exist among patients. Depending on the CYP phenotype encoded by a particular patient's genes, the metabolism of certain drugs may vary significantly. Thus, each person's ability to metabolize drugs is determined by the pairing of individual alleles he or she has inherited from his or her parents. Each allele may be categorized as a wild-type (functional) or variant (defective) allele. Wild-type alleles are considered “normal” and occur predominantly in the general population, whereas variant alleles may confer diminished or not activity. People who carry two wild type of alleles will generally have “normal” rates of metabolism (extensive metabolizers), whereas a person who carries two variant (defective) alleles will likely have little to no enzyme activity (poor metabolizers). Those who inherited one of each allele will have decreased enzymatic activity (intermediate metabolizers). In certain cases, when gene duplication or amplifications results in more than two gene copies of wild-type alleles, enzyme activity will be greater than normal (e.g., ultra-rapid metabolizers).

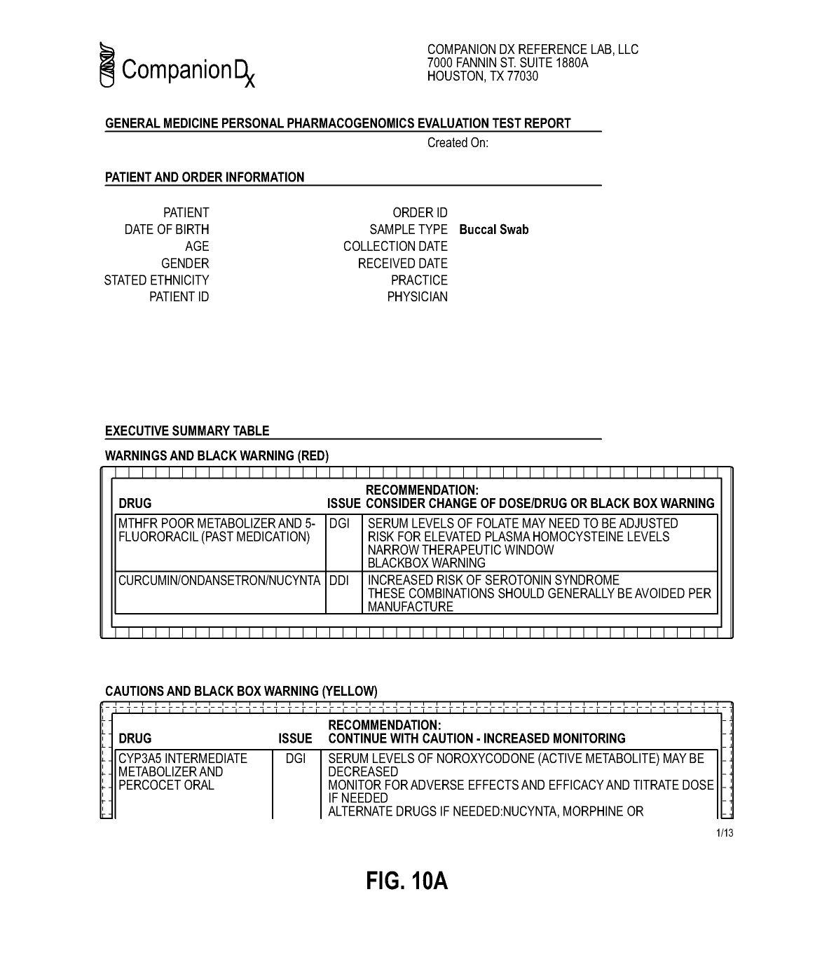

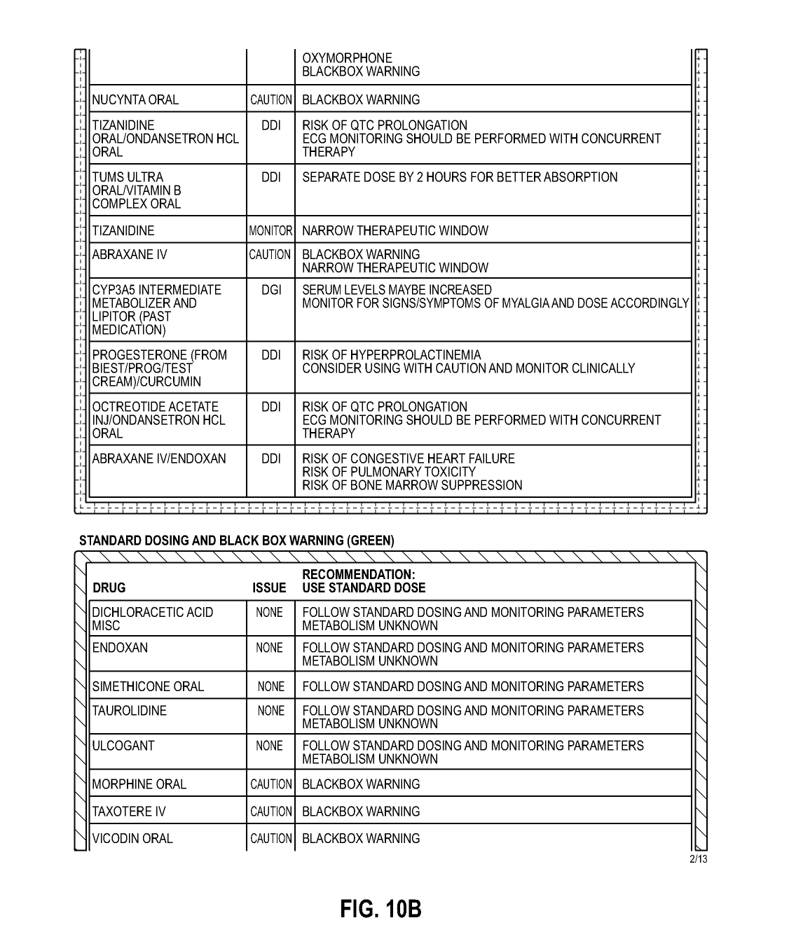

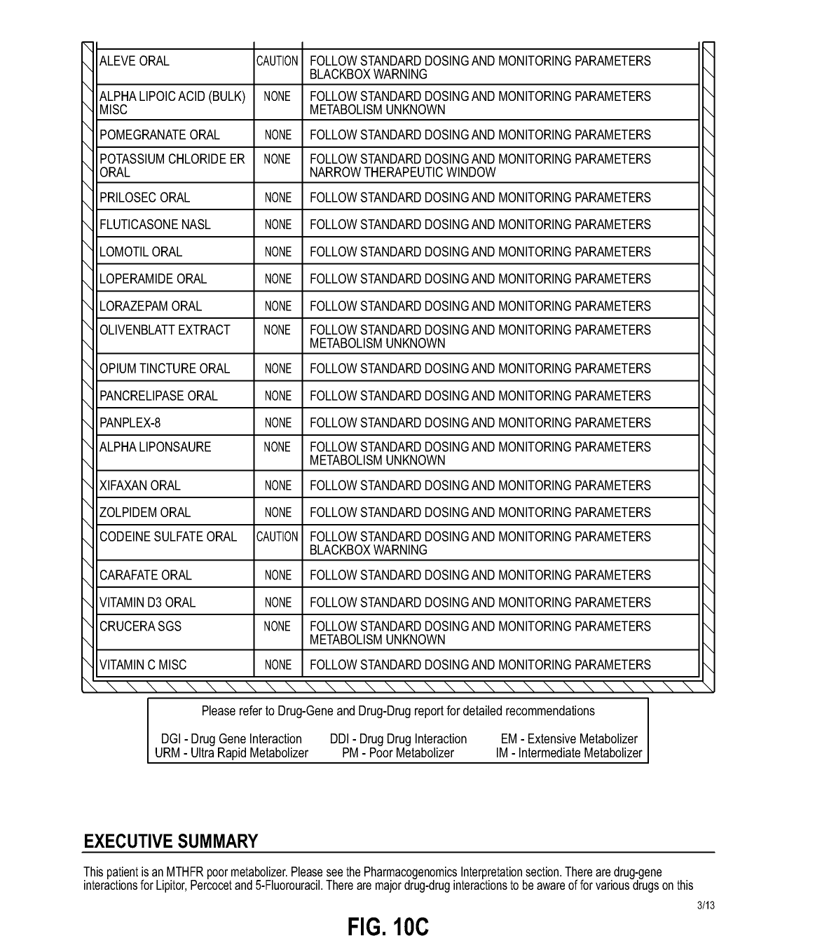

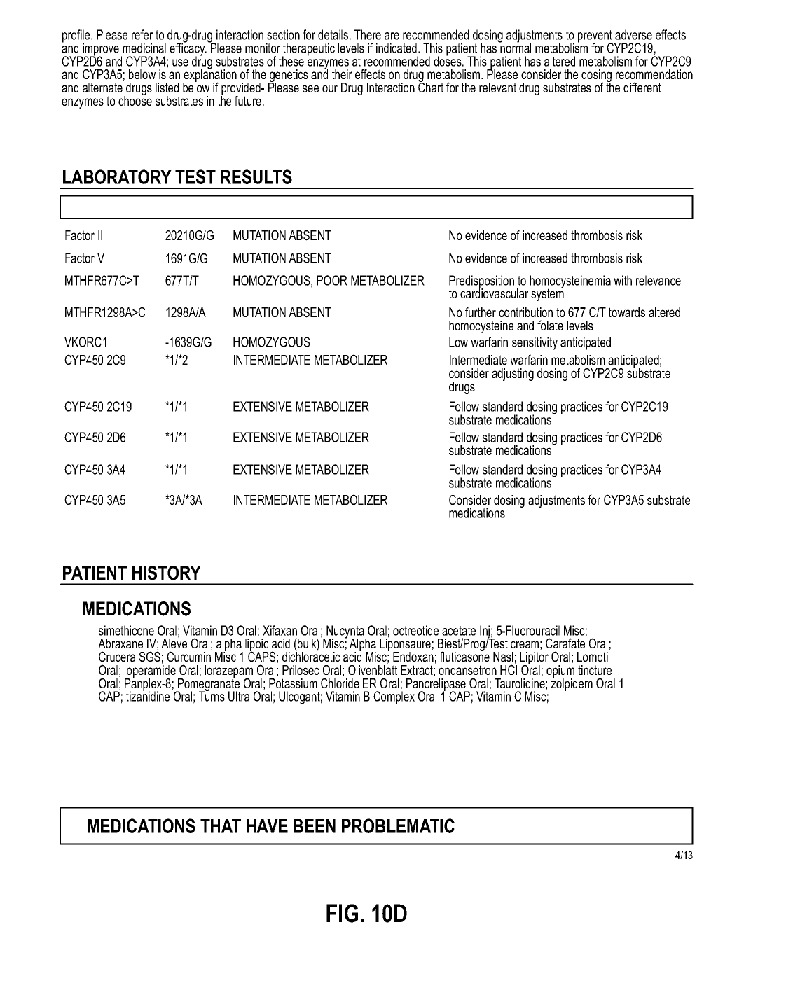

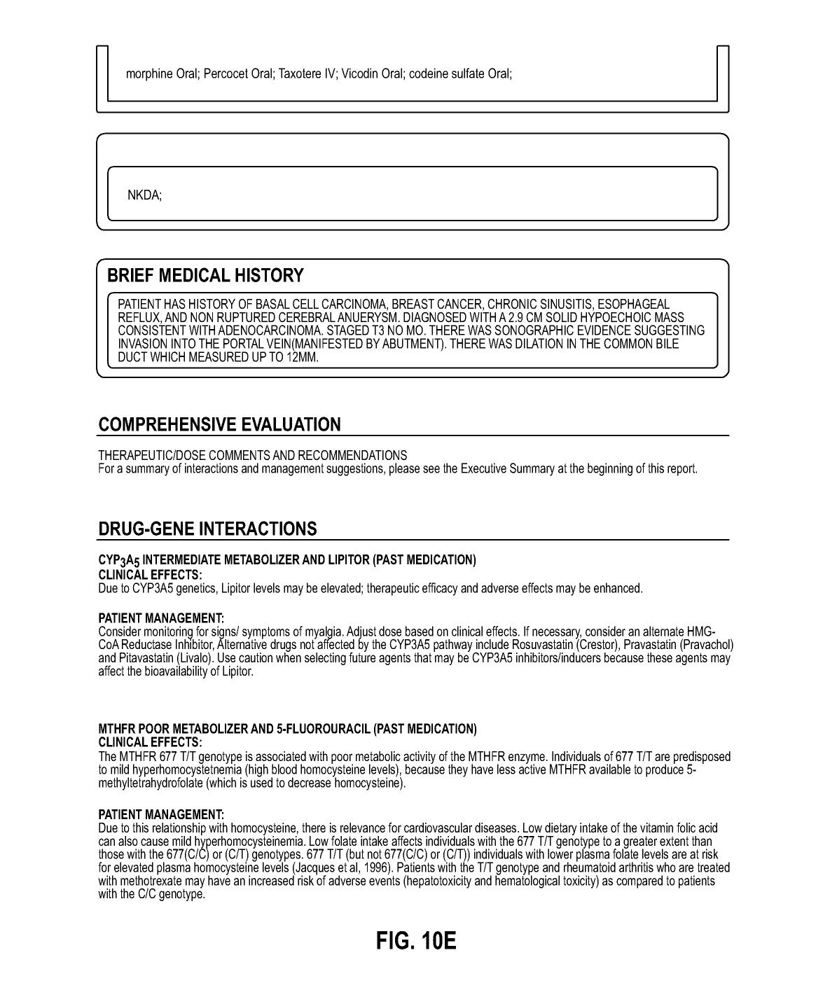

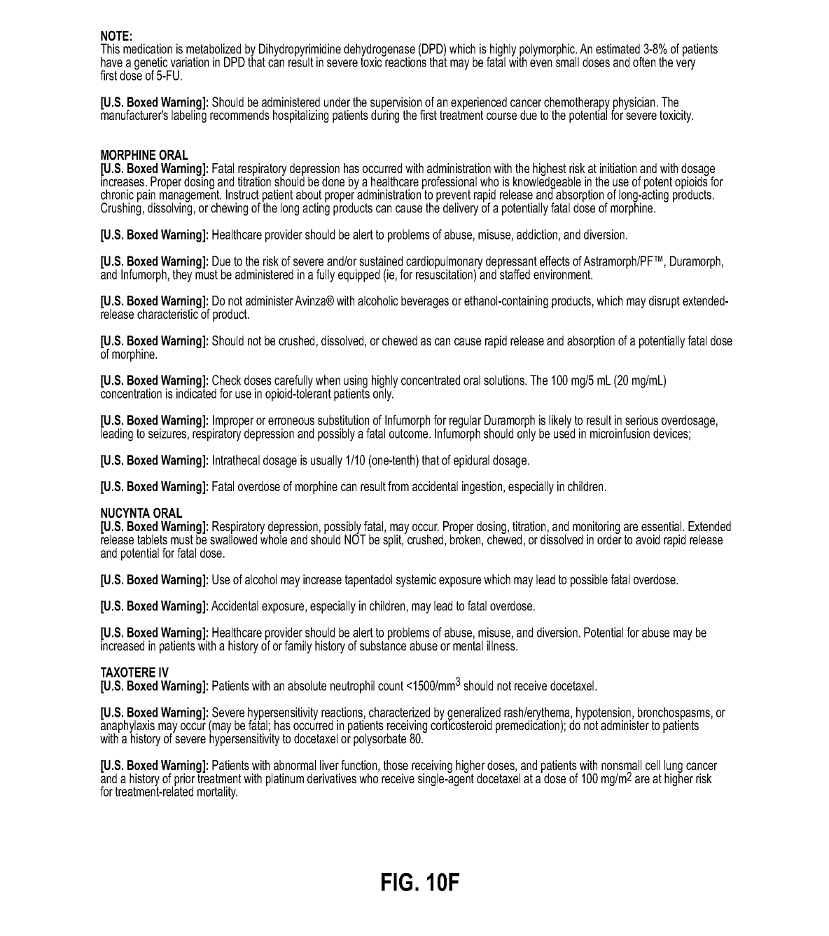

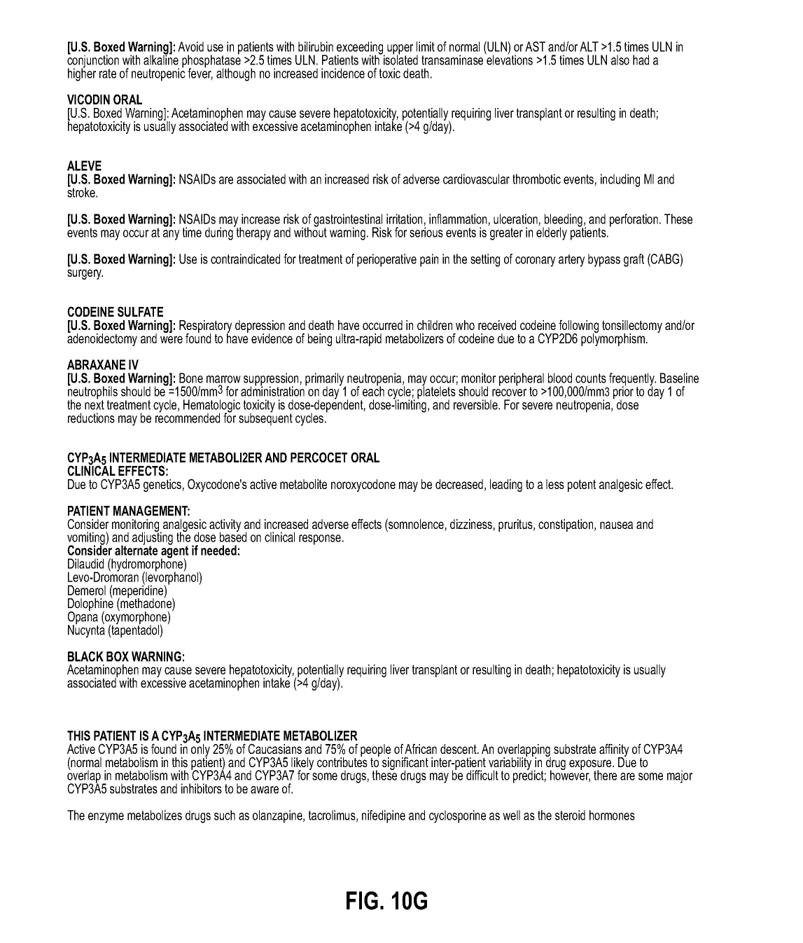

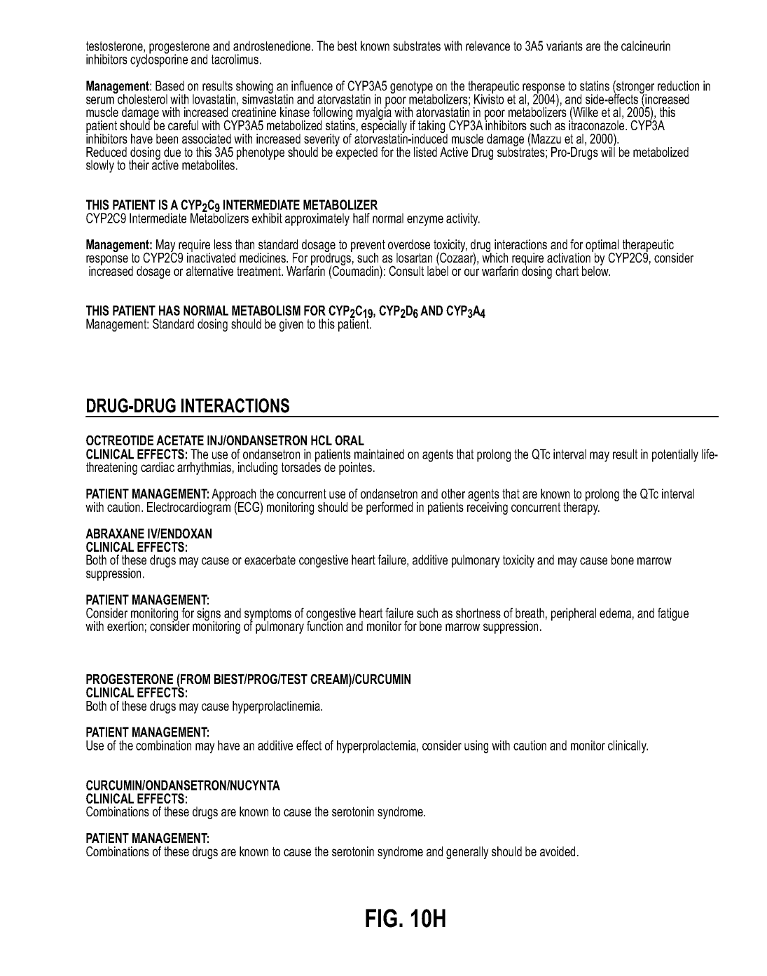

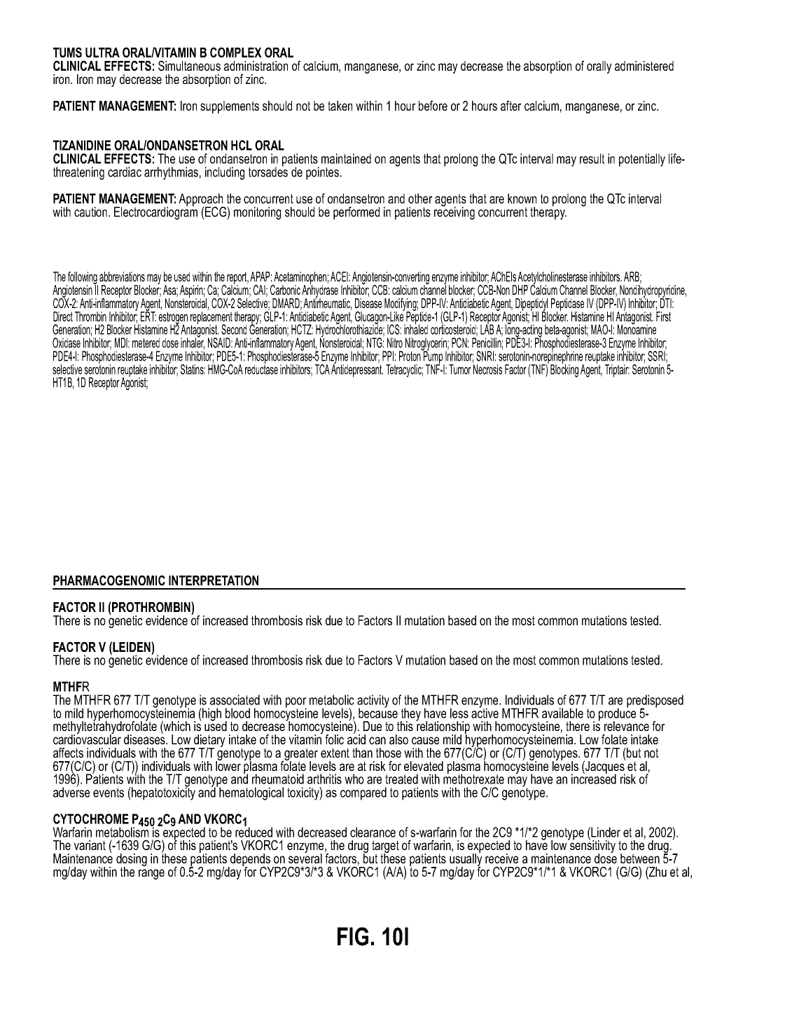

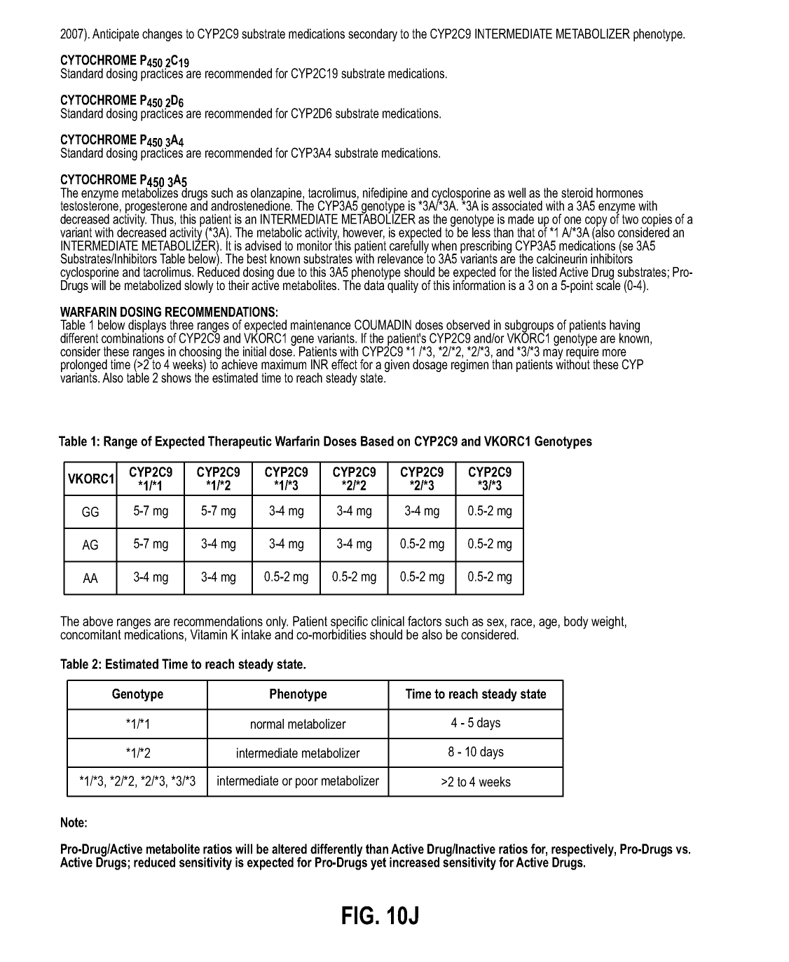

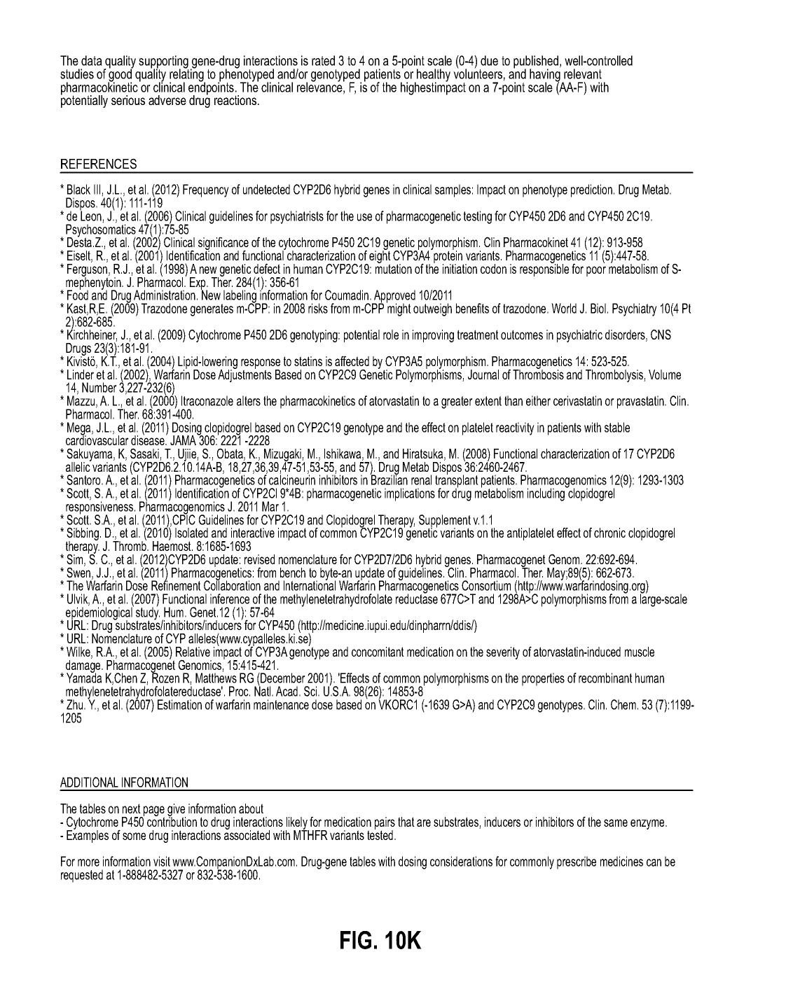

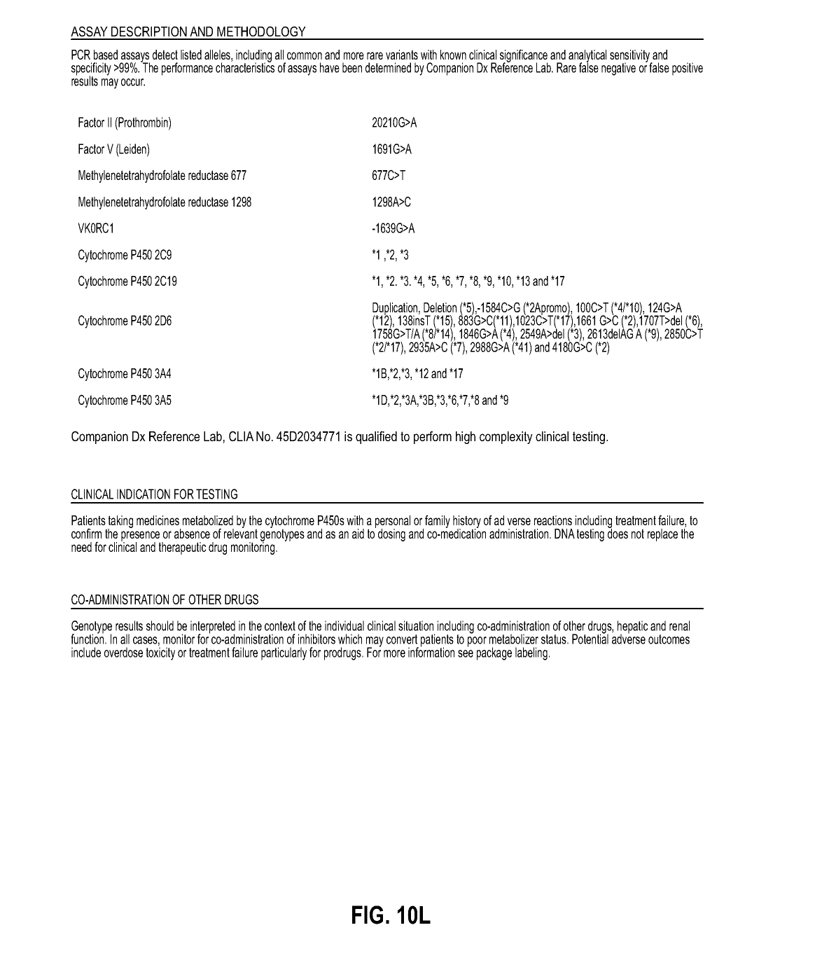

Genetic polymorphisms can have a significant impact on drug therapy and should be taken into consideration in clinical practice, especially when unexpected outcomes arise. For example, intermediate and poor metabolizers are at increased risk for toxicity and adverse effects due to drug accumulation. These patients demonstrate hypersensitivity or low tolerance to particular drugs and subsequently may require reduced doses or avoidance of the drug altogether. Conversely, prodrugs, (inactive parent drugs that require enzymatic conversion to the active metabolite) may exhibit low drug efficacy in poor metabolizers. These patients may need higher doses of drugs to produce the same response as extensive metabolizers. Ultra-rapid metabolizers represent the opposite end of the spectrum but may also be disposed to drug toxicity when the metabolite is more active than the parent drug. Thus, in several embodiments, the pharmacogenomic analysis identifies, based on a profile of a patient's gene expression, the metabolic characteristics of a patient, with respect to how quickly (or extensively) they will metabolize a drug. See FIGS. 10A-10L for a non-limiting example.

Drug metabolism is a complex and important component of developing an effective therapy. There are, however, many potential drug-drug interactions resulting from the inhibition, induction, and/or competition for common enzymatic pathways by different drugs. Genetic variability (e.g., patient to patient) of CYP is also a significant source of unpredictable drug effects. Awareness and understanding of drugs involved in common CYP pathways, as is achieved by the methods disclosed herein, adds to a practitioner's knowledge base to foresee and limit and/or prevent potential drug interactions and improve therapeutic outcomes.

Drug metabolism occurs in multiple organ systems, including the liver, intestinal wall, lungs, kidneys, and plasma. The liver, a primary site of drug metabolism, acts to detoxify and facilitate excretion of xenobiotics (foreign drugs or chemicals) by enzymatically converting compounds. Drug metabolism is achieved through phase I reactions, phase II reactions, or both. The most common phase I reaction is oxidation which is catalyzed by the CYP system.

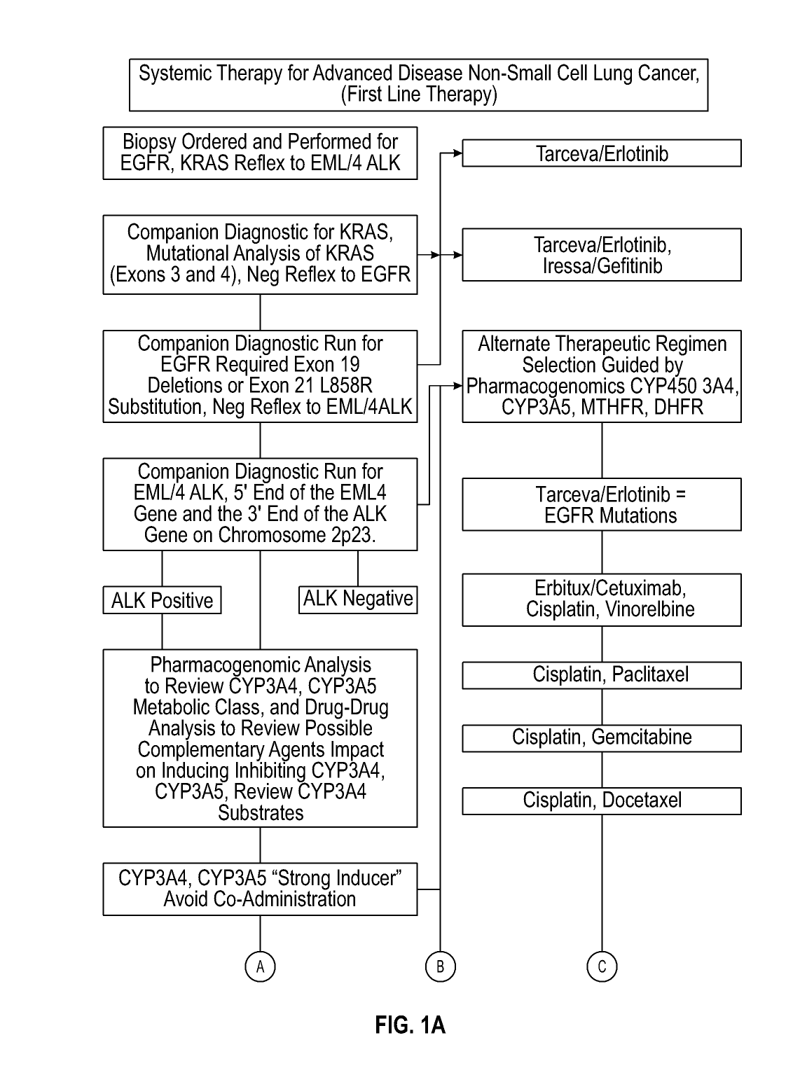

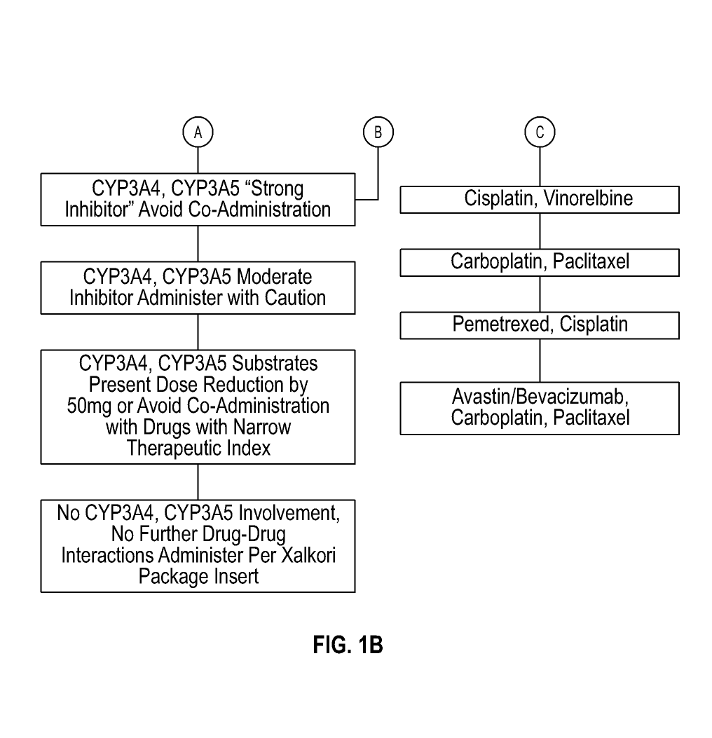

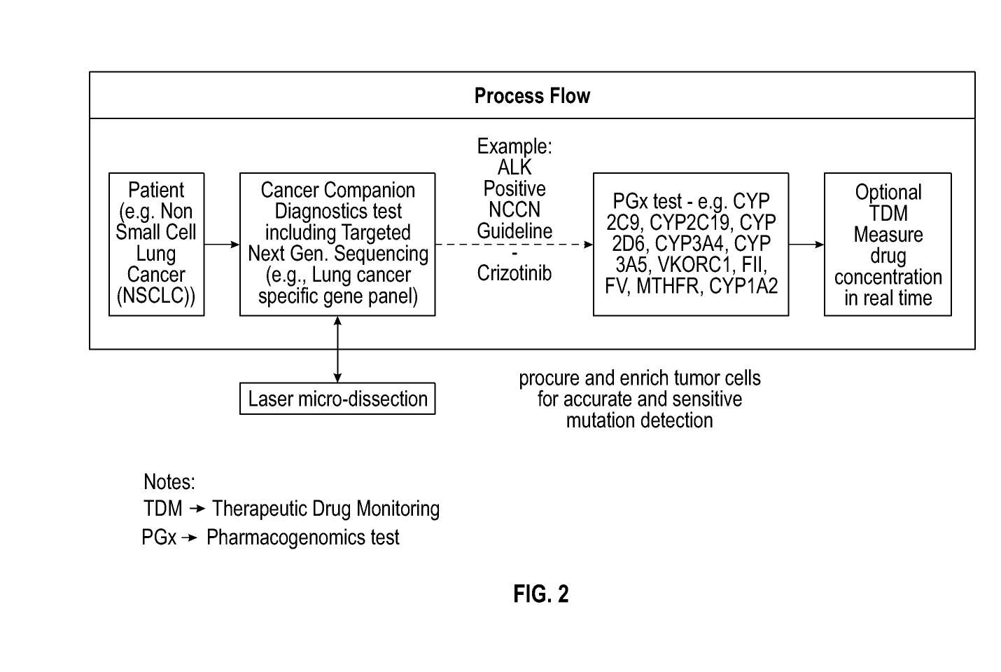

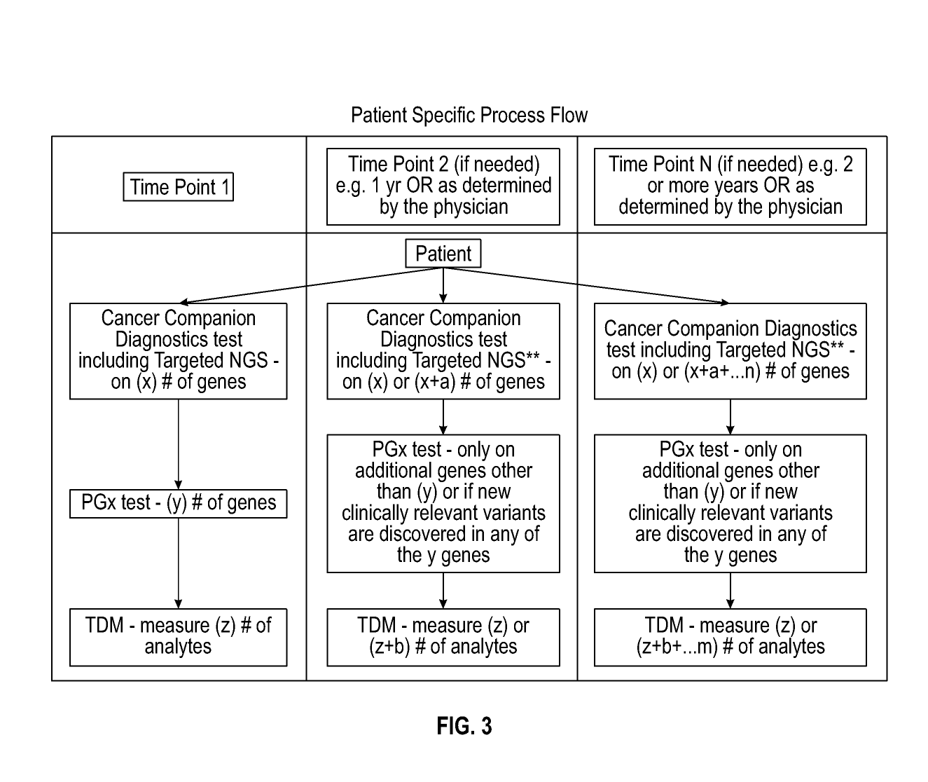

Drugs that share a common pathway (e.g., one or more drugs metabolized by the CYP system) have potential for drug-drug interactions. Classification of CYP proteins is an early indication to a practitioner of the potential for drug-drug interactions. Not all drugs have CYP activity (e.g., those drugs metabolized by the CYP system have CYP activity). However, any drugs with CYP activity may also be inhibitors, inducers or substrates for one or more specific secondary CYP enzymatic pathways, which has the potential to alter the metabolism of concurrently administered agents that may be metabolized through the secondary pathway(s). Drugs that inhibit an enzymatic pathway of CYP may cause increased concentrations of other drugs metabolized by the same pathway, resulting in drug toxicity. Likewise drugs that induce an enzymatic pathway of CYP may reduce concentrations of drugs metabolized by the same pathway, leading to subtherapeutic drug levels or treatment failure. The pharmacogenomic reports produced in several embodiments of the present invention identify these issues and a comprehensive report is provided to a medical practitioner that identifies these occurrences and recommended dosing and alternative agents are recommended to control these issues before they become a barrier to therapy giving the physician and patient better outcomes. See FIGS. 1A-1B for one non-limiting embodiment of an analysis flowchart. FIGS. 2 and 3 represent, respectively, examples of a general process flow for analysis of a subject and a patient-specific process flow. Note that in FIG. 3 the variables a, x, y, n refer to the number of genes, the variables b, m, and z are number of analytes, the variable x may refer to specific cancer panel genes (e.g. lung, colon, brain etc.). The “**” indicates that if additional clinically relevant genes are or have been discovered or if the cancer has metastasized to other parts of the body thus a modified different panel may be employed. FIGS. 10A-10L shows a non-limiting, illustrative example of a final form of report in which the pharmacogenomics analysis results as well as the resulting recommendation for the drug treatment protocols are provided. In several embodiments, if a patient's drug regimen is changed by the physician, then the re-evaluation pharmacogenomics analysis report can be provided without the need to run the test again.

One consequence (of many possible consequences) of drug-drug interactions may include the augmentation of potential side effects. For example, imatinib (Gleevec, Novartis) is an oral tyrosine kinase inhibitor that is approved by the US FDA for the treatment of Philadelphia chromosome-positive acute lymphoblastic leukemia and chronic myelogenous leukemia. Because Gleevec is both a CYP3A4 substrate and inhibitor, caution should be taken when CYP3A4 inhibitors and CYP3A4 inducers are concurrently prescribed (for example, CYP3A4 inhibitors such as azole antifungals). These additional agents can increase imatinib concentrations; CYP3A4 inducers, such as rifampin, can decrease imatinib levels, leading to either supra- or subtherapeutic levels of imatinib, respectively. Several embodiments of the invention assess the genetic profile of a patient, their potential for metabolizing an agent, and the possible drug-drug interactions that may result, thus arming a treating physician with the knowledge of potential adverse consequences and recommendations for alternative therapeutic approaches that will provide the most efficacious treatment regime for a specific patient.

As another example, certain drugs have a narrow therapeutic window, such as temsirolimus (Torisel; approved in the treatment of advanced renal cell carcinoma), which is metabolized by the CYP3A4 pathway. The manufacturer (Pfizer) recommends doubling the dose of temsirolimus when used concurrently with strong CYP3A4 inducers such as phenytoin or fosphenytoin.

While current methodologies often have extensive drug interaction studies being performed before drugs reach the market, not all drugs have been tested in combination. Sometimes drug interactions are hypothesized based on known metabolic pathways. For example tamoxifen is an estrogen receptor antagonist approved for use in patients with breast cancer. Its metabolism is complex and involves a number of CYP pathways, starting with activation through metabolism. However, CYP2D6 appears to be the most significant in the production of the active metabolite endoxifen. It follows that CYP2D6 inhibitors may cause decreased production of endoxifen, resulting in treatment failures. Thus, other drugs with potent CYP2D6 inhibitory activity may lead to decreased tamoxifen activity in patients with breast cancer. Again, several embodiments of the invention assess the genetic profile of a patient, assess the genetic make-up of their diseased tissues, their potential for metabolizing an agent, and the possible drug-drug interactions that may result, thus arming a treating physician with the knowledge of potential adverse consequences and recommendations for alternative therapeutic approaches that will provide the most efficacious treatment regime for a specific patient.

In certain embodiments, the pharmacogenomics analysis is configured to access or evaluate the patient's capability to process and metabolize a drug that is administered to the patient. Such capability may play an important role in determining the patient's response to the drug, which includes expected efficacy as well as adverse effect(s) of the drug. The capability of processing and metabolizing a drug may be influenced by at least one or more of the following biological processes: Absorption of a drug, Distribution of a drug, Metabolism of a drug and Excretion of drug in the patient (“ADME” processes hereinafter). In many cases, the patient's capability to respond to a certain drug would be determined by a combinatorial action of the foregoing ADME processes. To accurately evaluate the patient's capability and therefore predict the patient's response to a target drug (and eventually to the designed drug treatment regimen according to the methods disclosed herein), in certain embodiments, the activity of one or more genes that are known to involve in at least one of the ADME processes is measured. In this regard, in some embodiments, a genetic structure (e.g., genotype) of such genes associated with the ADME processes may be determined.

After detecting genotype(s) of the gene(s) associated with the ADME processes, the obtained genotype(s) can be converted into a phenotype (e.g. ultra slow-, slow-, normal-, fast-, and ultra-fast-metabolizer) indicating the level of the patient's capability in processing and metabolizing a drug. The genotype of an individual gene can be determined by identifying one or more genetic variations or alterations including polymorphism, mutation, deletion and duplication that are present in the gene. Each gene can have more than one genetic variation or alternation and often multiple genetic variations or alterations from a single gene are identified and considered together to determine a corresponding phenotype. In some embodiments, the genetic variations or alternations of more than one gene can be identified and considered together to determine a corresponding phenotype.

In some embodiments, one or more of the following example genes and/or the variants thereof in Table 1 that are known to be associated with the MADE processes can be evaluated in the pharmacogenomics analysis of the methods disclosed herein.

TABLE 1
Genes and alleles thereof designating different genetic variations or alternations

| Genes | Alleles |
|---|---|
| Factor II (Prothrombin) | 20210G > A |
| FactorV (Lei den) | 1691G > A |
| Methylenetetrahydrofolate | MTHFR 677C > T, MTHFR 1298A > C |
| reductase (MTHFR) | |
| VKORC1 | -1639G > A |
| Cytochrome P4502C9 | *1, *2, *3 |
| Cytochrome P4502C19 | *1, *2, *3, *4, *5, *6, *7, *8, *9, *10, *13 and *17 |
| Cytochrome P4502D6 | Rearrangement, Duplication, Deletion (*5), -1584C > G |
| | (*2Apromo), 100C > T, (*4/*10), 124G > A, (*12), 138insT |
| | (*15), 883G > C (*11), |
| | 1023C > T (*17), 1661 G > C (*2), 1707T > del (*6), 1758G > T/A |
| | (*8/*14), 1846G > A (*4), 2549A > del (*3), 2613delAGA (*9), |
| | 2850C > T (*2/*17), 2935A > C (*7), 2988G > A (*41) and |
| | 4180G > C(*2) |
| Cytochrome P4503A4 | *1B, *2, *3, *12 and *17 |
| Cytochrome P4503A5 | *1D, *2, *3A, *3B, *3, *6, *7, *8 and *9 |

Alleles shown in the above Table 1 represent genetic variations or alternations of their corresponding genes. Therefore, for example, allele 20210G>A is a variant of the gene encoding Factor II (Prothrombin) that is located at position 20210 of the 3′ untranslated region of the prothrombin gene on chromosome 11 and leads to substitution of an adenine for a guanine. As shown above, in certain genes, there is more than one allele available for the test in the pharmacogenomics analysis. Often testing two or more alleles of the same gene can lead to more accurate and fine evaluation of the patient's capability of drug process and metabolism. Testing all the alleles listed above for an individual gene may not be necessary. Further, testing all the genes from Table 1 may not be necessary. Any combination of genes among those listed above and any combinations of alleles for one or more those genes are possible in the methods disclosed herein. One or more additional alleles such as CYP1A2, DPYD, and TPMT can also be tested alone or in combination with one or more alleles listed in Table 1. Therefore, the combinations of alleles that are subjected to the pharmacogenomics analysis can vary greatly depending the alleles selected and tested.

Once genotypes of one or more genes associated with the ADME processes, e.g. those listed in Table 1, are determined, the results can be converted into their corresponding phenotypes and interpretations. The resulting phenotype can be ultra-poor (or ultra-slow), poor (or slow), intermediate, normal, fast, and ultra-fast metabolizer. As an exemplary illustration showing this genotype-phenotype conversion, the following Table 2 is provided.

TABLE 2
Various genotypes of CYP2C9 gene and
their corresponding phenotypes

| Genotype | Phenotype |
|---|---|
| *1/*1 | Normal metabolizer |
| *1/*2 | Intermediate metabolizer |
| *1/*3, *2/*2, *2/*3, *3/*3 | Intermediate or poor metabolizer |

Patients having different genotypes of the genes related to the ADME processes, thereby having different phenotypes, can show different abilities to process and/or metabolize a drug. Some patients may absorb, distribute, metabolize and/or excrete a drug notably better or worse than some other patients do. In other words, the overall drug process and metabolism may not be identical in individual patients. Rather, based on the patient's genotypes and phenotypes, the individual patient's capability of processing and metabolizing a drug can be significantly different. Further, some drugs may not be recommended or are typically be avoided in some specific patient(s). For example, if a patient is identified as a poor metabolizer of CYP2C9 gene, drugs that are known to reduce or inhibit the activity of CYP2C9 gene or the process involving CYP2C9 enzyme could raise the possibility of side effects. Therefore, the pharmacogenomics analysis results can also provide important guidance in selecting certain types of drugs. In addition, the drug application manner such as dose, frequency, and period of application may also need to be adjusted depending on the individual patient's capability of processing and metabolizing the drug. As further illustrated in the examples in this application, the pharmacogenomics analysis can provide such a fine tuning of drug regimen plan based on the patient's genotypes and/or phenotypes.

In some embodiments, there is provided a computerized system that is configured to receive and process the genotyping data (e.g., sequencing target alleles and identifying the genetic variations/alterations thereof) and converts the resulting genotypes to the corresponding phenotypes. The computerized system may comprise multiple elements such as a data receiver, a data processor, a data analyzer, and a data output device.

In addition to the foregoing interpretation based on drug-gene interaction, the pharmacogenomics analysis can also provide further guidance after accessing potential drug-drug interactions. In some embodiments, a first set of candidate drugs that were selected from the genetic profiling analysis may be considered in the pharmacogenomics analysis. Also, in certain embodiments, the patient may have been taking one or more drugs already. It is possible that co-administration of two or more drugs selected from those proposed from the genetic profiling analysis and/or those being already taken by the patient could lead to adverse effects due to drug-drug interactions. The pharmacogenomics analysis can also evaluate any potential dangerous interactions between drugs that are under consideration and/or being taken and provide information thereon. Accordingly, any harmful side effects can be avoided by way of the pharmacogenomics analysis.

In some embodiments, the genetic profiling provides a first group of candidate drugs that may be associated with the subject's genetic variations. In some of such embodiments, a pharmacogenomics analysis can be used to assess the impact of the subject's genetics on the response to medication in the subject, and/or the possible drug-gene and drug-drug interactions, especially for the first group of candidate drugs. If the patient has already been taking certain drugs, such drugs can also be considered and evaluated with the first group of candidate drugs in the pharmacogenomics analysis. Based on the data from the pharmacogenomics analysis, only certain drugs among the first group of candidate drugs and those that are already taken by the patient that may have relatively a higher efficacy and a lower risk in treating the subject are further selected. This second group of candidate drugs is selected upon comprehensive consideration of the subject's disease/abnormal condition, the subject's unique genetics as well as the subject's specific capability of processing and metabolizing drugs. Consequently, the selected second group of candidate drugs can provide a subject-specific (or customized) drug treatment protocol that is directly applicable to the subject, or can provide excellent guidance to a medical practitioner in tuning the therapy for the subject.

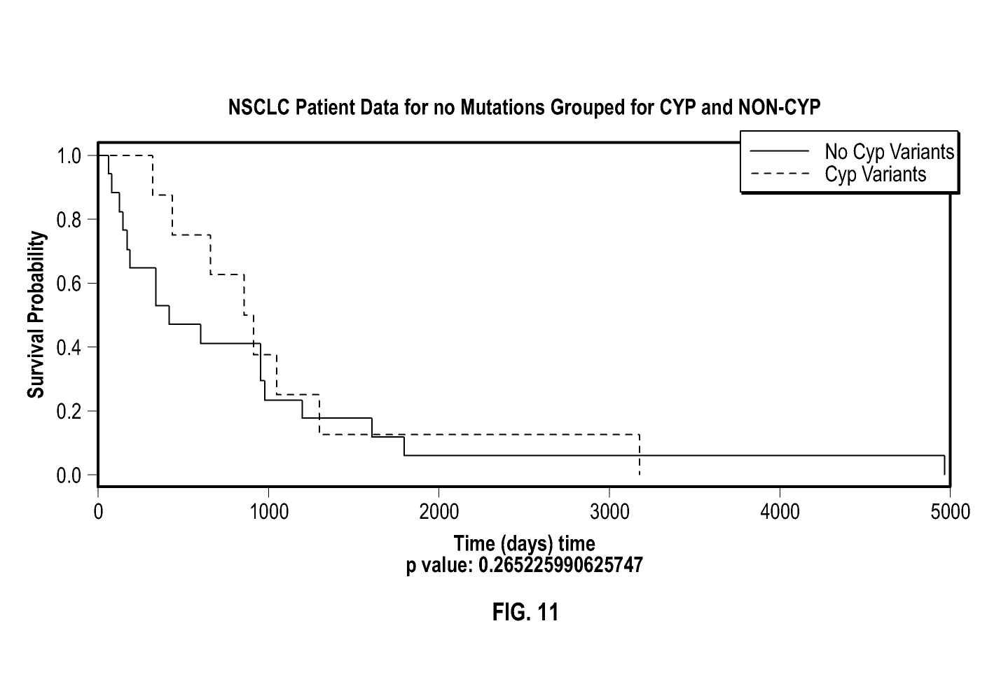

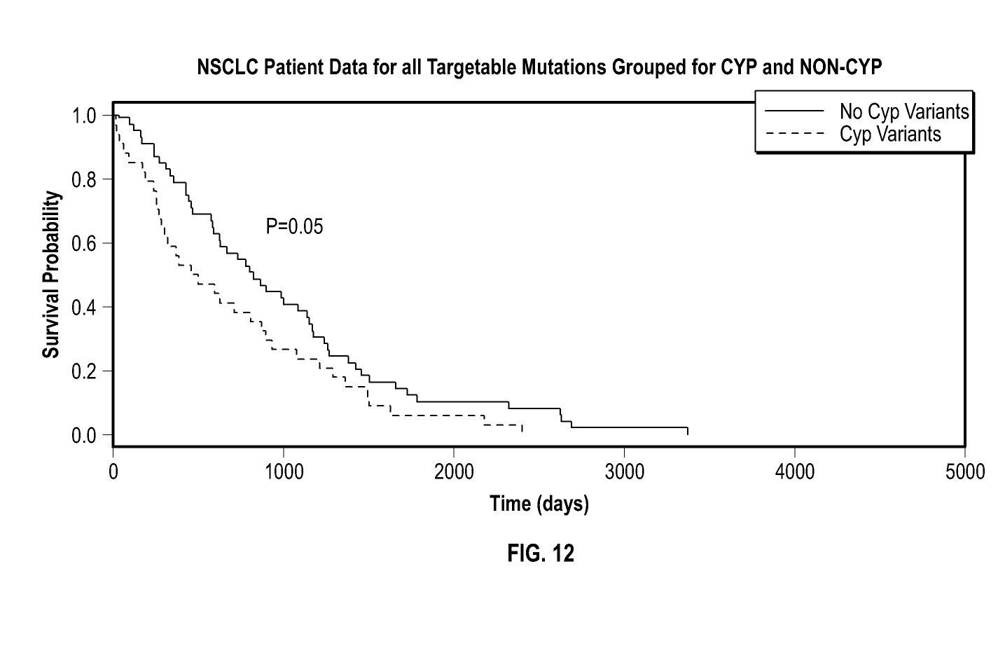

FIGS. 11 and 12 provide statistical data showing the unexpectedly efficacious results achieved when the methods/systems disclosed herein are used to assess the patient's genetic profiling analysis and the patient's pharmacogenomics. The patients tested in the experimentations of FIGS. 11 and 12 are all NSCLC patients and they were first divided into two groups depending on their genetic profiles. One group (FIG. 12) was of the patients having any targetable mutations (i.e. EGFR, KRAS, ROS, and more) in NSCLC whereas the other group (FIG. 11) was of the patients having no such mutations. In each group, the patients were further grouped based on the presence and absence of CYP variants, which were determined from the pharmacogenomics analysis.

FIG. 11 shows the data of survival probability of the NSCLC patients with no targetable mutations. The patients were under conventional drug treatments which may have contained one or more drugs targeting one or more genetic mutations associated (or linked) with NSCLC (e.g. targetable mutations on genes such as EGFR, KRAS, ROS, and more). Given that the patients did not have any mutations targetable by the treated drugs, the efficacy of the drug treatments did not show any notable difference. There is no further difference in the penitents' survival trends depending on their CYP mutations.

FIG. 12, on the other hand, provides a very different pattern. FIG. 12 shows the data of survival probability of the NSCLC patients who were determined to have any targetable mutations. The survival probability significantly differed over time depending on the presence of CYP variants in this group of patients.

These data from FIGS. 11 and 12 indicate several important aspects to consider when developing an optimized drug treatment regimen: (1) identification of the genetic profile of the subject, and (2) determination of the patient's pharmacokinetic profile, which allows clear identification of an efficacious drug treatment regimen. Given that the frequently used candidate drugs in NSCLC are known to target one or more genetic mutations that are associated with NSCLC, the patients having such targetable mutations are believed to respond more sensitively to such drug treatment regimens. Within such a group of patients having one or more specific mutations associated with NSCLC, their pharmacokinetic capability clearly further impacts the efficacy of the drug treatment. As seen from FIG. 12, the patients having any targetable mutations of NSCLC and no CYP mutations show clearly different behaviors (e.g., longer life expectancy) as compared to those having targetable mutations of NSCLC and CYP mutations simultaneously. The data from FIGS. 11 and 12 clearly prove that individual NSCLC patients can respond differently (e.g. respond to drug treatment regimens differently) depending on their genetic mutations in NSCLC-targetable genes as well as CYP genotypes. Therefore, it may be less preferred to apply the same or similar drug regimen plan to any NSCLC patients without considering the patient's genetic and pharmacogenomics profiles. Rather, knowing the patient's genetic profile as well as the pharmacokinetic capability is critical to design an optimized, patient-specific drug treatment regimen. Based on the knowledge of the genetic profile, the personalized drug treatment regimen may comprise only necessary (and a minimal number of) drugs that specifically target (act on) the mutations present in the patient and the application doses can be optimized based on the patient's pharmacokinetic capability, which will result in maximizing the drug treatment efficacy and minimizing any undesired side-effects.

Drug regimen plans that are currently applied to patients generally comprise more than one drug and each drug may be metabolized by the same or different metabolic pathways. The genes involved in an individual drug metabolism may also differ. Certain drugs administered to a patient can affect the activity of one or more genes that involve in drug metabolic pathways. Further, individual drugs can interact and affect the activity of one or each other. Therefore, when one or more drugs are administered to a patient, there can be complicated drug-drug interactions as well as drug-gene interactions, which can ultimately alter the efficacy of drug treatment.

Without considering such interactions between the drugs and between the drugs and genes, the drug regimen protocol may not be as effective as desired or even further, may lead to adverse consequences.

Taking the treatment of non-small cell lung cancer (NSCLC) as a non-limiting example, gefitinib is one of frequently used candidate drugs, especially to NSCLC patients who have a mutation(s) in EGFR gene. CYP3A4 is known to be involved in the metabolism of gefitinib. Gefitinib itself is a weak inhibitor of CYP2D6 activity. Gefitinib is known to have an interaction with rifampin, which is a strong CYP450 enzyme inducer. Studies showed that co-mediation with a CYP3A4 inducer (rifampin) reduces exposure to gefitinib and area under the curve was reduced by 83% (Swaisland et al., “Pharmacokinetic drug interactions of gefitinib with rifampicin, itraconazole and metoprolol”, Clin. Pharamacokinet. 2005, 44(10): 1067-81, which is incorporated by reference herein). Co-medication with a CYP3A4 inhibitor (intraconazole) increases exposure to gefitinib in health men (Swaisland, supra.). Therefore, one of the commonly used drug in NSCLC treatment, gefitinib may have multiple drug-gene interactions as well as drug-drug interactions with some other drugs.

There are several drugs known to be applicable to NSCLC patients and some of such drugs can be classified into different CYP450 enzyme regulators. According to the study by Song et al. (“Treatment of lung cancer patients and concomitant use of drugs interacting with cytochrome P450 isoenzymes”, 2011, Lung Cancer, 74(1): 103-11), strong CYP450 enzyme inhibitors, strong CYP450 enzyme inducers as well as CYP450 substrates are often prescribed to NSCLC patients. Treatment of strong CYP450 enzyme inhibitors to NSCLC patients is reported to result in 65.5 additional days of life span of a patient on average, which corresponds to 42% of the episode length. It was also reported that 28% of episodes of the NSCLC cancer patients in a study had prescription of 2 or more of strong CYP450 enzyme inhibitors. As in treatment of strong CYP450 enzyme inducers, it was reported to expand the patient's life span by an average 34.5 days and at least 2 different strong CYP enzyme inducers were prescribed in 4% of studied episodes. CYP450 enzyme substrate was reported to allow 96.1 days of life span extension and at least 2 different CYP450 enzyme substrates were prescribed during 96% of the studied episodes.

The following Table 3 provides further lists of drugs that are often used in NSCLC treatment (or may be used in treatment of other diseases). The drugs are divided into two groups depending on their activity as a CYP3A4 inducer or inhibitor.

TABLE 3
List of major CYP3A4 inducers and
inhibitors used in NSCLC treatment.

| Inhibitor | Inducer |
|---|---|
| Omeprazole | Aprepitant |
| Ciprofloxacin | Phenytoin |
| Bupropion | Carbamazepin |
| Clarithromycin | Phenobarbital |
| Fluconazole | Modafinil |
| Paroxetine | Rifampin |
| Metronidazole | Oxcarbazepine |
| Fluoxetine | Rifabutin |
| Quinine | Ritonavir |
| Telithromycin | |

More than two drugs (inhibitor or inducer) are prescribed in 98% of the treatment period according to the study by Song et al. (supra.). Given that drugs may have different activities (or interactions) with the genes involved in CYP metabolic pathway as well as with each other, the way to combine which drugs together in treatment can change the ultimate efficacy of the treatment as well as the amount of adverse effects. Depending on the combination of drugs, the planned drug treatment regimen can ultimately inhibit or induce the activity of, e.g. CYP3A4 gene. Alternatively, when the inducer and inhibitor are co-administered, the effect of modulating CYP3A4 may be cancelled out by each other and thus the CYP3A4 gene activity may largely be unaffected. Modulation of one or more CYP genes may also affect metabolism of other drugs that are metabolized by the affected CYP genes.

Also, as discussed herein, individual patients may have different inherent activities of CYP genes (by having different CYP gene alleles) and thus the impact of the drugs to individual patients may also vary according to the patient's specific pharmacokinetic profile and capability. The following Table 4 shows CYP alleles co-occurrence in a group of NSCLC patients.

TABLE 4
CYP co-occurrence in NSCLC patients from TCGA data set

| | CYP1A2 | CYP2C19 | CYP2C9 | CYP2D6 | CYP3A4 | CYP3A5 | MTHFR |
|---|---|---|---|---|---|---|---|
| CYP1A2 | — | 3 | 2 | 5 | 0 | 0 | 6 |
| CYP2C19 | 3 | — | 75 | 14 | 4 | 8 | 103 |
| CYP2C9 | 2 | 75 | — | 12 | 4 | 11 | 143 |
| CYP2D6 | 5 | 14 | 12 | — | 3 | 4 | 37 |
| CYP3A4 | 0 | 4 | 4 | 3 | — | 1 | 11 |
| CYP3A5 | 0 | 8 | 11 | 4 | 1 | — | 29 |
| MTHFR | 6 | 103 | 143 | 37 | 11 | 29 | — |

As seen above, it is not rare but, in fact it is rather common, that individual NSCLC patients have one or more CYP and/or MTHFR alleles, each of which is designated to different genetic variations or alternations. This clearly indicates that a patient diagnosed with NSCLC may have a different pharmacokinetic profile and therefore their drug metabolic capability may also be different. Accordingly, in order to design a drug treatment regimen that is specific and optimized to an individual patient, understanding of the patient's pharmacokinetic profile is important.

As discussed herein, complex interactions between drugs and between administered drugs and genes involved in drug metabolism can influence the ultimate efficacy of the drugs, and therefore it is critical to understand the patient's pharmacokinetic profile and capability as well as the potential drug-gene interactions and the drug-drug interactions.

In some embodiments of the invention, a report is generated upon completion of the pharmacogenomics analysis. Therefore, the analysis of the data obtained from the genetic profiling and/or pharmacogenomics analysis can produce a report that lists recommended on-label and off-label therapies associated with efficacy for patients having that disease and/or a specific identified mutation. See 10A-10L for a non-limiting example of this report. 10A-10L shows a report that contains the pharmacogenomics analysis results obtained from a subject. Further the report comprises the general information on medicine including potential risks, cautions, and warnings in application. Further, the report provides one or more candidate drugs that are recommended for treating the subject and the application protocol thereof (e.g. dosing and application period). In certain embodiments, the report contains information on one or more of, e.g. the subject's condition, the subject's genetic variations, the candidate drugs for therapy, the candidate drugs' pharmacological and pharmacokinetic data, and the like. The report can be forwarded to a medical practitioner including a medical doctor such that it can provide guidance on, and/or implementation of, the subject's specific therapy.

In some embodiments of the invention, the method may comprise a step (or steps) of monitoring the level of one or more drugs in a target patient(s) after administration of the drug(s). In certain embodiments where one or more candidate drugs are identified from the genetic profiling analysis and/or the pharmacogenomics analysis, and administered to the subject, a drug monitoring analysis of the subject can be conducted to monitor/measure the actual metabolism of the administered drug(s). While the genetic profiling and/or the pharmacogenomics analysis can identify drugs that may be more likely to be effective for a given condition (such as specific cancer including pediatric cancers, condition such as diabetes or mental health condition such as depression), the follow-up drug monitoring analysis of the subject may be used to determine if the selected drug(s) and/or dosage are actually present in the subject at the desired level.

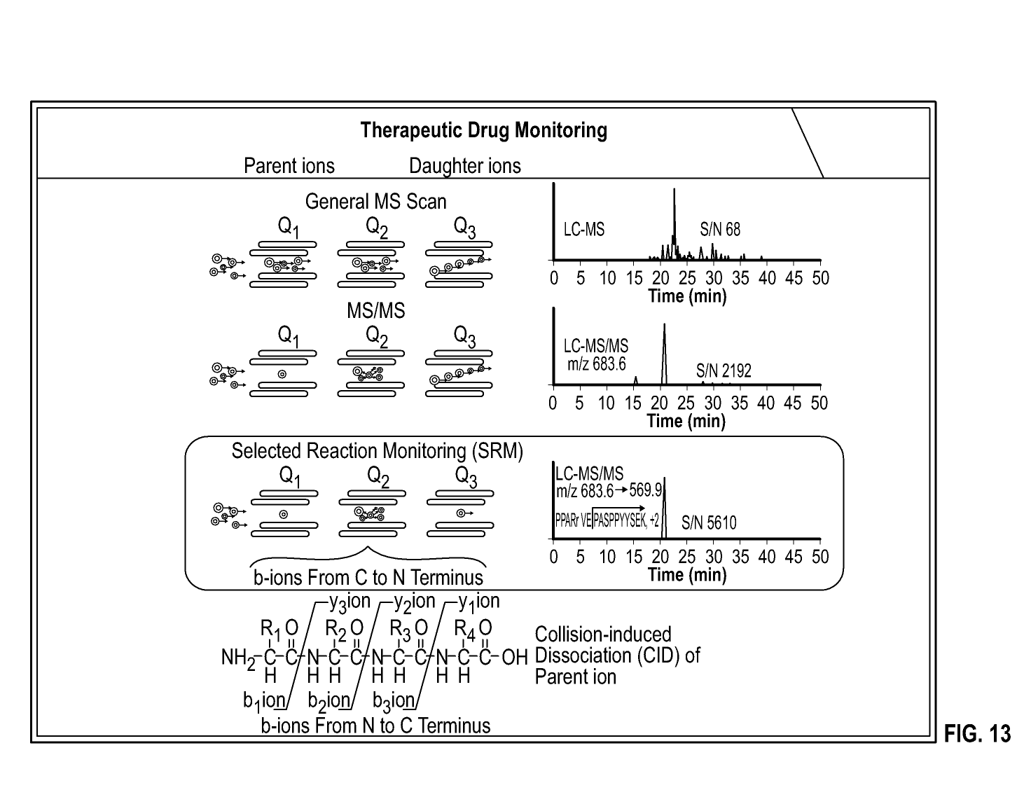

FIG. 13 shows testing of drug levels using various types of mass spectrometry. For example, some embodiments employ a general mass spectrometry scan of drug candidates. Other embodiments employ MS/MS, in which a particular characteristic peak of a mass spec profile is further analyzed (e.g., sequenced). This is also known as Triple Quadruple Mass Spectrometry. Selected Reaction Monitoring (SRM) is also another of non-limiting and illustrative type of mass spec that is used in some embodiments of the invention. However, any method of measuring drug levels may be employed including, e.g. Enzyme-Linked ImmunoSorbant Assay (ELISA). In FIG. 13, Q1, Q2, and Q3 represent each of the three quadruples of the mass spec system, with Q1 and Q3 being responsible for filtering sample ions according to their mass to charge (m/z) ratio and Q2 which serves as a non-linear collision cell. The ions are selected or scanned in Q1 and Q3 based on the stability of their paths in the electric field. Once they reach Q2, they are accelerated by the electric field and are collided with a neutral gas (e.g. nitrogen or argon) to produce small fragments. In several embodiments, there is no need to sequence the fragments that are generated by the collision in Q2, the characteristic peaks and profiles in Q3 allow rapid and accurate identification of a drug. In certain embodiments, an immunoassay that may be coupled with quantitation means would be sufficient to instantly measure the metabolic profile of a drug(s) that has been administered to the subject. Therefore, in certain embodiments, the metabolic profile of the drug(s) can be measured and determined in real-time and processed to provide further guidance in adjusting the drug therapy regimen.

In some embodiments, the measurement of the drug level (or the levels of multiple drugs) in the subject (e.g. the patient) and the following determination on the adjustment of the drug's treatment protocol can be done in real-time and thus can be used to alter the drug application protocol essentially in real time. In certain examples of such embodiments, the drug level in the patient, e.g., measured from a sample obtained from blood or urine can be measured by, e.g., a portable and sensitive finger stick device that may be operably linked to a quantitative analyzer. The level of the drug that is measured and processed with this device can be further processed substantially simultaneously to determine if the measured level of the drug is relatively consistent with the prediction. If any adjustment of the application protocol of the drug is determined to be necessary or recommended, the information on the protocol adjustment can be delivered to the patient and/or the medical practitioner of the subject substantially immediately. Therefore, the drug application protocol can be adjusted in real-time, e.g. within few minutes to few hours.

In some embodiments, the levels of a plurality of drugs can be measured and monitored relatively simultaneously so that a multiplex profiling can be possible. Alternatively, the levels of a plurality of drugs can be measured relatively separately.

Once the level(s) of one or more of the candidate drugs in the patient are measured, the resultant data can be processed to determine if the level of each of the tested drugs is within the expected or desired level. If the level of a certain drug in the patient is determined to be higher than expected, this may lead to a consideration of reducing a dose, application amount or frequency of the drug so as to maximize the desired efficacy and minimize any side effects. If the level of a certain drug is determined to be lower than expected, this may lead to a consideration of increasing a dose, application amount or frequency of the drug so as to reach the desired efficacy. Alternatively, if the level of a certain drug is substantially out of the expected range, thereby possibly risking the efficacy of the therapy, this may lead to a consideration of removal of the drug and/or substitution for a new candidate drug.

Accordingly, from this drug monitoring analysis in the subject, one can actually confirm whether the drug(s) administered in the subject behaves and becomes effective and functional as predicted/desired. In other words, the mode of action of each drug that is selected and predicted from the genetic profiling and/or pharmacogenomics analysis is actually monitored to confirm the accuracy of the prediction. If the actual behavior/level of a drug(s) is substantially inconsistent with the expected behavior/level of the drug(s), the application of the drug can be adjusted or modified so as to achieve the predicted and desired therapeutic effects.

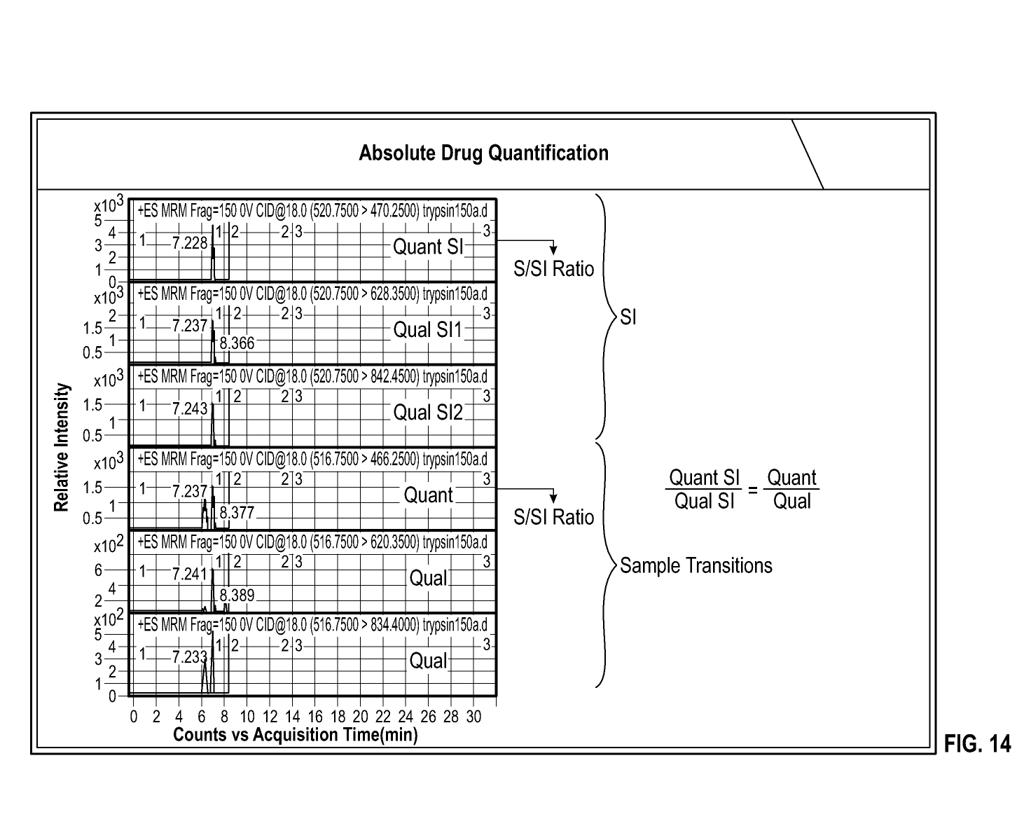

FIG. 14 shows certain embodiments of the metabolic profiling according to the invention. In these embodiments, a stable isotope (SI) can be used to provide an absolute base line for the measurement. For instance, a subject or patient may take a known amount of SI, e.g. orally. A biological sample such as the subject's blood or urine may be obtained and processed for the metabolic profiling assay. The level of SI as well as the target drugs that were previously administered to the subject may be measured. For this assay, an accurate ratio of the drug in the test sample (for example, a blood sample obtained by needle prick) is measured by spiking the sample with the drug containing the stable isotope (SI). Given that the initial application amount of SI is known, the measured amount of SI that is present in the subject can provide an absolute basis for the known amount. The spike of each drug that is measured from the sample obtained from the patient's blood or urine can then be compared to the spike level of the SI and its ratio can be obtained. This ratio can be used to calculate the level of the tested drug. For example, if the ratio between the relative intensity of the drug and the relative intensity of SI is 3 fold, it indicates that the tested drug would have three times of the known concentration of the SI. This quantitative method based on a simple ratio between the tested drug and the known standard molecule (e.g. SI) can provide a rapid, reliable and accurate way of measuring and determining the metabolic profile of each drug. By this method, an accurate determination of the amount of drug may be obtained.

As already discussed above, the measurement of the drug level in the subject can be done for a plurality of drugs relatively simultaneously. Furthermore, the measurement can be performed more than once. For instance, the drug monitoring analysis can be conducted after hours, days or weeks from the drug administration. During this time period, a plurality of drug monitoring analyses can be conducted, e.g. every 6 hours, every 12 hours, daily, weekly and more, such that the dynamic profiling of the drug level(s) can be determined. Alternatively, the drug level can be measured, e.g. a week after the drug administration and as a follow-up, e.g. a month after the drug administration. Accordingly, the administered drugs can be continuously monitored and as a consequence the application of the drug can be adjusted or modified accordingly. Also, in some embodiments, especially when the therapy reaches so-called a steady state so that the drug levels generally are stable based on their dosing, the drug monitoring analysis can be conducted in a longer interval, e.g. quarterly. The time and frequency of the drug monitoring analysis may therefore vary.

The therapeutically effective concentration of a drug can be varied in individual subjects depending on their genetic and/or non-genetic factors. The general reference values of the therapeutic concentration of drugs are available from, e.g. publically available databases such as “Therapeutic Drug Monitoring” database managed by UCSD lab medicine, which is incorporated by reference herein. Some values on the therapeutic rage of certain drugs that are available from the UCSD database are provided below for reference.

TABLE 5
Data for some therapeutic drugs (retrieved from “Therapeutic
Drug Monitoring” database managed by UCSD lab medicine)

| | | Dose Interval | Therapeutic | | | | See |
|---|---|---|---|---|---|---|---|
| Drug | t_{1/2}(hours) | (hours) | Range | | Critical | | notes |
| Acetaminophen | 1-3 | 4 | 10-25 | mg/L | >40 | mg/L | |
| Amikacin | 2.5 | 6-8 | peak 20-30 mg/L, | | >40 | mg/L | 1 |
| | | | trough 1-8 mg/L | | | | |
| Carbamazepine | 10-48 | 8 | 8-12 | mg/L | >15 | mg/L | |
| Digoxin | 33-51 | 24 | trough 0.8-2.0 ng/mL | | >2.5 | ng/mL | 2 |
| Gentamicin | 2 | 8 | peak 4-10 mg/L, | | >12 | mg/L | 1 |
| | | | trough 1-2 mg/L | | | | |
| Lidocaine | 1.8 | Infusion | 1.5-5 | mg/L | >8.0 | mg/L | |
| Lithium | 19 | 6-12 | 0.5-1.5 | mmol/L | >2.0 | mmol/L | |
| NAPA | 6-12 | N/A | 5-30 | mg/L | PA + | | 3 |
| | | | | | NAPA >35 | | |
| | | | | | mg/L | | |
| Phenobarbital | 72-100 | 12 | 10-40 | mg/L | >60 | mg/L | |
| Phenytoin | 6-24 | 8 | 10-20 | mg/L | >25 | mg/L | |
| Primidone | 6-12 | 6-8 | 5-12 | mg/L | >15 | mg/L | 4 |
| Procainamide | 3-5 | 4-6 | PA 4-10 mg/L, | | PA + | | 3 |
| (PA) | | | NAPA 5-30 mg/L, | | NAPA >35 | | |
| | | | PA + NAPA 5-30 mg/L | | mg/L | | |
| Quinidine | 4-7 | 6 | trough 2.3-5.0 mg/L | | >7 | mg/L | |
| Salicylate | 2-19 | 4 | 10-30 | mg/dL | >45 | mg/dL | |
| Theophylline | 3-9 | | 10-20 | ug/mL | >30 | ug/mL | |
| Tobramycin | 2 | 8 | peak 4-10 mg/L, | | >12 mg/L, | | 1 |
| | | | trough 0.5-1.5 mg/L | | >5 mg/L | | |
| Valproic acid | 8-15 | 8 | 50-100 | mg/L | >200 | mg/L | |

| | | | | | |
|---|---|---|---|---|---|
| Vancomycin | 5.0-6.5 | 6-12 | peak 30-40 mg/L, | >50 mg/L, | 1 |
| | | | trough 5-15 mg/L | >15 mg/L | |

NOTES:
1. Draw trough immediately prior to next dose
For intramuscular dose, draw peak 45-60 minutes post dose
For 30 minute intravenous infusion, draw peak 30 minutes post dose
For 60 minutes intravenous infusion, draw peak 15 minutes post dose
2. Draw specimen >8 hours after dosing
3. N-acetylprocainamide (NAPA) is the active metabolite of procainamide (PA); it has similar pharmacological effects as the parent compound; both should be monitored
4. Phenobarbital is the active metabolite of primidone and the dose is usually titrated to obtain therapeutic concentrations of phenobarbital

Once the reference value for the therapeutic range of a drug is determined, e.g. via a database, e.g. “Therapeutic Drug Monitoring” database managed by UCSD lab medicine and/or the guidelines published in Neels et al. (“Therapeutic drug monitoring of old and newer anti-epileptic drugs” 2004, Clin. Chem. Lab. Med., 42(11): 1228-1255, which is incorporated by reference herein), one can compare this reference value with the drug concentration calculated from the subject and determine if the drug concentration in the subject is within or substantially close to the therapeutic range. If the drug concentration measured from the subject is notably off of the desired therapeutic range, the drug regimen plan for the tested drug and/or one or more other drugs may need to be reconsidered for potential modification.

The therapeutically effective concentration of a drug can vary in individual subjects depending on their genetic and/or non-genetic factors. Therefore, when the methods disclosed herein are in practice, the individual patient's specific conditions that may affect the drug metabolism may need to be considered before determining the desired therapeutic range of the target drug. This drug monitoring analysis and continuous (or frequent) monitoring are particularly important in embodiments related to cancer treatments. In some examples, the actual metabolism of each of the drugs can vary depending on the toxicity of each drug as well as the toxicity of any chemotherapy that is accompanied with the drug treatment. The subject's health is often very weak during cancer treatment and therefore inappropriate drug treatment can lead to severe and irrecoverable damages. The drug monitoring analysis and timely adjustment of the drug therapy regimen can be critical to protect the subject's health and maximize the effect of the treatment.

Moreover, the timely and proper drug monitoring analysis can be very helpful when the subject is a young child or baby who may not be fully capable of conveying information related to their experiencing side effects from the drugs. In such a case, if the administered drugs cause any negative effects on the subject's health, such negative effects can quickly and explicitly monitored by the drug monitoring analysis.

In addition, when the administered drug has a narrow therapeutic window, i.e. the toxic dose and the efficient dose are relatively close, this drug monitoring analysis can also play an important role. In such a case even a small amount of overdose can be toxic and a marginally low dose will not be effective, and therefore the fine adjustment of the drug dose would be important. The drug monitoring analysis can be critical to timely and accurately monitor the level of the drug in the subject and provide further information that may lead to the adjustment of the drug application.

In certain embodiments, the drug monitoring analysis can be done prior to the genetic profiling and/or the pharmacogenomics analysis. Alternatively, the drug monitoring analysis can be operated at a relatively same time with the genetic profiling and/or the pharmacogenomics analysis. In one aspect, the drug monitoring analysis that is conducted prior to or relatively simultaneously with the genetic profiling and/or the pharmacogenomics analysis can be done to monitor the presence and/or level of any drugs that were administered to the subject before the specialized-drug treatment regimen. This drug monitoring analysis can be particularly helpful if any of the drugs that were previously administered to the subject can possibly interact with any of the candidate drugs that are selected from the genetic profiling and/or the pharmacogenomics analysis and will be administered to the subject.

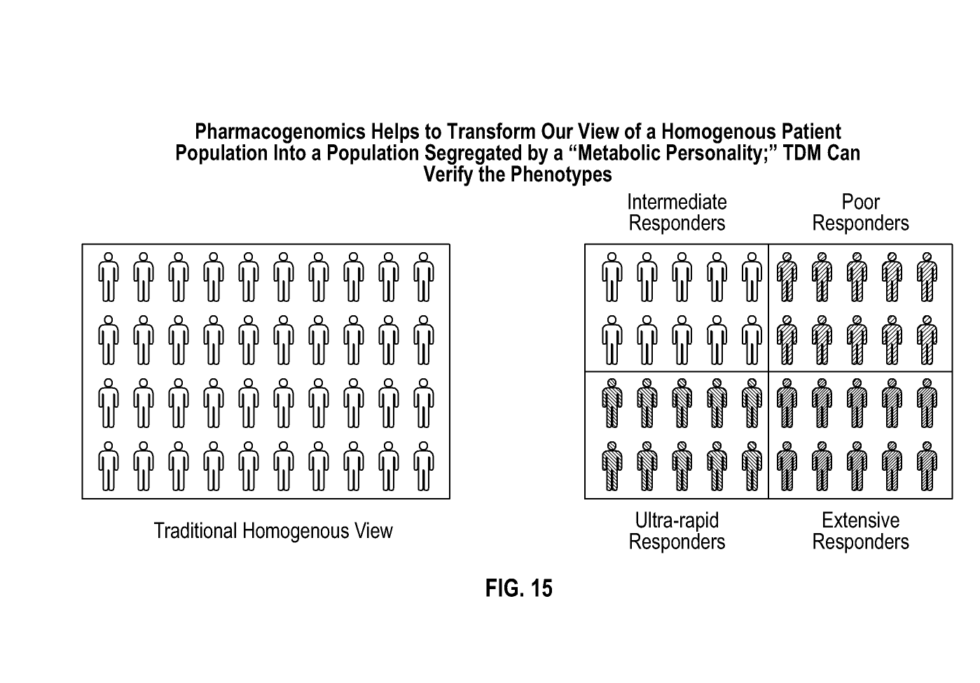

As shown diagrammatically in FIG. 15, although the type and dose of drug(s) as determined from the genetic profiling and the pharmacogenomics analysis are largely based upon the patient's certain genetic information (e.g. mutations on cancer genes and polymorphisms on genes related to the ADME processes), the actual phenotype of an individual may differ. The drug monitoring analysis is a useful check on actual and real time drug levels in the individual patient and depending on the results the drug regiment plan can be altered or updated. According to a traditional homogenous view of patients in clinical trials, each patient would receive a same average dose. Taking an antiplatelet drug, such as PLAVIX (Bristol-Myers Squibb) as an example, the average person would be prescribed to take about 75 mg/day to avoid clotting, strokes and heart attached. This is based on the result from a clinical trial. This is the dose of which 50% of people responded in the clinical trial; however, in reality individual patients have different sensitivities to this drug, e.g. from poor responders to ultra-responders. Such differences in response are in part based on the genetic difference between the subjects, including the genetic variations on the genes associated with the subject's condition and metabolic systems. Certain subjects may metabolize the drug faster or slower than other subjects. The individual subject's genetic background, i.e. a genotype and their response to the drug can be tested and predicted by way of the genetic profiling and/or the pharmacogenomics analysis. Further, the difference in actual response to a drug, i.e. a phenotype can be verified by a way of the drug monitoring analysis. From this series of analyses, the drug treatment regimen can be designed in a way to maximize the efficacy in each individual. Therefore, several embodiments of the invention disclosed herein help transform the traditional homogenous patient population into a population segregated by a genetic and metabolic personality. The metabolic profiling can verify the phenotype of individual personality. Therefore, applying some embodiments of the invention into a clinical trial, the recommended application mode can be adjusted to a group of subjects who shares certain genetic and/or non-genetic traits, instead of being universal to any subjects. For example, the recommended application dose can be determined depending on a certain age group, a certain racial group, a certain geological group, a family, and more.

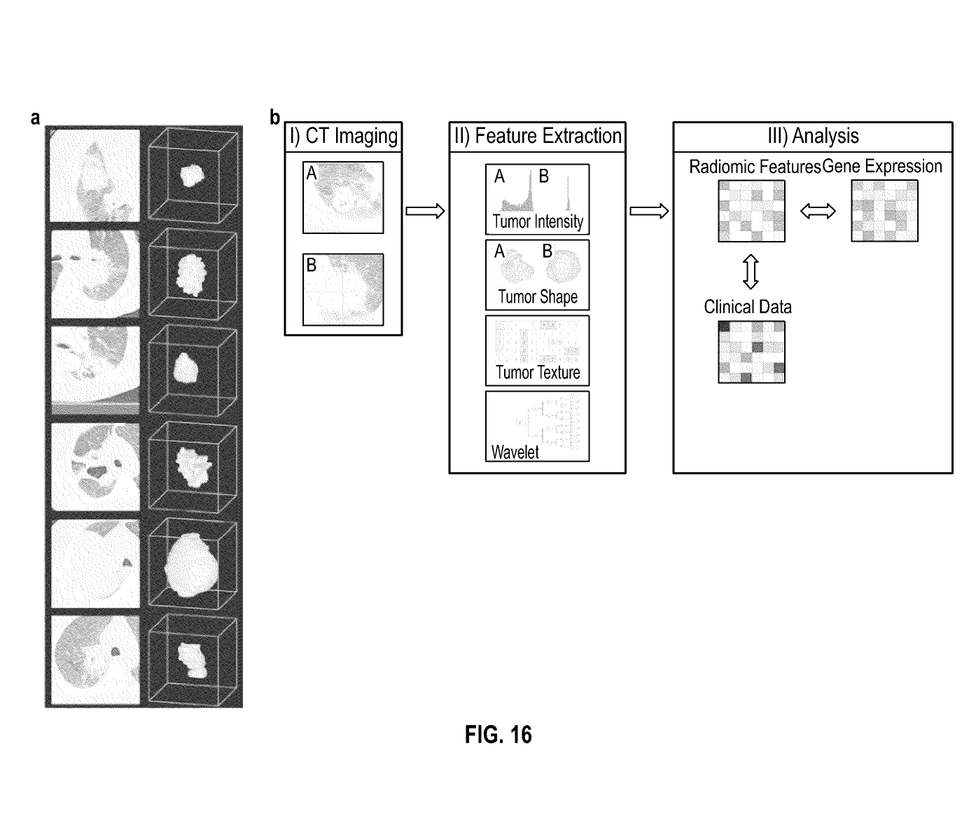

In some embodiments of the methods disclosed herein, an imaging technique or process can be used along with one or more protocols of the methods. FIG. 16 shows an example of imaging process that is applicable to evaluate tumor growth (retrieved from Aerts et al. “Decoding tumour phenotype by noninvasive imaging using a quantitative radiomics approach”, 2014, Nat. Commun. 5:4006, which is incorporated by reference herein). The figure shows different types of tumors monitored by Computed Tomography (CT) technique. Example CT images of lung cancer patients are presented in (A). CT images with tumor contours are left, three-dimensional visualizations are right. Notably there are strong phenotypic differences that can be captured with routine CT imaging, such as intratumor heterogeneity and tumor shape. (B) illustrates a strategy for extracting radiomics data from images. In (I), experienced physicians contoured the tumor areas on all CT slices. In (II), features were extracted from within the defined tumor contours on the CT images, quantifying tumor intensity, shape, texture and wavelet texture. In (III), for the analysis the radiomics features were compared with clinical data and gene-expression data. A variety of techniques of imaging the disease status and/or the condition of concerned tissues/organs in the subject can be applied to various embodiments of the methods disclosed herein.

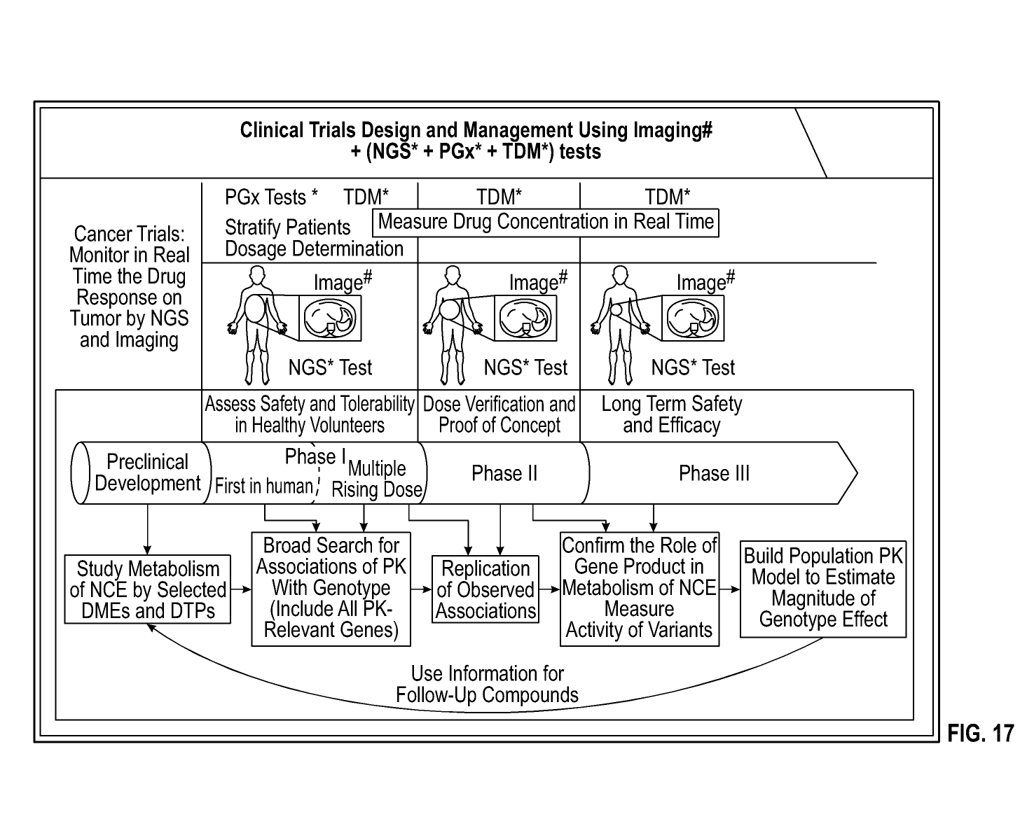

FIG. 17 shows one of such embodiments where the genetic profiling, the pharmacogenomics analysis, the drug monitoring analysis and the imaging technique can integrate into a known clinical trial and management scheme (Nature Reviews, Drug Discovery vol. 7, April 2009, which is incorporated by reference herein). In some embodiments illustrated in this figure, additional techniques(s) such as imaging (even 3D imaging) can be employed to monitor any development of the disease/condition. For example, the imaging can be used to monitor the area of the cancerous tissue in the subject and as the treatment advances, the affected area of the tissue may be reduced as shown in this figure. Any available and suitable imaging techniques can be used, e.g., including, but not limited to, CT, PT, MRI, and MRS. Such an additional monitoring means can provide a further readout showing the efficacy of the drug treatment in the subject and also provide further guidance in adjusting the drug treatment regimen when appropriate.

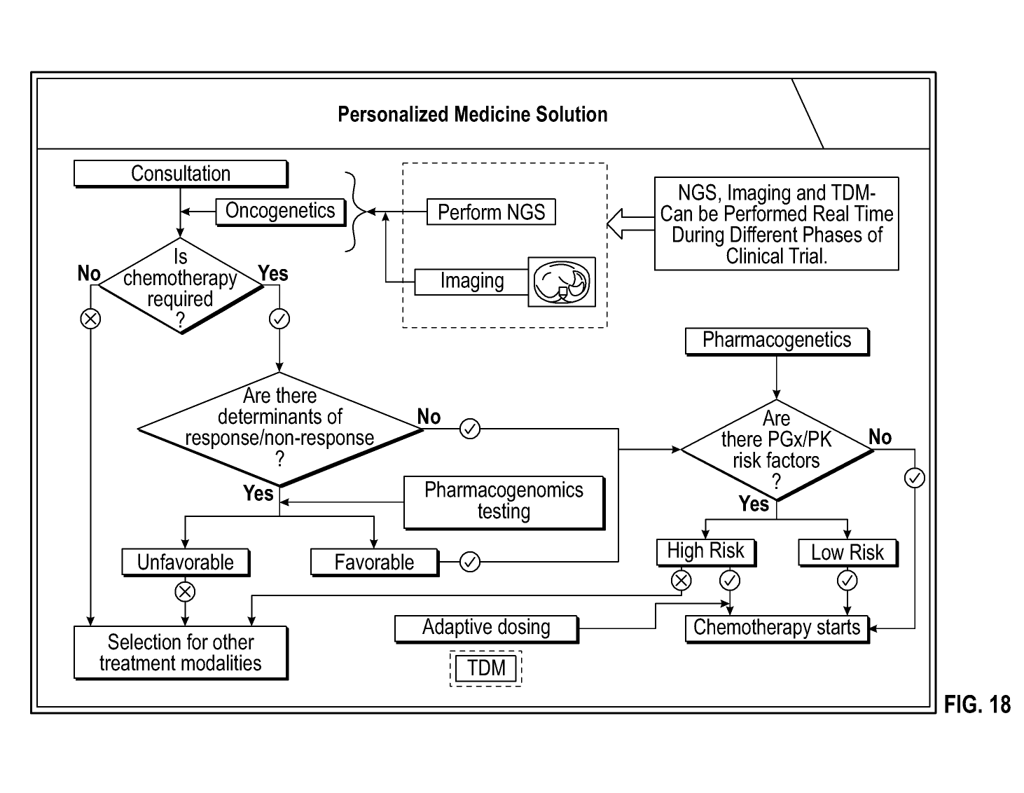

FIG. 18 illustrates certain embodiments of an overall patient treatment plan which includes the genetic profiling, the pharmacogenomics analysis, the drug monitoring analysis and the imaging techniques. However, it is important to note that the strategies described herein can be used separately or in different combinations for different embodiments of the invention. That is, for instance, the genetic profiling, the pharmacogenomics analysis, the drug monitoring analysis are used separately and also in combination of two of the three together.

In one aspect of the invention, a method of providing a drug treatment regimen that is specialized (or customized) for a subject may comprise one or more of the following protocols: a genetic profiling, a pharmacogenomics analysis, and a drug monitoring analysis. In some embodiments, the method may comprise two protocols. In some other embodiments, the method may comprise all three protocols. In some other embodiments, the method may comprise all four protocols, e.g. a genetic profiling analysis, a pharmacogenomics analysis, a drug monitoring analysis and an imaging process. In some embodiments, each of the protocols employed in the method may be conducted once. Alternatively, part or all of the protocols employed in the method may be conducted more than once. Each of the protocols employed in the method of the invention can be conducted substantially simultaneously with one or more of the other protocols. Alternatively, each protocol can be conducted separate from other protocols in a sequence. An order of each of the protocols employed in the method can vary. Therefore, in one example, the method may comprise conducting a genetic profiling of a subject, a pharmacogenomics analysis, and a drug monitoring analysis of the subject (in this order). In another example, the method may comprise conducting a drug monitoring analysis of a subject first and continuously conduct a genetic profiling of the subject and a pharmacogenomics analysis. In still another example, the method may comprise conducting a pharmacogenomics analysis and a drug monitoring analysis of a subject in this order, without conducting a genetic profiling of the subject. Also, as discussed elsewhere in the disclosure, one or more protocols in the method can be conducted substantially simultaneously or substantially separately. Also, at least some of the protocols can be conducted more than once. Therefore, in one of such examples, the method may comprise a genetic profiling of a subject and a drug monitoring analysis of the subject substantially simultaneously, and continue to conduct a pharmacogenomics analysis. As readily clear to a person having ordinary skill in the art, there may be many different combinations of protocols possible for the methods of the invention. All of such possible combinations of the protocols are surely within the scope of the invention.

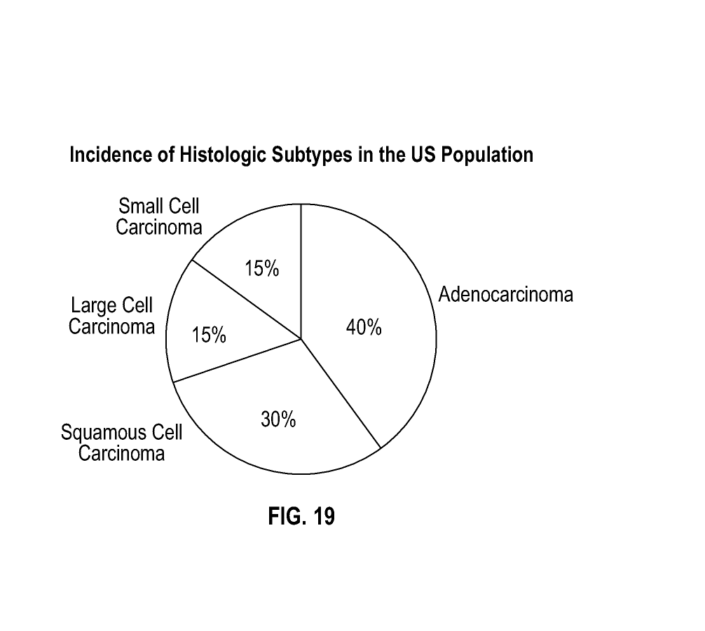

In another example, the method may comprise conducting a genetic profiling of a subject, a pharmacogenomics analysis, a drug monitoring analysis of the subject and an imaging process to monitor the disease status (in this order). In another example, the method may comprise conducting a drug monitoring analysis of a subject first and continuously conduct a genetic profiling of the subject, a pharmacogenomics analysis and an imaging process. In still another example, the method may comprise conducting a pharmacogenomics analysis, a drug monitoring analysis of a subject and an imaging process in this order, without conducting a genetic profiling of the subject. Also, as discussed elsewhere in the disclosure, one or more protocols in the method can be conducted substantially simultaneously or substantially separately. Also, at least some of the protocols can be conducted more than once. Therefore, in one of such examples, the method may comprise a genetic profiling of a subject and a drug monitoring analysis of the subject substantially simultaneously, and continue to conduct a pharmacogenomics analysis, which may be followed by an imaging process. An imaging process can be applied once or more in any time during the method disclosed herein is operated. Thus, in one example, an imaging process can be applied at an early stage of the method so that the subject's disease or the organs/tissues affected by the disease can be monitored. In another example, an imaging process can be applied substantially simultaneously with the drug monitoring analysis so that the effect of the drugs that were selected from a pharmacogenomics analysis and therefore administered to the subject can be monitored. In still another example, an imaging process can be used substantially at a separate time from a drug monitoring analysis. In still another example, an imaging process can be run substantially simultaneously with a genetic profiling analysis, a pharmacogenomics analysis and/or a drug monitoring process. Also as illustrated in an embodiment of FIG. 19 where a certain embodiment of the method is applied to a clinical trial, the imaging process can be conducted at phase I, II and/or III so that the disease status affected by the trial drug can be closely monitored. As readily clear to a person having ordinary skill in the art, there may be many different combinations of protocols possible for the methods of the invention. All of such possible combinations of the protocols are surely within the scope of the invention.

Some embodiments of the invention relate to a method of optimizing a drug therapy for a subject in need of the therapy. The method may comprise processing to obtain a genetic profile of the subject, processing to obtain a pharmacogenomics analysis of the subject, and processing to obtain a level of one or more drugs in the subject. The term “processing” in certain embodiments may include, but is not limited to, an action of actually conducting procedures to obtain the designed results in some embodiments. Therefore, in some embodiments, in the “processing to obtain a genetic profile of the subject” a medical practitioner such as a doctor may have the necessary procedures to obtain the genetic profile of the subject conducted under his/her direct or indirect supervisions. Therefore, for instance, a lab technician or medical practitioner in a hospital or lab environment may conduct a DNA sequence analysis to determine the subject's genetic profile. Alternatively, the “processing” may refer to provision of instructions or an order to an entity such that the entity will conduct procedures to obtain the designed results. Therefore, for example, a medical practitioner may instruct a service company to conduct DNA sequence analysis with the subject's biological sample. The service company may further conduct bioinformatics data analysis with the DNA sequence results to identify the genetic variations of the subject. In these alternative embodiments, the direct or indirect guidance from the medical practitioner may not be necessary. As for the “processing to obtain a pharmacogenomics analysis of the subject”, it may also include embodiments where a medical practitioner would have the pharmacogenomics analysis conducted in a hospital or lab under his/her direct or indirect supervisions. Alternative embodiments may be where a medical practitioner may provide instructions or an order to a separate service company who can conduct necessary procedures for the pharmacogenomics analysis without the medical practitioner's direct or indirect supervisions. As for the “processing to obtain a level of one or more drugs in the subject”, this may cover an embodiment where a medical practitioner would have the drug level be determined in a hospital or lab under his/her direct or indirect supervisions. Alternatively, a medical practitioner may provide instructions or an order to a separate service company who can conduct necessary procedures for the drug level in the subject without the medical practitioner's direct or indirect supervisions. Still alternatively, a medical practitioner may instruct his/her patient to conduct at least part of the necessary procedures for the measurement of the drug level in the subject. In some examples where the drug monitoring analysis is conducted with the subject's blood sample that can be obtained by a finger stick, a doctor or any responsible medical expert may instruct his/her patients to collect their blood using the finger stick device at a given time(s). The collected blood sample can be processed immediately or later to identify and quantify the target drug's level in the subject's system. Processing the collected blood can be done with an analyzer that is operably coupled to the finger stick device at least in some embodiments. The measured and processed information including the measured and determined level of the drugs in the subject can then be transferred to a doctor or any responsible medical expert or a service company who can further process the data. Alternatively, the collected blood sample may be provided to a hospital or a service company where the further processing of the sample and determination of the level of the drugs would be conducted.

In certain embodiments, the process to obtain a genetic profile of the subject may comprise providing a biological sample of the subject. The biological sample may comprise various biological samples comprising genetic material of the subject, including but not limited to, blood, urine, saliva, ascites fluid, lymph, cheek swabs, tissue samples (e.g., biopsies) and the like. The method may further comprise analyzing the biological sample to obtain a first set of data, the first set of data comprising information on one or more genetic alterations or variants of the subject that may be associated with a condition of the subject. The method may also comprise computerized processing the first set of data to provide a second set of data, the second set of data comprising information on a first set of candidate drugs that may be associated with the one or more genetic alternations or variants of the subject. The biological sample that is obtained for the genetic profiling can be blood, urine, saliva, or tissue of the subject.

In certain embodiments, the process to obtain a pharmacogenomics analysis of the subject may comprise processing to obtain a genetic or expression profile of one or more genes that may be associated with a drug metabolic process. The process to obtain a pharmacogenomics analysis may further comprise accessing an impact of said one or more genetic alternations or variants that were identified from the genetic profiling of the subject on a response to the first set of candidate drugs in the subject, and/or a drug-drug interaction between two or more drugs selected from the first set of candidate drugs in the subject. From the results obtained from the pharmacogenomics analysis, a second set of candidate drugs can be determined from the first set of candidate drugs. In certain embodiments, the method of the invention may further comprise, after the computerized processing, providing a report comprising information on the first set of candidate drugs. In some other embodiments, the method may further comprises, after the second set of candidate drugs are determined, a report comprising information on the second set of candidate drugs can be generated (or provided). In some embodiments, the report may further comprise one or more of: one or more combinations of drugs from the second set of candidate drugs, a range of dose for a drug of the second set of candidate drugs, a range of application period and/or frequency for a drug of the second set of candidate drugs, and information on potential risk or adverse effect of a drug of the second set of candidate drugs.

In certain embodiments, the process to obtain a level of one or more drugs in the subject may comprise providing a biological sample from the subject, monitoring the presence and/or a level of one or more drugs in the biological sample, wherein said one or more drugs are selected from the second set of candidate drugs and have been administered to the subject, and determining the level(s) of the one or more drugs in the subject. In some embodiments, the method may further comprise, after the determining the level(s) of the one or more drugs in the subject, determining if a mode of application of at least one drug that has been administered to the subject needs to be altered or maintained. In certain some embodiments, a report comprising information of the maintenance or adjustment of the mode of application can be generated (or provided). The biological sample used to obtain the pharmacogenomics data may be blood, urine, saliva, and/or tissue of the subject. Combinations of these biological samples are used in some embodiments.

Another aspect of the invention may relate to a method of optimizing a drug therapy for a subject in need of the therapy. The method may comprise processing to select a first set of candidate drugs that may be associated with a condition of the subject, processing to obtain a pharmacogenomics analysis of the subject, and processing to obtain a level of one or more drugs in the subject.

The above-mentioned term “processing” in certain embodiments may include, but is not limited to, an action of actually conducting procedures to obtain the designed results in some embodiments. Therefore, in certain embodiments, in the “processing to select a first set of candidate drugs”, a medical practitioner such as a doctor may have the necessary procedures to obtain the genetic profile of the subject conducted under his/her direct or indirect supervisions. Therefore, for instance, a lab technician or medical expert in a hospital or lab environment may identify a first set of candidate drugs, especially those may be associated with a condition of the subject. Alternatively, the “processing” may refer to provision of instructions or an order to an entity such that the entity will conduct the procedures to obtain the designed results. Therefore, for example, a medical practitioner may instruct a service company to conduct procedures, e.g. bioinformatics procedures and/or database searching, to identify the candidate drugs that may be associated with the subject's condition. In these alternative embodiments involving the service company, the direct or indirect guidance from the medical practitioner may not be necessary.

As for the “processing to obtain a pharmacogenomics analysis of the subject”, it may also include embodiments in which a medical practitioner would have the pharmacogenomics analysis conducted in a hospital or lab under his/her direct or indirect supervisions. Alternative embodiments may include instances when a medical practitioner may provide instructions or an order to a separate service company who can conduct the necessary procedures for the pharmacogenomics analysis without the medical practitioner's direct or indirect supervisions.

As for the “processing to obtain a level of one or more drugs in the subject”, this may include embodiments in which a medical practitioner would have the drug level(s) be determined in a hospital or lab under his/her direct or indirect supervisions. Alternatively, a medical practitioner may provide instructions or an order to a separate service company who can conduct the necessary procedures for the drug level(s) of the subject without the medical practitioner's direct or indirect supervisions. Still alternatively, a medical practitioner may instruct his/her patient to conduct at least part of the necessary procedures for the drug level monitoring. In some examples where the drug level monitoring is conducted with the subject's blood sample that can be obtained by a finger stick device, a doctor or any medical practitioner may instruct his/her patients to collect their blood using the finger stick device at a given time(s). The collected blood sample can be processed immediately or later to identify and quantify the level of the target drug(s) in the subject's system. Processing the collected blood can be done with an analyzer that is operably coupled with the finger stick device in certain embodiments. The measured and processed information including the measured and determined level of the drugs can then be transferred to a doctor or any responsible medical expert or a service company who can further process the data. Alternatively, the collected blood sample may be provided to a hospital or a service company where the further processing of the sample and determination of the level of the drugs can be conducted.

In several embodiments, the use of DNA sequence analysis (e.g., next generation DNA sequencing) is used to identify genetic abnormalities (e.g., genetic mutations, gene fusions, etc.) within a tumor (or other diseased tissue), providing physicians with an improved ability to understand the specifics of a disease for a particular patient. The bioinformatics that can be rendered through the comprehensive analysis of the data generated from DNA analysis is used in several embodiments of the present invention in a number of ways; including, but not limited to, identification of recommended drugs (including both on and off-label) that have been found to benefit patients with specific tumor types (or other disease types) as well as identify open clinical trials for patient/physician consideration. Further, in several embodiments, the outcomes and recommendations of drugs rendered through the sequence analysis are coupled with a pharmacogenomics analysis which shows a physician a specific patient's genotype/phenotype (e.g., metabolic classification) for drugs considered for use in therapy, as well as a thorough analysis of the patient current drug list to identify any inducer, inhibitory or competitive pathway issues. Together, these analyses, in several embodiments, ensure the patient is treated with a specific, efficacious drug, based on the specific tumor type and/or accompanying mutations, metabolic phenotype, and potential for drug-drug interactions. Moreover, in several embodiments, the metabolic profiling of a subject including therapeutic drug monitoring (TDM) is also employed to further refine a patient's progress when a therapeutic regimen is administered.

Thus, in several embodiments, there is provided a for method for optimizing a therapeutic regimen for a subject having a cancerous tumor, comprising obtaining a biological sample comprising one or more cells from said cancerous tumor from the subject, isolating genetic material from the biological sample (e.g., isolation of DNA, RNA, protein, etc.), evaluating the isolated genetic material to detect one or more genetic mutations associated with the one or more cells from the cancerous tumor, for example by next generation sequencing techniques, accessing, by a computer system, a first electronic database to identify one or more potential therapeutic compounds having demonstrated therapeutic in treating either (i) other patients having the same type of cancerous tumor, or (ii) other patients sharing one or more of the detected genetic mutations. In addition, in certain embodiments, the method may comprise performing a genomic analysis of the genetic material, which can be obtained from cancerous or non-cancerous tissues/cells of the subject, to identify subject-specific phenotypic characteristics related to the metabolism of one or more of the potential therapeutic compounds, wherein the subject-specific phenotypic characteristics are related to the metabolism of the one or more potential therapeutic compounds allow the subject to be characterized as a poor metabolizer, an intermediate metabolizer, an extensive metabolizer, or an ultra-rapid metabolizer, accessing, by a computer system, a second electronic database to identify possible interactions (e.g., drug-drug interactions) between the one or more potential therapeutic compounds and any secondary medications that are being taken by the subject, such as shared metabolic pathways, likelihood of the potential therapeutic compound to induce or inhibit a metabolic pathway of a secondary medication (thus reducing the potential efficacy of the secondary medication or cause a side effect), and likelihood of to induce or inhibit a metabolic pathway of a potential therapeutic compound (thus reducing the potential efficacy of the potential therapeutic compound or cause a side effect), and outputting, by the computer system, a recommendation based on the genetic mutation analysis, the genomic analysis, and the possible interactions, for an optimized therapy to treat the subject having a cancerous tumor. In several embodiments, the one or more potential therapeutic compounds may be on-label, off-label, or combinations thereof, depending on the number identified. Thus, the methods disclosed herein integrate the data related to genetic mutations, the pharmacogenomic profile of the subject, and the potential for drug-drug interaction to identify the most therapeutic regimen for that subject. For example, other therapeutic agents that subject is taking may negatively impact the treatment regimen or individual drug performance if a drug within the regimen is characterized as an inducer or inhibitor of a pathway, which could subsequently compromise that pathway in a way that would negatively impact the anticipated efficacy of the drug or treatment regimen.

In several embodiments, the cancerous tumor comprises non-small cell lung cancer. In several such embodiments, the one or more potential therapeutic compounds comprises crizotinib.

In several embodiments, the method further comprises treating the subject with the optimized therapy. In some such embodiments, the methods further comprise performing therapeutic drug monitoring to evaluate the efficacy of the optimized therapy in treating the cancerous tumor.

In several embodiments, accessing the first electronic database also identifies open clinical trials for the one or more potential therapeutic compounds.

In several embodiments, the methods disclosed herein may comprise a step of administering to a patient one or more candidate drugs that were studied and recommended from one or more of a genetic profiling analysis and a pharmacogenomics analysis.

In several embodiments, the methods disclosed herein may comprise a step of administering to a patient one or more drugs after the doses of the one or more drugs have been altered or modified.

### Example

### Tailored Therapies for Non-Small Cell Lung Cancer

According to the National Comprehensive Cancer Network® lung cancer is the leading cause of cancer death in the United States. In 2012, an estimated 226,000 new cases (116,000 in men and 110,000 in women) of lung and bronchial cancer will be diagnosed, and 160,000 deaths (88,000 men and 72,000 women) are estimated to occur because of the disease. Only 15.9% of all lung cancer patients are alive 5 years or more after diagnosis and when the disease is advanced, the 5-year survival rate goes down to 5% or less. In addition, at least 40% of lung cancer patients preset from metastatic disease. However a great deal of progress has been made in the last 10 years for lung cancer (screening, minimally invasive techniques for diagnosis or treatment, targeted therapy).

Lung cancer is a leading cause of cancer death worldwide, and late diagnosis is a major obstacle to improving lung cancer outcomes. Due to the fact that localized cancer can be managed curatively and because the mortality rate in other solid tumors (cervix, colon) seems to be decreased by screening and early detection, lung cancer would be an appropriate candidate for a population-based screening approach.

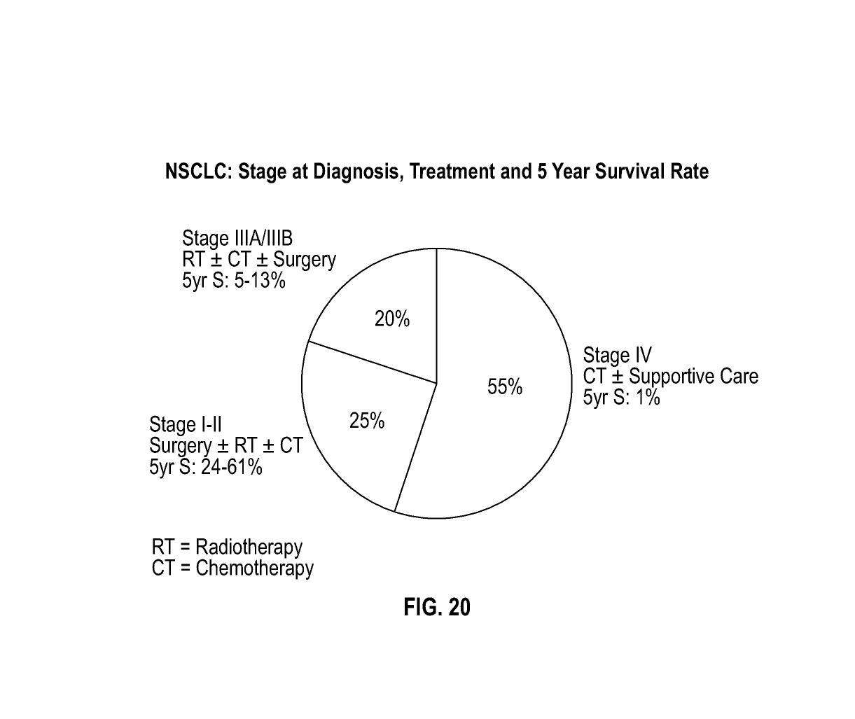

The WHO divides lung cancer into 2 major classes based on its biology, therapy, and prognosis: non-small cell lung cancer, (NSCLC) and small cell lung cancer. NSCLC accounts for more than 85% of all lung cancer cases, and it includes 2 major types: 1.) non-squamous carcinoma (including adenocarcinoma, large-cell carcinoma, and other cell types); and 2.) squamous cell (epidermoid) carcinoma. FIG. 19 shows incidence of histological subtypes of lung cancer in the U.S. population. FIG. 20 shows the stages at diagnosis, treatment and 5-year survival rate measured from a group of NSCLC patients. Notably the 5-year survival rate significantly reduces as the disease is advanced to a later stage, i.e. from 24-61% at stages I-II to 1% at stage IV.

Certain prognostic factors may be predictive of improved survival in patients with NSCLC. Good prognostic factors include early-stage disease at diagnosis, good performance status, no significant weight loss, and female gender.

NCCN (National Comprehensive Cancer Network) states that all findings and patient factors need to be carefully evaluated in a multidisciplinary diagnostic team before establishing a diagnosis of lung cancer and before starting treatment. The NCCN Guidelines recommend biopsy or surgical excision for highly suspicious nodules seen on low-dose CT scans or further surveillance for a low suspicion of cancer depending on the type of nodule and multidisciplinary evaluation of other patient factors. The NCCN Guidelines recommend that the diagnostic strategy should be individualized for each patient depending on the size and location of the tumor, presence of mediastinal or distant disease patient characteristics (comorbidities), and local experience.

The pathological evaluation is performed to classify the histological type of lung cancer, determine the extent of invasion, determine whether it is primary lung cancer or metastatic, establish the cancer involvement status of the surgical margins, and do molecular diagnostic studies to determine wither certain gene alterations are present (epidermal growth factor receptor mutations). Data show that targeted therapy is potentially very effective in patients with specific gene mutations or rearrangements (e.g., EGFR Mutations and ALK Gene Rearrangements). Preoperative evaluations include examination of the following: bronchial brushings, bronchial washings, fine-needle aspiration biopsy.

Several biomarkers are potential prognostic and/or predictive markers for NSCLC. As used herein, the term “prognostic biomarker” shall be given its ordinary meaning and shall also refer to a biomolecule that is indicative of a patient survival independent of the treatment received; e.g., the biomolecule is an indicator of the innate tumor aggressiveness. As used herein the term “predictive biomarker” shall be given its ordinary meaning and shall also refer to a biomolecule that is indicative of therapeutic efficacy; that is, there is an interaction between the biomolecule and therapy on patient outcome. Among these biomarkers, EFGR, the 5′ endonuclease of the nucleotide excision repair complex (ERCC1), the KRAS oncogene, and the ALK fusion oncogene (fusion between anaplastic lymphoma kinase [ALK] and several other genes [e.g., echinoderm microtubule-associated protein-like 4]) appear to exhibit the best potential for use as prognostic or predictive biomarkers. See FIGS. 1A-1B.

EGFR is a transmembrane receptor that is detectable in approximately 82% of patients with NSCLC. The most common found mutations in patients with NSCLC are deletions in exon 19 and a mutation in exon 21. Both mutations result in activation of the tyrosine kinase domain, and both are associated with sensitivity to the small molecule TKI's erlotinib, and gefitinib. The drug-sensitive mutations are found in approximately 10% of Caucasian patients and up to 50% of Asian patients. Other drug-sensitive mutations include point mutations at exon 21 and exon 18. Primary resistance to TKI therapy is associated with KRAS mutations and ALK gene rearrangements. Certain patients with drug-sensitive EGFR mutations at Exon 19 and 21 have a significantly better response to erlotinib or gefitinib. In several embodiments, the methods disclosed herein allow an analysis of whether a subject has those mutations, and further an analysis of whether the patient's genomic profile and/or concurrently administered drugs may alter the efficacy of drugs such as erlotinib or gefitinib. Retrospective studies of patients having one of those mutations demonstrates a response rate of approximately 80% with a median progression-free survival of 13 months to single agent therapy in patients with a bronciovoalveolar variant of adenocarcinoma and an EGFR mutation. In several embodiments, the data generated from the mutation and/or pharmacogenomics reports lead to an advantageous shift in what is used as a first line therapy.

The presence of the EGFR exon 19 deletion (LREA) or exon 21 L858R mutations does not appear to be prognostic of survival for patients with NSCLC, independent of therapy. However, the presence of the EGFR exon 19 deletion or exon 21 L858R mutation may be predictive of treatment benefit from EGFR tyrosine kinase inhibitor (EGFR-TKI) therapy. High levels of ERCC1 expression may also predictive of poor response to platinum-based chemotherapy. The presence of KRAS mutations appears to be prognostic of poor survival for patients with NSCLC when compared to absence of KRAS mutations, independent of therapy. KRAS mutations also appear to be predictive of lack of benefit from platinum/vinorelbine chemotherapy or EGFR TKI therapy. The ALK fusion oncogene (ALK gene rearrangement) is a new predictive biomarker that has been identified in a small subset of patients with NSCLC. Other gene rearrangements, such as the ROS1 mutation may also be useful as markers that can be used to develop targeted therapies.

Testing for EGFR mutations and ALK rearrangements is recommended in the NCCN Guidelines for NSCLC for select patients (those with adenocarcinoma) so that patients with these genetic abnormalities can receive effective treatment (e.g., erlotinib, crizotonib). See FIGS. 1A-1B. Patients with NSCLC may have other genetic abnormalities as well and it is recommended that other mutational assays are leveraged to identify these genetic deviations, such as those provided in the various sequencing methods identified herein. In several embodiments, the genetic analysis of a subject's DNA allows for identification of other mutations that may be relevant to the therapeutic regime designed for a specific patient.

Approximately 2-7% of patients have ALK gene rearrangement, about 10,000 patients in the United States. These patients are often resistant to EGFR TKI's but exhibit similar clinical characteristics to those with EGFR mutations. Thus erlotinib (or gefitinib) may not typically be recommended as second-line therapy in patients with ALK rearrangements who relapse on crizotonib. Crizotinib is an inhibitor of ALK and MET tyrosine kinases that is approved by the FDA for patients with locally advance or metastatic NSCLC who have the ALK gene rearrangement. While crizotonib can yield very high response rates (>60%) and improve survival when used in patients with advanced NSCLC who have ALK rearrangements and have progressed on previous therapy, a few patients have had life-threatening pneumonitis. Continued use of crizotonib is not recommended for these patients. The methods disclosed herein can, in several embodiments, avoid such problematic side effects, through analysis of the specific genetic makeup of patient that may predispose them to such side effects.

Approximately 25% of adenocarcinomas in a North American population have KRAS mutations, which is the most common mutation. KRAS mutational status is prognostic of survival. Patients with KRAS mutations appear to have a shorter survival than patients with wild-type KRAS. KRAS mutational status is also predictive of lack of therapeutic efficacy with EGFR-TKI's; however, it does not appear to affect chemotherapeutic efficacy.

Other driver mutations and gene fusions continue to be identified, such as, for example, ERBB2 and BRAF mutations, ROS1 and RET gene fusions, and MET amplification. Targeted agents are available for patients with these genetic alterations, although they are FDA approved for other indications.

TABLE 6
Targeted Agents for Patients with Genetic Alterations

| Genes having a variation, | | |
|---|---|---|
| e.g. mutation, amplification, | Frequency | |
| fusion, rearrangement | in NSCLC | Drug |
| ALK gene rearrangements | 3-7% | Crizotinib |
| EGFR mutations | 10-35% | Gefitinib, Erlotinib |
| HER2 mutations | 2-4% | Afatinib, Trastuzumab, |
| | | lapatinib, pertuzumab |
| BRAF mutations | 1-3% | Vemurafenib |
| MET amplification | 2-4% | Crizotonib |
| ROS1 gene fusions | 1% | Crizotonib |
| RET gene fusions | 1% | Vandetanib, sunitinib, |
| | | sorafenib |
| KRAS | 15-25% | |
| FGFR1 | 20% | |
| PTEN | 4-8% | |
| DDR2 | ~4% | |
| PIK3CA | 1-3% | |
| AKT1 | 1% | |
| MEK1 | 1% | |
| NRAS | 1% | |
| RET | 1% | |

Upon identification of the candidate drugs from the genetic profiling analysis, the pharmacogenomics analysis can follow in order to access the impacts of the subject genetics on the response to medication in the subject, and/or the possible drug-gene and drug-drug interactions. Drugs that share a common pathway (e.g., one or more drugs metabolized by the CYP system) have potential for drug-drug interactions. Classification of CYP proteins can be an indication to a practitioner of the potential for drug-drug interactions. In this particular example as illustrated in FIGS. 1 and 2, various genes relates to the CYP system, e.g. CPY2C9, CYP2C19, CYP2D6, CYP3A4, CYP3A5, CYP1A2, VKORC1, FII, FV, and MTHFR can be tested and monitored for any genetic variations thereon and any resulting impact on the CYP system and drug metabolism. In addition, any drug-drug interaction between the candidate drugs identified in Table 6 can be further accessed. Accordingly, as illustrated in FIGS. 10A-10L, the data obtained from the pharmacogenomics analysis can be provided. The data may comprise information related to the potential impact of the subject's genetic variations on the candidate drugs as well as the potential impact resulted from the drug-drug interaction. In addition, after processing the data obtained from the genetic profiling analysis and the pharmacogenomics analysis, the recommended protocols of drug treatment that is specially designed for the subject are provided in the report. Therefore, the report can provide information to a medical practitioner including a list of recommended drugs, the recommended application protocols including the dosing and application period, potential predictable risks or side effects, cautions and warnings on the application, and more. The medical practitioner can then apply the recommended drug protocols to the subject directly or with modification.

In some embodiments that are illustrated in FIGS. 10A-10L, the method disclosed herein can test one or more genes that are characteristic of absorption, distribution, metabolism, and/or excretion of drugs in the subject. As illustrated in FIGS. 10A-10L, for example, one or more genes selected from the group consisting of gene encoding Factor II (Prothrombin), gene encoding Factor V (Leiden), gene encoding Methylenetetrahydrofolate reductase (MTHFR), gene encoding VKORC1, gene encoding Cytochrome P4502C9 (CYP2C9), gene encoding Cytochrome P4502C19 (CYP2C19), gene encoding Cytochrome P4502D6 (CYP2D6), gene encoding Cytochrome P4503A4 (CYP3A4), gene encoding Cytochrome P4501A2 (CYP1A2), and gene encoding Cytochrome P4503A5 (CYP3A5) can be tested. Each of the genes tested in the pharmacogenomics analysis may comprise one or more alleles and thus multiple alleles can be tested for individual genes in certain embodiments. Combinations of the alleles for the test can vary, e.g. in one embodiment a single allele can be tested, in another embodiment two or more alleles of a single gene can be tested, and still in another embodiment, one or more alleles from two or more genes can be tested. Once the selected allele(s) for one or more genes are tested, a genotype of the tested gene(s) can be determined. Examples of genotypes can found from FIGS. 10A-10L. Once the genotypes of the tested genes are determined, corresponding phenotypes can be determined and examples of such phenotypes (e.g. different levels of metabolizer for individual gene) can also be found from FIGS. 10A-10L. The results of the genotypes and corresponding phenotypes of the subject can be used as indicator of the pharmacokinetic profile of the subject.

As illustrated in FIGS. 10A-10L, information related to drug-gene interactions, e.g. an impact of the pharmacokinetic profile of the subject on a recommended dosage amount of each of certain candidate drugs, can be provided through the pharmacogenomics analysis of the method disclosed herein. Further, information related to drug-drug interactions, e.g. an impact of putative or actual drug-drug interactions for each of candidate drugs selectee from the genetic profiling analysis and one or more drugs currently being administered or contemplated to be administered to the subject, can be provided from the method disclosed herein. When evaluating the drug-gene and/or drug-drug interactions, one or more alleles can be considered. Thus, in one embodiment, a single allele can be tested and considered to evaluate the drug-drug interaction and/or drug-gene interaction. In another embodiment, two or more alleles from a single gene can be tested and considered to evaluate the interactions (or impacts). In still another embodiment, one or more alleles from two or more genes can be tested and considered simultaneously to evaluate the interactions (or impacts).

Pharmacogenomic interpretation can also provide information on application details (e.g. dose, application frequency, and period). See, e.g. FIGS. 10A-10L. Similar with the evaluation of drug-drug or drug-gene interactions, one or more alleles from a single gene or multiple genes can be considered to process and compute the application details. For example, as illustrated in FIGS. 10A-10L, two genes, CYP2C9 and VKORC1 can be considered. Each gene can have more than one genotypes and alleles and thus, when considering multiple genes, the possible combinations of genetic alterations or variants can be many. Thus, in the example provided in FIGS. 10A-10L, there can be at least eighteen different combinations of allelic combinations between two genes and the dosing recommendation of COUMADIN, the drug of consideration in this example, can vary in different combinations of genetic background.

Also illustrated in FIGS. 10A-10L is estimated time to reach steady state of a drug. This type of information can also be used to determine application frequency and/or period. In this process of computing estimate effective time, one or more alleles from a single gene or multiple genes can be considered. Thus, as illustrated in this figure (more particularly TABLE 2 embedded in FIGS. 10A-10L), different periods expected to reach steady state of COUMADIN multiple variants of CYP2C9 can be computed depending on the genetic backgrounds of the subject.

As illustrated in non-limiting examples from FIGS. 10A-10L, the method disclosed herein can provide recommendation of one or more drug and the application details thereof based on the subject's pharmacokinetic profile. The profiling of the subject's pharmacokinetics can be done by testing one or more alterations or variants of genes that are associated with processing and metabolizing drugs including absorption, distribution, metabolism and excretion. Each gene may have more than one alteration or variant. Such a case, two or more of such alterations or variants of a signal gene can be tested and the genotype of the gene can be determined. Also, more than one of such genes can be tested and considered simultaneously. Thus, in certain embodiments, one or more alterations or variants of two or more genes can be monitored and the genotypes of such genes can be determined in the subject. The recommended drug regimen and application details (e.g. dosing and application period and frequency) can be determined based on combinatorial consideration of the genotypes (or corresponding phenotypes) of such tested genes.

In some embodiments, two or more, three or more, four or more, five or more, six or more, seven or more, eight or more, nine or more, or ten or more alleles from a single gene or multiple genes can be considered in the pharmacogenomics analysis in the method disclosed herein. In certain embodiments, more than ten alleles of a single gene or multiple genes can be considered in the pharmacogenomics analysis.

In some other embodiments, the genotype and/or phenotype of one gene can be considered in the pharmacogenomics analysis. Alternatively, the genotype and/or phenotype of two or more, three or more, four or more, five or more, six or more, seven or more, eight or more, nine or more, or ten or more genes can be considered in the pharmacogenomics analysis in the method disclosed herein. In certain embodiments, more than ten genes can be considered in the pharmacogenomics analysis.

After the recommended drug treatment protocols are implemented such that the recommended drugs are administered to the subject, a metabolic profiling of one or more of the administered drugs can be performed. In certain embodiments, a technique based on mass spectrometry can be employed to measure the metabolic level of the drugs in the subject. A biological sample such as the subject's blood can be taken by, e.g. a finger stick device and processed to determine the metabolic profile of the drug. If a certain drug is determined to be metabolized more than expected, this may lead to a consideration of increasing the dose, application amount or frequency of the drug so as to reach the desired efficacy. If a certain drug is determined to be metabolized less than expected, this may lead to a consideration of reducing the dose, application amount or frequency of the drug so as to maximize the desired efficacy and minimize any side effects. Alternatively, if the metabolism of a certain drug is substantially out of the expected range, thereby possibly risking the efficacy of the therapy, this may lead to a consideration of removal of the drug and/or substitution for a new candidate drug.

It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. For example, actions such as “collecting a biological sample from a subject” include “instructing the collection of a biological sample from a subject.”

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers. For example, “about 10 nanometers” includes “10 nanometers.”

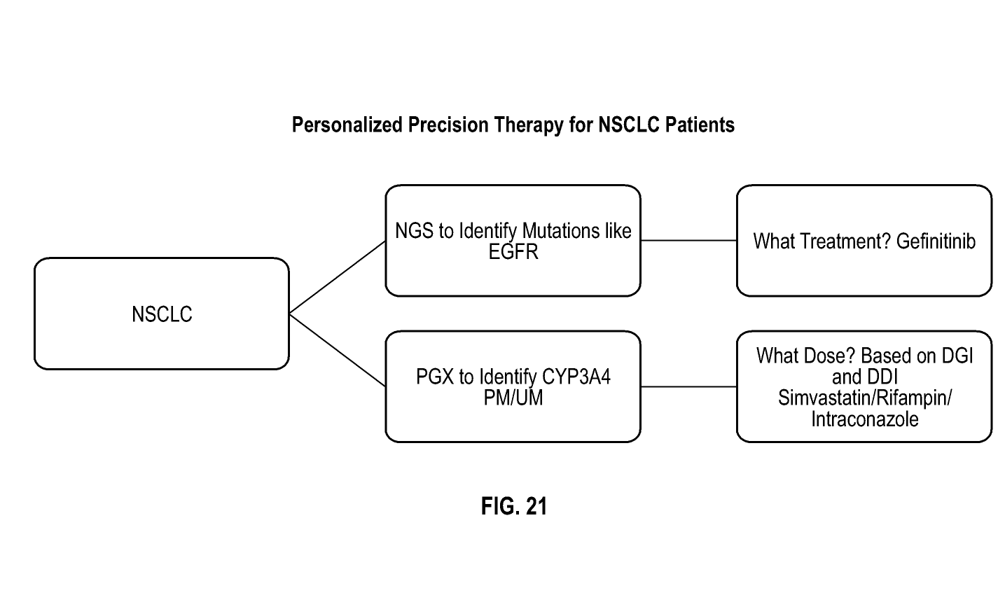

FIG. 21 shows an alternative example where a patient diagnosed with NSCLC may be subjected to an embodiment of the methods disclosed herein. In this particular example, the genetic profiling analysis of the subject may identify a mutation in EGFR gene and this result may lead to a candidate drug of gefinitinib (and possibly more). In addition, the pharmacogenomics analysis may identify that the patient has CYP3A4 allele suggesting that the patient is a poor metabolizer of CYP3A4. A further study under the pharmacogenomics analysis on potential drug-drug interaction (DDI) and drug-gene interaction (DGI) may be conducted to finalize a drug treatment protocol that is customized for the patient. Implementation Systems.

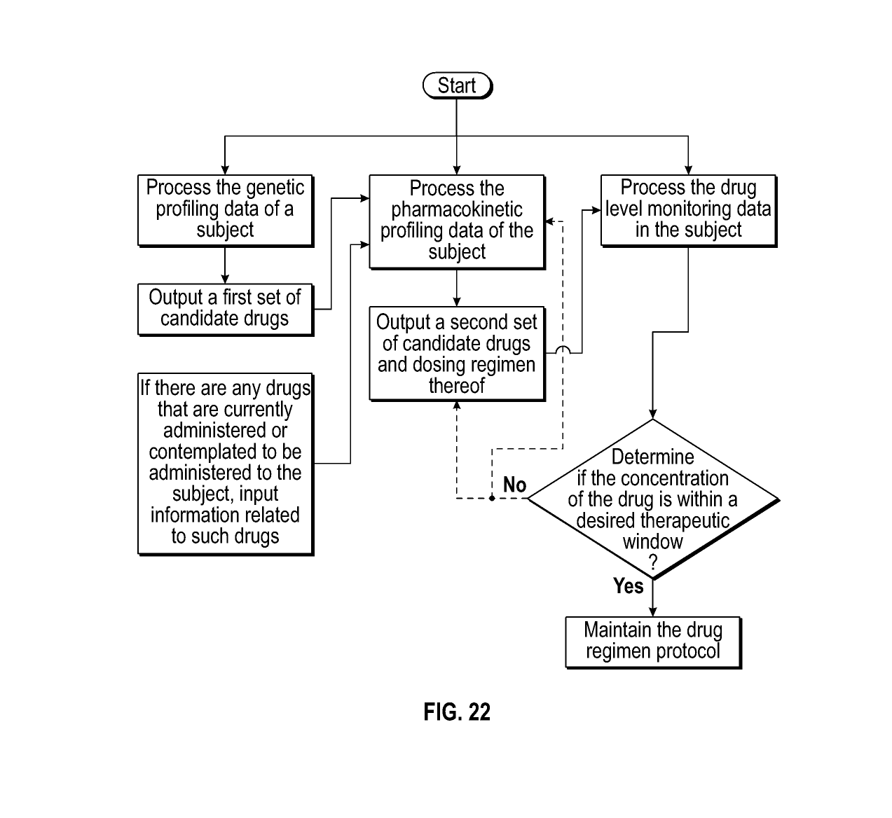

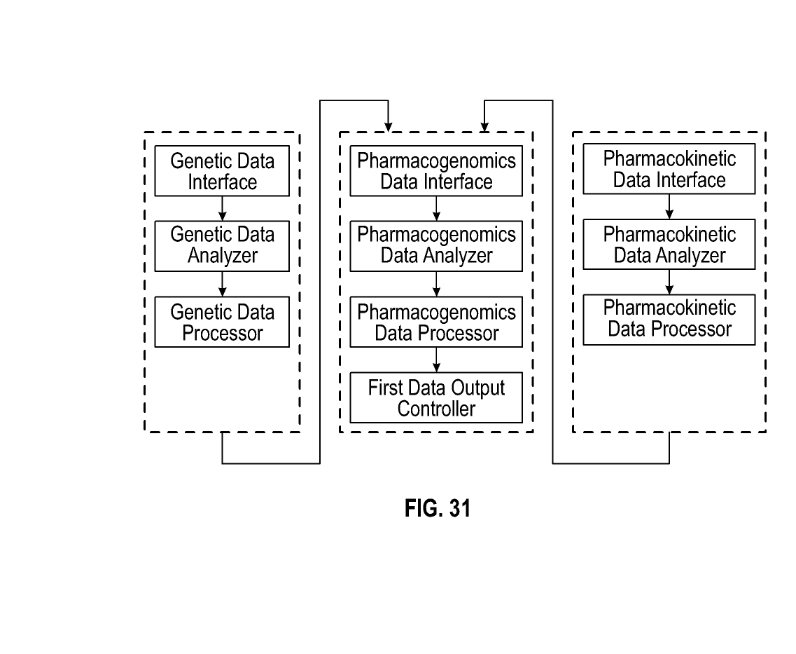

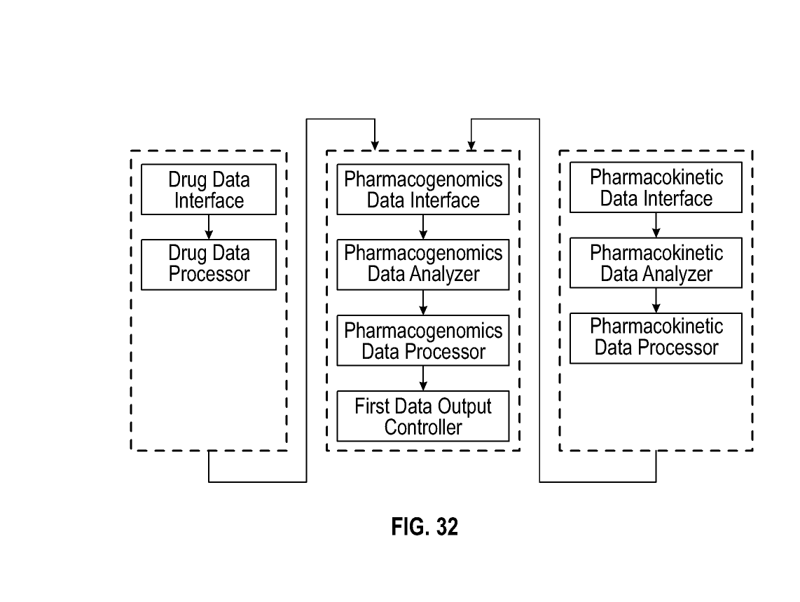

Various embodiments illustrated in FIGS. 22-32 are related to the systems that are configured to implement (in whole or in part) the methods disclosed herein. The system may comprise at least one or more of hardware such as computers, software such as algorithms, computer languages, programs and databases, and a network.

FIG. 22 shows certain embodiments of the methods disclosed herein, especially related to a system that is configured to implement a subject-specific therapeutic drug treatment regimen. In some embodiments, the system may comprise three subsystems, e.g., a subsystem that is configured to process the genetic profiling of a subject, a subsystem that is configured to process the pharmacogenomics analysis of the subject, and a subsystem that is configured to process the therapeutic drug monitoring analysis in the subject. The embodiment illustrated in FIG. 22 employs these three subsystems to develop the subject-specific therapeutic drug treatment regimen.

In certain embodiments, a subsystem that is configured to process the genetic profiling of the subject may output the data related to a first set of candidate drugs that are known to be associated with the condition or disease of the subject. Associated genes may include, but are not limited to, genes that are known to be genetically linked to a certain disease or condition. Alternatively, the associated genes may include genes that are known to directly or indirectly involve the occurrence or development of the concerned disease or condition. Genes that are believed, but not yet demonstrated, to be associated with a disease may also be assessed, in several embodiments.

The data of the first set of candidate drugs may be provided to a subsystem that is configured to process the pharmacogenomics analysis of the subject. Also, in certain embodiments, additional information related to drugs that are currently administered or contemplated to be administered to the subject can be provided to the subsystem processing the pharmacogenomics analysis of the subject. This subsystem may output the data related to a second set of candidate drugs and dosing regimen thereof.

In some embodiments, the data related to the second set of candidate drugs and the dosing regimen thereof can be used to set an actual drug regimen protocol that is specific to the subject. According to this protocol, the subject may be administered with one or more of the recommended drugs (e.g., the second set of candidate drugs) with a certain dose that is determined based on the recommended dosing regimen from the pharmacogenomics analysis.

In certain embodiments, the level of the drugs that were administered in the subject based on the recommendation from the pharmacogenomics analysis may be measured. The results of the measurement may be provided to the subsystem that is configured to process the therapeutic drug monitoring analysis in the subject. After processing the measurement results, this subsystem can determine if administration of the drugs need to altered or maintained. The information related to any changes or maintenance of the drug regimen can be output, e.g. in form of a report. If any alteration of drug regimen or substitution of drugs is recommended, the information related to such changes can be provided to the subsystem of pharmacogenomics analysis so as to either identify alternative drugs and/or update (or modify) the recommended drug regimen protocols.

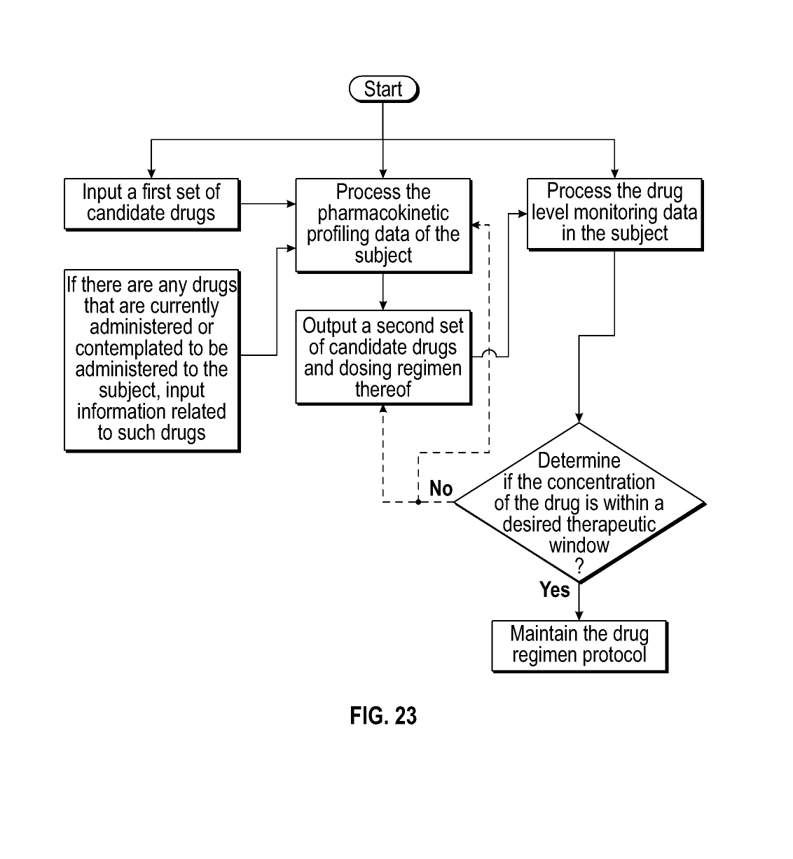

FIG. 23 illustrates an additional embodiment where the genetic profiling process is optionally not employed. Instead, the data related to the first set of candidate drugs can be generated based on the information related to the subject's condition. For example, if the subject is diagnosed with, for example, a bacterial infection, one or more drugs that are known to be effective in treating the diagnosed infection can be identified, e.g. via querying an electronic drug database. Alternatively, if the subject's high-fat diet is concerned, one or more candidate drugs that are known to lower the fat level or ameliorate side effects of high-fat diet can be identified from a relevant drug database. This information of the first set of candidate drugs, which is generated without the genetic profiling of the subject, can be provided to the subsystem of pharmacogenomics analysis to output the second set of candidate drugs.

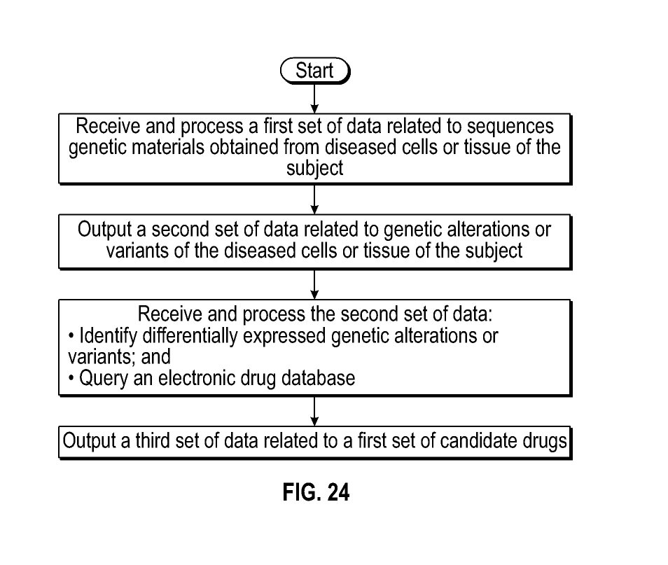

FIG. 24 illustrates certain embodiments of the subsystem that is configured to process the genetic profiling of the subject. In some embodiments, this subsystem may be configured to process a first set of data using a computer system. The computer system may utilize one or more algorithms designed to process one or more sets of the data. The subsystem may be configured to receive and assess the first set of data and provide an output comprising a second set of data. The first set of data may comprise information related to sequences of genetic materials obtained from diseased cells or tissue of the subject. The second set of data may comprise information related to one or more genetic alternations or variants of the diseased cells or tissue of the subject as compared to normal, non-diseased cells. In some embodiments, the computer system comprises an algorithm that compares a data point from the first set of data with a corresponding data point from normal, non-diseased cells. The subsystem may also be configured to process the second set of data using a computer system configured to receive and assess the second set of data and provide an output comprising a third set of data. The processing of the second set of data may comprise identifying differentially expressed genetic alterations or variants in the diseased cells and querying an electronic drug database. The third set of data may comprise information related to a first set of candidate drugs that may be associated with an elevated degree of therapeutic efficacy against cells exhibiting the one or more genetic alternations or variants identified in the diseased cells or tissue of the subject.

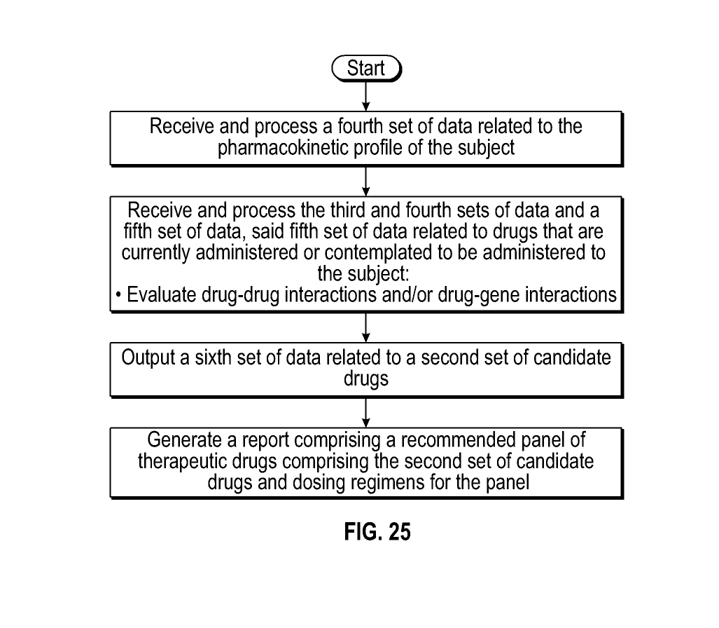

FIG. 25 illustrates certain embodiments of the subsystem that is configured to process the pharmacogenomics analysis of the subject. In some embodiments, this subsystem may be configured to process a fourth set of data using a computer system. The subsystem may be configured to receive and assess the fourth set of data. The fourth set of data may comprise information related to the pharmacokinetic profile of the subject. The pharmacokinetic profile of the subject may be determined by screening the subject for characteristic identifiers of absorption, distribution, metabolism, and/or excretion of drugs. The subsystem may also be configured to process the third and fourth sets of data and a fifth set of data using a computer system. The subsystem may be configured to receive and assess data (e.g., one or more of the third, fourth, and fifth sets of data described above) and/or other input related to a panel of drugs currently being administered or contemplated to be administered to the subject. In some embodiments, the processing of the third, fourth, and fifth sets of data may comprise evaluating one or more of the following: an impact of the pharmacokinetic profile of the subject on a recommended dosage amount of each of the first set of candidate drugs, and an impact of putative or actual drug-drug interactions for each of the first set of candidate drugs and one or more drugs currently being administered or contemplated to be administered to the subject. The subsystem for processing the pharmacogenomics analysis of the subject may also be configured to provide an output comprising a sixth set of data comprising information related to a second set of candidate drugs. In certain embodiments, the subsystem may generate at least one report and the report may comprises a recommended panel of therapeutic drugs comprising the second set of candidate drugs and dosing regimens for the panel.

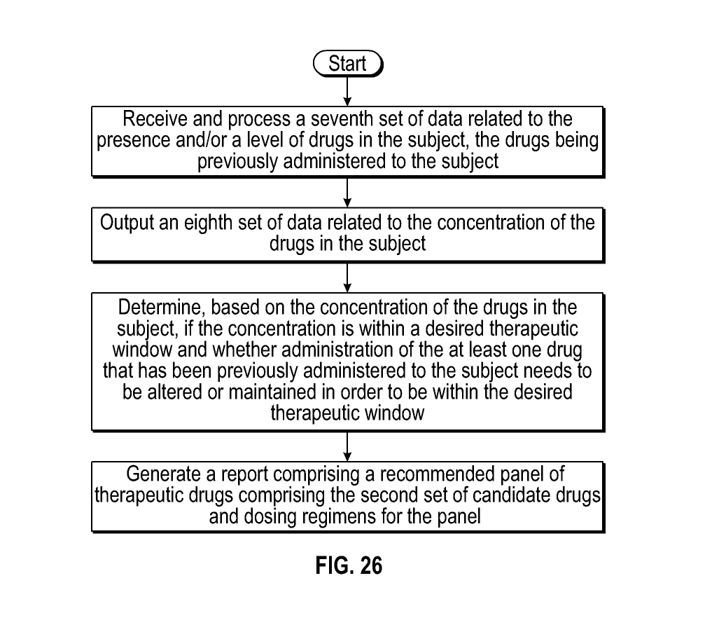

FIG. 26 illustrates certain embodiments of the subsystem that is configured to process the therapeutic drug monitoring analysis. In some embodiments, this subsystem may be configured to process a seventh set of data using a computer system. The subsystem may be configured to receive and assess the seventh set of data and provide an output comprising an eighth set of data. The seventh set of data may comprise information related to the presence and/or a level of one or more drugs in the subject. The one or more drugs may be selected from the second set of candidate drugs and having been previously administered to the subject. The eighth data may comprise information related to the concentration of said one or more drugs. The subsystem may also be configured to determine, based on the concentration of the one or more drugs in the subject, if the concentration is within a desired therapeutic window and whether administration of the at least one drug that has been previously administered to the subject needs to be altered or maintained in order to be within the desired therapeutic window. In certain embodiments, the subsystem for processing the therapeutic drug monitoring analysis may generate a report comprising information on suggested alterations or maintenance of the drug administration in order to reach concentrations of the at least one drug that are within the desired therapeutic window.

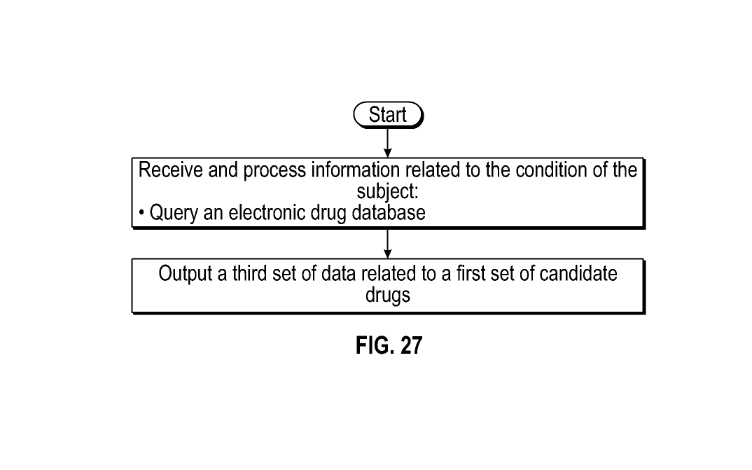

FIG. 27 illustrates alternative embodiments of the subsystem that is configured to generate a first set of candidate drugs that is associated with the condition of the subject. This subsystem may be configured to receive information on the condition of the subject and process the information using a computer system. The subsystem may also be configured to query an electronic drug database and provide an output comprising a first set of data. The first set of data may comprise information on a first set of candidate drugs that may be associated with an elevated degree of therapeutic efficacy against cells exhibiting the condition of the subject.

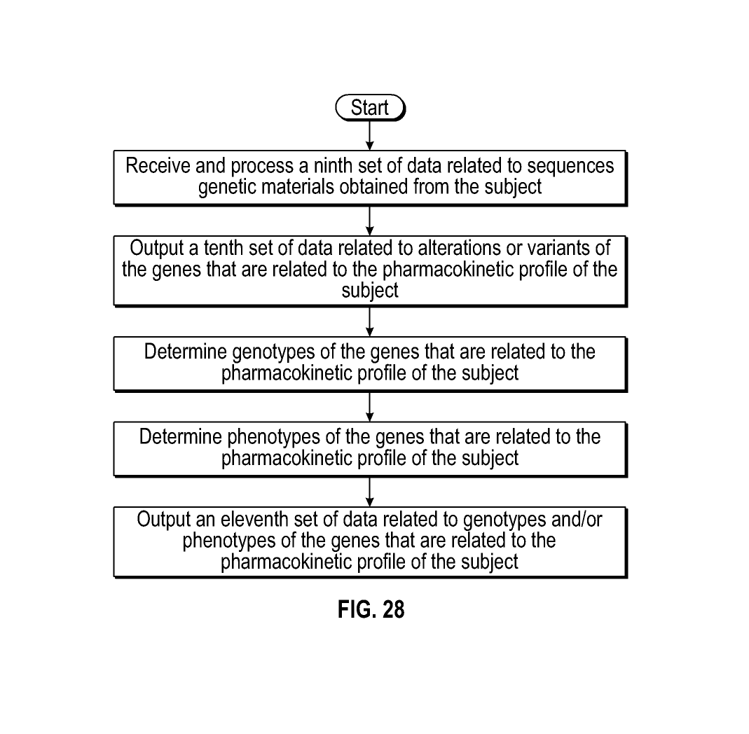

In certain embodiments, an additional subsystem can be included in the system that is configured to implement at least some methods disclosed herein. See FIG. 28. Such an additional subsystem may include, for example, that is configured to generate the pharmacokinetic profile of the subject. This additional subsystem may be configured to process a ninth set of data using a computer system. The subsystem may be configured to receive and assess the ninth set of data and provide an output comprising a tenth set of data. In certain embodiments, the ninth set of data comprises information related to sequences of genetic materials obtained from the subject and the tenth set of data comprises information related to one or more alterations or variants of the one or more genes. In some embodiments, the computer system may comprise an algorithm that compares a data point from the eighth set of data with a corresponding data point from a control. In some embodiments, the subsystem may also be configured to determine a genotype of the one or more genes. In certain some embodiments, the subsystem may be configured to determine a phenotype of the one or more genes. In addition, the subsystem may also be configured to output the eleventh set of data. The eleventh set of data may comprise information related to the genotype and/or the phenotype of the one or more genes. In certain embodiments, this eleventh set of data may be part of the data related to the pharmacokinetic profile of the subject, e.g. the fourth set of data in the embodiment illustrated in FIG. 25.

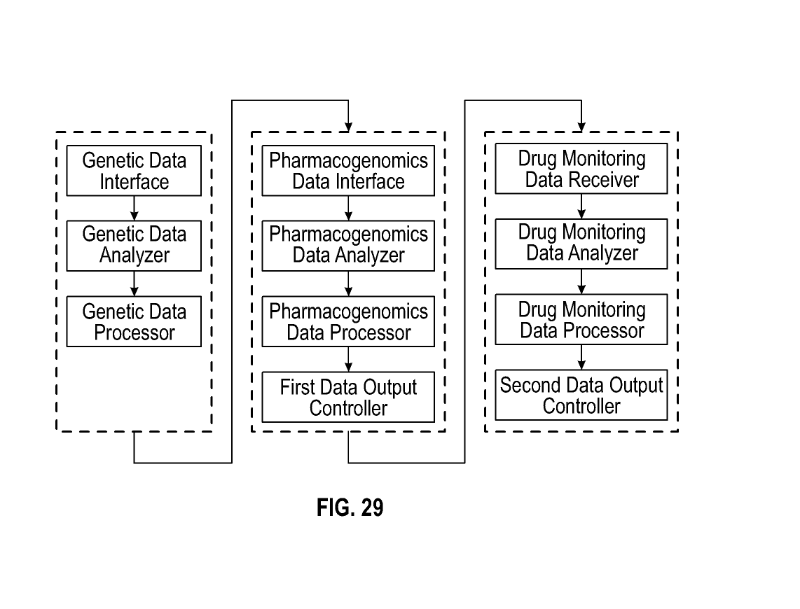

FIG. 29 illustrates certain embodiments of the systems disclosed herein. In some embodiments, the system for implementing a customized drug therapy for a subject having a disease may comprise a genetic data interface that is configured to receive a first set of data and store the first set of data in an electronic sequence database. The first set of data may be generated by a genetic material sequencing apparatus and comprise information related to the genetic profile of the subject.

The system may also comprise a genetic data analyzer that is configured to access the first set of data in the electronic database and to process the first set of data to generate a second set of data, based on the first set of data, the second set of data comprising information related to one or more genetic alterations or variants of diseased cells or tissue of the subject as compared to normal, non-diseased cells.

In some embodiments, the genetic data analyzer may comprise an algorithm that compares a data point from the first set of data with a corresponding data point from normal, non-diseased cells, thereby generating the second set of data. In some alternative embodiments, the genetic data analyzer may comprise an output generator that prepares the second set of data for output.

In some embodiments, the system may also comprise a genetic data processor that is configured to receive the second set of data from the output generator and query an electronic drug database to generate a third set of data, the third set of data comprising information related to a first set of candidate drugs that may be associated with an elevated degree of therapeutic efficacy against cells exhibiting the genetic alterations or variants identified in the diseased cells of the subject.

In some embodiments, the system may also comprise a pharmacogenomics data interface that is configured to receive a fourth set of data and a fifth set of data. The fourth set of data is related to the pharmacokinetic profile of the subject. In certain embodiments, the pharmacokinetic profile of the subject may be determined by screening the subject for characteristic identifiers of absorption, distribution, metabolism, and/or excretion of drugs. The fifth set of data may be related to a panel of drugs currently being administered or contemplated to be administered to the subject. In addition, the pharmacogenomics data interface may be configured to store the fourth and fifth set of data in an electronic patient drug profile.

In some embodiments, the system may comprise a pharmacogenomics data analyzer that is configured to receive and process the third, fourth, and fifth sets of data and configured to evaluate one or more of the following: an impact of the pharmacokinetic profile of the subject on a recommended dosage amount of each of the first set of candidate drugs, and an impact of putative or actual drug-drug interactions for each of the first set of candidate drugs and one or more drugs currently being administered or contemplated to be administered to the subject.

In some embodiments, the system may comprise a pharmacogenomics data processor that is configured to generate a sixth set of data, said sixth set of data comprising information related to a second set of candidate drugs.

In some embodiments, the system may comprise a first data output controller that is configured to generate at least one report, wherein the report comprises a recommended panel of therapeutic drugs comprising the second set of candidate drugs and dosing regimens for said panel.

In some embodiments, the system may comprise a drug monitoring data receiver that is configured to receive a seventh set of data, said seventh set of data comprising information related to the presence and/or a level of one or more drugs in the subject, and said one or more drugs being selected from the second set of candidate drugs and having been previously administered to the subject.

In some embodiments, the system may comprise a drug monitoring data analyzer that is configured to process the seventh set of data so as to determine a concentration of said one or more drugs in the subject.

In some embodiments, the system may comprise a drug monitoring data processor configured to determine, based on the concentration of said one or more drugs in the subject, if the concentration is within a desired therapeutic window and whether administration of the at least one drug that has been previously administered to the subject needs to be altered or maintained in order to be within the desired therapeutic window.

In some embodiments, the system may comprise a second data output controller that is configured to generate a report comprising information on suggested alterations or maintenance of the drug administration in order to reach concentrations of the at least one drug that are within the desired therapeutic window.

In certain embodiments, the system may comprise at least a computer processor and an electronic memory.

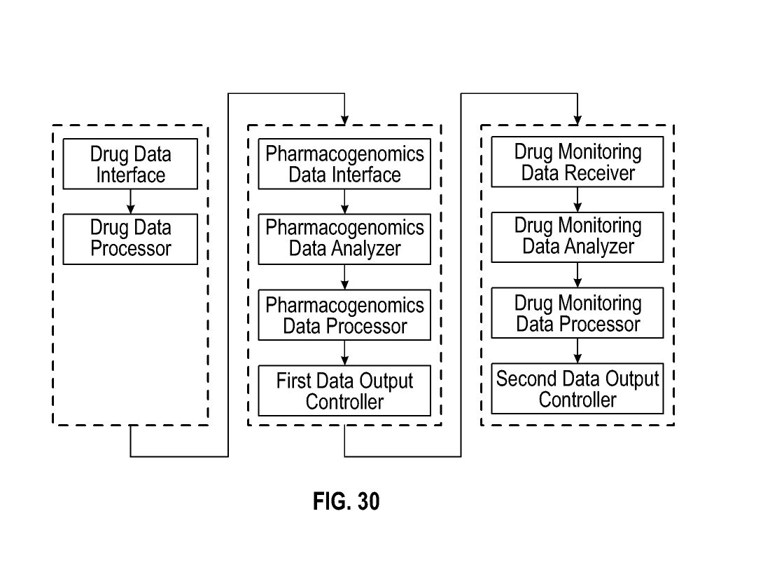

FIG. 30 illustrates certain alternative embodiments of the systems disclosed herein. In these alternative embodiments, the system may not include elements that are configured to process the genetic profiling of the subject. Instead, the system may comprise a drug data interface. In some embodiments, the drug data interface may be configured to receive a first set of data and store the first set of data in an electronic sequence database, the first set of data comprising information related to the condition of the subject.

In some embodiments, the system may also comprise a drug data processor that is configured to receive the first set of data from the output generator and query an electronic drug database to generate a second set of data, the second set of data comprising information related to a first set of candidate drugs that may be associated with an elevated degree of therapeutic efficacy against cells exhibiting the condition of the subject.

In some embodiments, the data/information output from the drug data processor can be provided and processed by the other elements that are configured to process the pharmacogenomics analysis and the therapeutic drug monitoring analysis, e.g. those illustrated in the middle and right panels from FIG. 30.

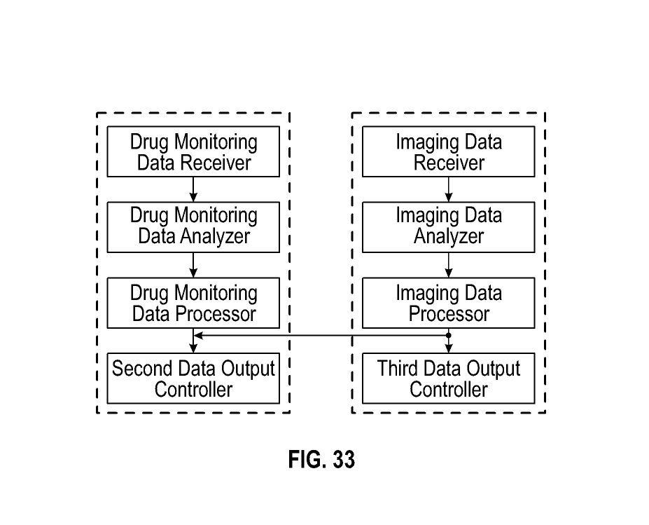

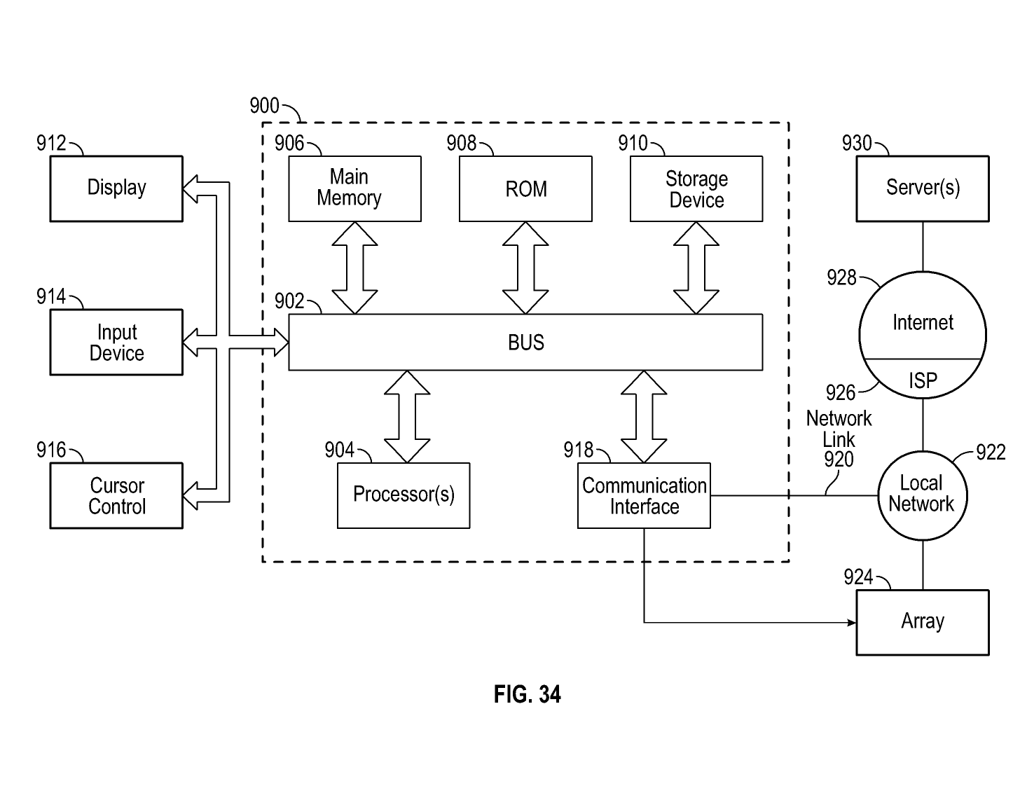

FIGS. 33 and 34 illustrate still additional embodiments of the systems disclosed herein. In these embodiments, the system may comprise additional elements that are configured to generate a data related to the pharmacokinetic profile of the subject. Such additional elements may include:
(i) a pharmacokinetic data interface that is configured to receive an eighth set of data and store said eighth set of data in an electronic sequence database, said eighth set of data generated by genetic material sequencing apparatus;
(ii) a pharmacokinetic data analyzer that is configured to access the eighth set of data in the electronic database and to process the eighth set of data to generate a ninth set of data, based on said eighth set of data, said ninth set of data comprising information related to one or more alterations or variants of the one or more genes,
   wherein the pharmacokinetic data analyzer comprises an algorithm that compares a data point from the eighth set of data with a corresponding data point from a control,
   wherein the pharmacokinetic data analyzer comprises an output generator that prepares the ninth set of data for output; and
(iii) a pharmacokinetic data processor that is configured to receive and process the ninth set of data from the output generator to determine a genotype of the one or more genes and a corresponding phenotype thereof. In some embodiments, the pharmacokinetic data processor may comprise an algorithm that matches the genotype to its corresponding phenotype.

In certain embodiments, the pharmacokinetic data processor may comprise an output generator that prepares a tenth set of data for output, the tenth set of data comprising information related to the genotype and/or the phenotype of the one or more genes. In certain embodiments, this tenth of data can be part of a data related to the pharmacokinetic profile of the subject.

In some embodiments, the data/information output from the pharmacokinetic data processor may be provided and processed by other elements that are configured to process the pharmacogenomics analysis, e.g. those illustrated in the middle panel from FIGS. 33 and 34.

In certain embodiments, the normal, non-diseased cells may be from the subject. In certain other embodiments, the normal, non-diseased cells may be from an individual other than the subject (e.g., one or more members of a control population).

In certain embodiments, the control may be a separate individual having no genetic alteration or variant of at least one of the genetic identifiers.

In certain embodiments, a concentration of the at least one drug within the desired therapeutic window is associated with reduced adverse side effects, as compared to the degree of side effects when the concentration is not within the desired therapeutic window.

In certain embodiments, the system may further comprises an imaging data receiver that is configured to receive a (first) set of data and another (second) set of data, the (first) set of data comprising information related to a first imaging data of a tissue or organ of the subject, wherein the (first) imaging data were obtained prior to the administration of one or more drugs that were recommend from a genetic profiling analysis and/or a pharmacogenomics analysis, and the another (second) set of data comprising information related to a second imaging data of the tissue or organ of the subject, wherein the another (second) set of imaging data were obtained after the administration of the recommended one or more drugs, an imaging data analyzer that is configured to process the two (first and second) sets of data so as to compare the condition of the tissue or organ of the subject before and after the administration, and an imaging data processor configured to process determine any change in the condition of the tissue or organ of the subject. In certain embodiments as illustrated in FIG. 35, once any change in the condition of the tissue or organ of the subject is determined from the process of the imaging data, the resulted information may be provided and processed to be included into a report. Depending on the results obtained from the process of the imaging data, the drug regimen plan that has been applied to a subject may be reviewed and considered for any updates or alterations. Especially if the imaging data processed reveal substantially no change or even notable advancement of the disease condition, any changes or modification on the drug types (e.g. adding new drugs in the regimen, substituting one or more of the existing drugs to one or more new drugs, and more) and/or application modes (e.g. doses, frequency, or more) may be considered in order to further improve the efficacy of the treatment.

### Implementation Mechanisms

According to one embodiment, the methods described herein can be implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software, such as iOS, Android, Chrome OS, Windows XP, Windows Vista, Windows 7, Windows 8, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

For example, FIG. 34 is a block diagram that illustrates a computer system 900 upon which an embodiment may be implemented. For example, any of the computing devices discussed herein, such as the insurer device 130, the prescription and medical claims data server 140, the providers 110, and the patient 150 may include some or all of the components and/or functionality of the computer system 900.

Computer system 900 includes a bus 902 or other communication mechanism for communicating information, and a hardware processor, or multiple processors, 904 coupled with bus 902 for processing information. Hardware processor(s) 904 may be, for example, one or more general purpose microprocessors.

Computer system 900 also includes a main memory 906, such as a random access memory (RAM), cache and/or other dynamic storage devices, coupled to bus 902 for storing information and instructions to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

Computer system 900 may be coupled via bus 902 to a display 912, such as a cathode ray tube (CRT) or LCD display (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 804 and for controlling cursor movement on display 912. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

Computing system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage

Computer system 900 may implement the methods described herein using customized hard-wired logic, one or more ASICs or FPGAs, firmware and/or program logic which in combination with the computer system causes or programs computer system 900 to be a special-purpose machine. According to one embodiment, the methods herein are performed by computer system 900 in response to hardware processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between nontransitory media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or solid state drive of a remote computer. The remote computer can load the instructions into its dynamic memory and send the instructions over a telephone line using a modem or other network interface, such as a WAN or LAN interface. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may retrieve and execute the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN (or WAN component to communicated with a WAN). Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

### Terminology

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Terms, such as, “first”, “second”, “third”, “fourth”, “fifth”, “sixth”, “seventh”, “eighth”, “ninth”, “tenth”, or “eleventh” and more, unless specifically stated otherwise, or otherwise understood within the context as used, are generally intended to refer to any order, and not necessarily to an order based on the plain meaning of the corresponding ordinal number. Therefore, terms using ordinal numbers may merely indicate separate individuals and may not necessarily mean the order therebetween. Accordingly, for example, the first and second sets of data used in this application may mean that there are merely two sets of data. In other words, there may not necessarily be any intention of order between the “first” and “second” sets of data in any aspects.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A method of optimizing a drug therapy for a subject in need of the therapy, the method comprising:
receiving a genetic profile of the subject;
obtaining a pharmacogenomics analysis of the subject; and
processing a level of one or more drugs in the subject;
wherein said genetic profile of the subject is prepared by a method comprising:
(i) processing a first set of data using a computer system configured to receive and assess the first set of data and provide an output comprising a second set of data,
said first set of data comprising information related to genetic sequences of biological materials obtained from diseased cells or tissue of the subject, and
said second set of data comprising information related to one or more genetic alternations or variants of the diseased cells or tissue of the subject as compared to normal, non-diseased cells, wherein said computer system comprises an algorithm that compares a data point from the first set of data with a corresponding data point from normal, non-diseased cells;
(ii) processing the second set of data using a computer system configured to receive and assess the second set of data and provide an output comprising a third set of data, said processing the second set of data comprises identifying differentially expressed genetic alterations or variants in the diseased cells and querying an electronic drug database to identify a first set of candidate drugs that may be associated with an elevated degree of therapeutic efficacy against cells exhibiting the one or more genetic alterations or variants identified in the diseased cells or tissue of the subject, said third set of data comprising information related to the first set of candidate drugs;
wherein said pharmacogenomics analysis of the subject is generated by a method comprising:
(iii) processing a fourth set of data using a computer system configured to receive and assess the fourth set of data, said fourth set of data comprising information related to the pharmacokinetic profile of the subject, wherein the pharmacokinetic profile of the subject was determined by screening the subject for characteristic identifiers of absorption, distribution, metabolism, and/or excretion of drugs;
(iv) processing the third and fourth sets of data and a fifth set of data using a computer system configured to receive and assess the third, fourth, and fifth sets of data, said fifth set of data comprising information related to a panel of drugs currently being administered or contemplated to be administered to the subject, said processing the third, fourth, and fifth sets of data comprising:
evaluating one or more of the following:
an impact of the pharmacokinetic profile of the subject on a recommended dosage amount of each of the first set of candidate drugs, and
an impact of putative or actual drug-drug interactions for each of the first set of candidate drugs and one or more drugs currently being administered or contemplated to be administered to the subject;
(v) providing an output comprising a sixth set of data, said sixth set of data comprising information related to a second set of candidate drugs; and
(vi) generating at least one report, wherein said report comprises a recommended panel of therapeutic drugs comprising the second set of candidate drugs and recommended dosing regimens for the panel;
wherein said processing the level of one or more drugs in the subject comprises:
(vii) processing a seventh set of data using a computer system configured to receive and assess the seventh set of data and provide an output comprising an eighth set of data,
said seventh set of data comprising information related to the presence and/or a level of one or more drugs in the subject, and said one or more drugs being selected from the second set of candidate drugs and having been previously administered to the subject,
said eighth data comprising information related to the concentration of said one or more drugs;
(viii) determining, based on the concentration of said one or more drugs in the subject, if the concentration is within a desired therapeutic window and whether administration of the at least one drug that has been previously administered to the subject needs to be altered or maintained in order to be within the desired therapeutic window; and
(ix) generating a report comprising information on suggested alterations or maintenance of the drug administration in order to reach concentrations of the at least one drug that are within the desired therapeutic window.

2. The method of claim 1, wherein said identifiers comprise one or more genes that are associated with absorption, distribution, metabolism and/or excretion of drugs in the subject and said fourth set of data is generated by a method comprising:
(x) processing a ninth set of data using a computer system configured to receive and assess the ninth set of data and provide an output comprising a tenth set of data,
said ninth set of data comprising information related to sequences of genetic materials obtained from the subject;
said tenth set of data comprising information related to one or more alterations or variants of the one or more genes,
wherein said computer system comprises an algorithm that compares a data point from the eighth set of data with a corresponding data point from a control;
(xi) determining a genotype of the one or more genes;
(xii) determining a phenotype of the one or more genes; and
(xiii) outputting the eleventh set of data, said eleventh set of data comprising information related to the genotype and/or the phenotype of the one or more genes, said fourth set of data comprising at least part of the eleventh set of data;
wherein the computer system comprises an algorithm that matches the genotype to its corresponding phenotype.

3. The method of claim 2, wherein the one or more genes associated with absorption, distribution, metabolism and/or excretion of drugs in the subject are selected from the group consisting of:
gene encoding Factor II (Prothrombin);
gene encoding Factor V (Leiden);
gene encoding Methylenetetrahydrofolate reductase (MTHFR);
gene encoding VKORC1;
gene encoding Cytochrome P450 2C9;
gene encoding Cytochrome P450 2C19;
gene encoding Cytochrome P450 2D6;
gene encoding Cytochrome P450 3A4;
gene encoding Cytochrome P450 3A5;
and combinations thereof.

4. The method of claim 2, wherein said tenth set of data comprises at least two alterations or variants of a same gene or different genes that are associated with absorption, distribution, metabolism and/or excretion of drugs in the subject.

5. The method of claim 1, wherein the normal, non-diseased cells are from the subject.

6. The method of claim 1, wherein the normal, non-diseased cells are from an individual other than the subject.

7. The method of claim 2, wherein the control is a separate individual having no genetic alteration or variant of at least one of the genetic identifiers.

8. The method of claim 1, wherein a concentration of the at least one drug within the desired therapeutic window is associated with reduced adverse side effects, as compared to the degree of side effects when the concentration is not within the desired therapeutic window.

9. The method of claim 1, wherein said processing the level of one or more drugs in the subject is repeated.

10. The method of claim 1, wherein the method further comprises:
operating an imaging process.

11. A system for implementing a customized drug therapy for a subject having a disease, the system comprising:
(i) a genetic data interface that is configured to receive a first set of data and store said first set of data in an electronic sequence database, said first set of data generated by a genetic material sequencing apparatus and comprising information related to the genetic profile of the subject;
(ii) a genetic data analyzer that is configured to access the first set of data in the electronic database and to process the first set of data to generate a second set of data, based on said first set of data, said second set of data comprising information related to one or more genetic alterations or variants of diseased cells or tissue of the subject as compared to normal, non-diseased cells,
wherein the genetic data analyzer comprises an algorithm that compares a data point from the first set of data with a corresponding data point from normal, non-diseased cells, thereby generating the second set of data,
wherein the genetic data analyzer comprises an output generator that prepares the second set of data for output;
(iii) a genetic data processor that is configured to receive the second set of data from the output generator and query an electronic drug database to generate a third set of data, said third set of data comprising information related to a first set of candidate drugs that may be associated with an elevated degree of therapeutic efficacy against cells exhibiting the genetic alterations or variants identified in the diseased cells of the subject;
(iv) a pharmacogenomics data interface that is configured to receive a fourth set of data and a fifth set of data,
wherein said fourth set of data is related to the pharmacokinetic profile of the subject,
wherein the pharmacokinetic profile of the subject was determined by screening the subject for characteristic identifiers of absorption, distribution, metabolism, and/or excretion of drugs,
wherein the fifth set of data is related to a panel of drugs currently being administered or contemplated to be administered to the subject,
the pharmacogenomics data interface configured to store the fourth and fifth set of data in an electronic patient drug profile;
(v) a pharmacogenomics data analyzer that is configured to receive and process the third, fourth, and fifth sets of data and configured to evaluate one or more of the following:
an impact of the pharmacokinetic profile of the subject on a recommended dosage amount of each of the first set of candidate drugs, and
an impact of putative or actual drug-drug interactions for each of the first set of candidate drugs and one or more drugs currently being administered or contemplated to be administered to the subject;
(vi) a pharmacogenomics data processor that is configured to generate a sixth set of data, said sixth set of data comprising information related to a second set of candidate drugs;
(vii) a first data output controller that is configured to generate at least one report, wherein said report comprises a recommended panel of therapeutic drugs comprising the second set of candidate drugs and dosing regimens for said panel;
(viii) a drug monitoring data receiver that is configured to receive a seventh set of data, said seventh set of data comprising information related to the presence and/or a level of one or more drugs in the subject, and said one or more drugs being selected from the second set of candidate drugs and having been previously administered to the subject;
(ix) a drug monitoring data analyzer that is configured to process the seventh set of data so as to determine a concentration of said one or more drugs in the subject; and
(x) a drug monitoring data processor configured to determine, based on the concentration of said one or more drugs in the subject, if the concentration is within a desired therapeutic window and whether administration of the at least one drug that has been previously administered to the subject needs to be altered or maintained in order to be within the desired therapeutic window; and
(xi) a second data output controller that is configured to generate a report comprising information on suggested alterations or maintenance of the drug administration in order to reach concentrations of the at least one drug that are within the desired therapeutic window, and
wherein the system comprises at least a computer processor and an electronic memory.

12. The system of claim 11, wherein said identifiers comprise one or more genes that are associated with absorption, distribution, metabolism and/or excretion of drugs in the subject and the system further comprises:
(i) a pharmacokinetic data interface that is configured to receive an eighth set of data and store said eighth set of data in an electronic sequence database, said eighth set of data generated by genetic material sequencing apparatus;
(ii) a pharmacokinetic data analyzer that is configured to access the eighth set of data in the electronic database and to process the eighth set of data to generate a ninth set of data, based on said eighth set of data, said ninth set of data comprising information related to one or more alterations or variants of the one or more genes,
wherein the pharmacokinetic data analyzer comprises an algorithm that compares a data point from the eighth set of data with a corresponding data point from a control,
wherein the pharmacokinetic data analyzer comprises an output generator that prepares the ninth set of data for output;
(iii) a pharmacokinetic data processor that is configured to receive and process the ninth set of data from the output generator to determine a genotype of the one or more genes and a corresponding phenotype thereof, wherein the pharmacokinetic data processor comprises an algorithm that matches the genotype to its corresponding phenotype, and wherein the pharmacokinetic data processor comprises an output generator that prepares a tenth set of data for output, said tenth set of data comprising information related to the genotype and/or the phenotype of the one or more genes, said fourth set of data comprising at least part of the tenth set of data.

13. The system of claim 12, wherein the one or more genes associated with absorption, distribution, metabolism and/or excretion of drugs in the subject are selected from the group consisting of:
gene encoding Factor II (Prothrombin);
gene encoding Factor V (Leiden);
gene encoding Methylenetetrahydrofolate reductase (MTHFR);
gene encoding VKORC1;
gene encoding Cytochrome P450 2C9;
gene encoding Cytochrome P450 2C19;
gene encoding Cytochrome P450 2D6;
gene encoding Cytochrome P450 3A4; and
gene encoding Cytochrome P450 3A5.

14. The system of claim 12, wherein said ninth set of data comprises information related to at least two alterations or variants of a same gene or different genes that are associated with absorption, distribution, metabolism and/or excretion of drugs in the subject.

15. The system of claim 11, wherein the normal, non-diseased cells are from the subject.

16. The system of claim 11, wherein the normal, non-diseased cells are from an individual other than the subject.

17. The system of claim 12, wherein the control is a separate individual having no genetic alteration or variant of at least one of the genetic identifiers.

18. The system of claim 11, wherein a concentration of the at least one drug within the desired therapeutic window is associated with reduced adverse side effects, as compared to the degree of side effects when the concentration is not within the desired therapeutic window.

19. The system of claim 11, wherein said processing the level of one or more drugs in the subject can be repeated.

20. The system of claim 11, wherein the system further comprises:
(iv) an imaging data receiver that is configured to receive an eleventh set of data and a twelfth set of data;
said eleventh set of data comprising information related to a first imaging data of a tissue or organ of the subject, wherein said first set of imaging data were obtained prior to the administration of said one or more drugs; and
said twelfth set of data comprising information related to a second imaging data of the tissue or organ of the subject, wherein said second set of imaging data were obtained after the administration of said one or more drugs
(v) an imaging data analyzer that is configured to process the eleventh and twelfth sets of data so as to compare the condition of the tissue or organ of the subject before and after the administration; and
(vi) an imaging data processor configured to process determine any change in the condition of the tissue or organ of the subject.
